(19) United States
(12) Patent Application Publication
(10) Pub. No.: US 2019/0156443 A1
(43) Pub. Date: May 23, 2019

(54) SYSTEM AND METHOD FOR MONITORING AND MANAGING INFORMATION

(71) Applicant: Site 10.01, Inc., Kansas City, KS (US)

(72) Inventor: Eric Hall, Bend, OR (US)

(21) Appl. No.: 16/151,285

(22) Filed: Oct. 3, 2018

Related U.S. Application Data
(63) Continuation of application No. 15/221,523, filed on Jul. 27, 2016, now abandoned.
Application No. 15/221,523 is a continuation-in-part of application No. 14/746,368, filed on Jun. 22, 2015, now abandoned.
Application No. 14/746,368 is a continuation of application No. 13/072,672, filed on Mar. 25, 2011, now Pat. No. 9,064,219.
(60) Provisional application No. 61/331,472, filed on May 5, 2010.

(51) Int. Cl. G06Q 50/16; H04L 29/08; G06Q 30/02; G06Q 10/10; H04L 29/06; G06Q 10/06

(52) U.S. Cl. CPC G06Q 50/163; H04L 67/02; G06Q 10/06; G06Q 10/10; H04L 67/42; G06Q 30/0283

(57) ABSTRACT

A system and related method which has a database that stores information indicative of a plurality of assets that are used in a building or system. A user interface of the system enables identifying a group of such assets and associating a portion of the assets with the identified group of assets. The assets included in the identified group of assets may collectively be located in different rooms of a building in which the assets are located and/or on different floors of a building in which the assets are located.

### CROSS-REFERENCE TO RELATED APPLICATIONS

The present application is a continuation of U.S. patent application Ser. No. 15/221,523, filed Jul. 27, 2016, which is a continuation-in-part of U.S. patent application Ser. No. 14/746,368, filed on Jun. 22, 2015, which is a continuation of U.S. patent application Ser. No. 13/072,672, filed on Mar. 25, 2011, now issued as U.S. Pat. No. 9,064,219, which claims the benefit of U.S. Provisional Patent Application No. 61/331,472 filed on May 5, 2010. The disclosures of all above-referenced applications are incorporated herein by reference in their entireties.

### BACKGROUND OF THE INVENTION

### Field of Invention

This invention relates generally to facility management and, more particularly, to systems and methods for managing a facility's content, equipment and infrastructure.

### Background Art

Buildings have become increasingly complex to maintain, particularly large modern buildings having multiple floors. These buildings feature a plurality of different building systems, including electrical systems; heating/cooling/ventilation systems; plumbing, security systems, communication/data systems, telephone systems, elevator systems and others. Many of these systems are interdependent, for example the heating and cooling systems are dependent on the electrical systems. Each of these complex systems must be maintained and managed according to various rules and regulations, and also according to best practices, in order for the smooth and efficient operation and maintenance of these systems and the overall building. However, detailed and current information regarding the building's infrastructure is necessary to accomplish successful maintenance and management of the building. Often the information available regarding the building infrastructure is not current and/or is not readily accessible in a user-friendly manner and even if the information is available in some form or another, the amount of information is so large that it is not able to be managed easily in such a manner that is effective for managing and maintaining a building. Building management systems and/or facility content systems that are available often are not user-friendly and do not have an easy mechanization for updating information such that it is current.

Automatic management of such building systems is clearly desirable over manual management and/or over handling paper drawings that are often and quickly out of date. The systems are sufficiently complex that it is difficult if not impossible for a maintenance engineer to fully visualize them and to manually handle a huge amount of complex data. Furthermore, often maintenance should be performed according to a particular schedule, in order to prevent malfunctions in one or more parts of the system.

Various software programs have been proposed in the art to overcome management and maintenance problems. For example, applications have been proposed that are able to assist in the maintenance and management of building systems, once the plans for these building systems have been manually input. One such system is described in PCT Application No, WO 06/004649, which describes software for management of building systems after the plans have been manually analyzed. However, these types of solutions clearly require manual analysis of the plans (blueprints) of the building and identification of objects therein, much of which is not easily accessed and inventoried once the building is complete, which can be disadvantageous in terms of the return on the investment of time and effort required. Manual analysis is time consuming and can also lead to human error. Automatic analysis methods in general could potentially have an advantage if such a product could be readily developed and standardized and made reproducible and effective regardless of the building design. However, even with an automated system, there will likely be errors or holes in the data due to the huge distinctions between different building structures. However, in this area, such an automated analysis method is not readily available and likely not practical.

There are some systems that provide geographical views and top-level information about equipment such as information technology equipment, furniture and building space. However, many of these systems are an integrated system of sensors, transceivers and controllers for automatically controlling certain building systems and sensing various building metrics, for example temperature. Some systems have been proposed that allow for manipulation of drawings, reports, requests and different layer views with a navigation scheme, see U.S. Patent Application Publication 2006/0031455. However, even with systems of this nature, the level of detail for comprehensive maintenance down to the level needed for the original construction plans is not provided, nor is it considered. Further, significant manual input will likely be required.

It has been proposed that in some large installations, all HVAC components (sensors, counters, contacts, etc.) are connected via a DDC/PMS (Direct Digital Control/Programmable Management System) unit to a Building Automation System, and the Building Automation System can be connected to a Building Management System to form an integrated monitoring and control system. However, monitoring and controlling systems are only a small portion of the overall building management task, thus tools of this nature are not comprehensive in addressing the need.

A building's life cycle can include several phases. A pre-design phase can be when the project is initially conceived for a building, facility or product, and can include site analysis, project pro forma (the analysis of the financial feasibility and related design of the project), program development, and the like. During the design phase, the building components of the project are designed, which can be items that are necessary for the operation or maintenance of the building or are inherently permanent. The design phase includes schematic design and design development of the project. The documentation can include the detailed documentation of the design that is further refined down to the detailed drawing, which can include non-permanent fixtures and infrastructure. The documentation phase can include working drawings, specifications, and construction contracts, and the like. Typically, after the documentation phase is the pricing phase where the project is priced or bid. Typically, after the pricing phase the project is implemented. The implementation phase includes construction administration, construction, installation, assembly, change orders, field orders, mover's instructions, product warranties for facility management, occupancy, placed in service, use, and the like. The implementation phase is conducted based on a detailed set of drawings, including installation orders down to the smallest detail, and it is this level of detail that is ultimately needed for effective management and maintenance of the building. When the building is put into operation and use there must be day to day operation, maintenance and emergency management of the facility. In order to effect repairs and modifications, certain details concerning the building need to be readily accessible; or, in order to properly respond to emergency situations involving the building, again certain details are also needed.

At some point in time the use of the building will diminish or even the building itself is abandoned. Abandonment may include a study to determine the feasibility of an alternate use that usually requires partial or even full demolition. When alternate uses are determined unprofitable (usually because of elevated cost and complexity associated with remodel construction), the result is a vacant building that is characteristically a social and health hazard having a negative influence on neighborhood cohesion and welfare. Demolition of the building may ultimately result; however, building methods generally do not lend themselves to being “deconstructed” into segregated parts which could be reused. Therefore, the demolition of buildings may result in destroying the integrity of the individual building components. Demolition of projects and their components become very low-grade waste at best and, more often, become an environmental hazard requiring special landfill permits because, in its composite state, it produces off-gases and byproducts that are volatile and hazardous to the health safety and welfare of the public.

A more comprehensive building management system is needed that will address the above outlined problems, particularly those relating to the completeness of the data, accessibility, and user-friendly interface.

### BRIEF SUMMARY OF THE INVENTION

The invention is a system and method for providing a detailed Facility Content System (FCS) that leverages a Building Information Model (BIM) created during the design and build phases of the process of construction to deliver Operations and Maintenance (O&M) content to building owners. The O&M content can have the level of detail required during the detailed design and build phases thereby providing sufficient information to the operator/owner for ongoing operations and maintenance. The system will use extracted images from the BIM to drive the navigation of the system and provide data to the user not previously available in the current O&M deliverable or other facility management systems. Rooms and equipment will also be supplied with QR (Quick Response) codes which may be scanned with mobile devices to drive instant access to room, equipment and maintenance information, and the like.

The present invention is a system and method that provides a unique building maintenance tool which leverages the information collected during the design and construction phase of the building lifecycle. User access to BIMs, Revit (or other similar building design software) schedules and other data sources within the unique construction process provide clients with a post occupancy view previously unobtainable. The solution provides for simple integration with external data sources through data file import or direct integration. The intent of the data integration model is to reduce costs of ongoing implementations providing a scalable model. Mobile access to information is a central component of customer appeal and will be a focal point of the design process. With the present invention, mobile users can use a mobile device to scan 2 dimensional barcodes or QR Codes or other type of georeferencing code including RFIDs and thereby use the mobile device as the primary navigation portal to room and equipment information and images. The present invention provides building management functionality by leveraging extracted building data of a database constructed from construction process data as a foundation, which includes detailed equipment specifications. The invention also includes tools to build on and update the foundational data to include maintenance schedules and history; work order management; part tracking on work order history data; build solution in a hosted model; and administration and support of multiple client implementations on a single application instance.

One embodiment of the present invention can be a facility content system network server communicably coupled to a customer client network comprising a content network server having executable content enterprise resource planning (ERP) systems and web services applications residing thereon and communicably coupled with a file server function, a database server function with associated computer readable storage medium and data structure, a legacy project construction management application server function with associated computer readable storage medium and an administrator computer work station operable to execute the ERP systems and web services applications to thereby pre-populate the database server function content with detailed design and construction data during the construction project. The invention can further comprise a customer client network web server communicably coupled via a local network to a customer computer work station having a computer executable browser based user interface application residing thereon and to a mobile computing device having a computer executable mobile browser based user interface application residing thereon, and where said customer client network web server is communicably coupled via a wide area network to said content network server and where said customer computer work station is operable to execute the build/maintenance and web services applications to thereby maintain content.

The invention can also include a facility content system network server communicably coupled to a customer client network comprising facility content system data associated with equipment, finish types, images and custom properties stored in a computer readable medium with an account centric data structure where the data is segregated by a building, an area within the building, and a room within the area, where the facility content system data is initially pre-populated using data generated by a legacy project construction application and design-build data inputs from a building integration model. A user interface client application can have a navigation schema adapted to access building objects, area objects grouped within said building objects, room objects grouped within said area objects, and equipment instances within said room objects, and where said user interface client application is operable when executed to access said objects and display images representative of content data within said objects. The invention can also organize and segregate data for uses other than facility content management. For example, the present invention is useful as an information management system for municipalities, cities, counties, or other geographical zones. In particular, the present invention is useful to enable information management for components and equipment and sensors in communication systems (such as broadband wireless access networks (e.g., WiMax) or other systems, sewage systems, etc.).

A unique building maintenance tool is provided that leverages the information collected during the design and construction phase of the building lifecycle to provide a comprehensive detailed management tool without significant manual input. These and other advantageous features of the present invention will be in part apparent and in part pointed out herein below.

As illustrated and described, the Facility Content System (FCS) is a useful system and set of digital and/or online tools for use in managing and maintaining a building. Additionally, the FCS may include additional functionality and/or be a part of, and integrated with, a more comprehensive information monitoring and management system that monitors a number of other or additional sensors, including Building Automation System (BAS) sensors and/or Internet of Things (IoT)-type sensors and that receives additional information from other systems and sources of data. Additionally, the FCS may be a comprehensive component of a cloud-based Internet of Things information monitoring and management system and platform. Such a system and platform enables monitoring of data in at least substantially real-time from a variety of sensors (such as sensors in buildings, in mobile devices, on equipment, on vehicles, on communications equipment, in industrial works such as sewers, Internet of Things devices, etc.), setting alert and alarm thresholds, generating alerts and alarms, automatically generating work orders based on alerts and alarms, storing, displaying and communicating data trends, provision of digital regulatory management recording-keeping tools, provision of data trend information and recommendations for energy-use optimization and management, cost center management, provision of statistical analysis and tools to aid in capital planning, generate and manage work orders, define areas and asset groups in buildings, and other functionality.

The ability of the information monitoring and management system to collect data over time from a variety of sensors enables deep data analysis to enable managers of the systems and/or machines and/or equipment being monitored by the system to better understand operations and to make informed decisions that improve efficiency, productivity, capital allocation, planning, and purchasing decisions. Additionally, in embodiments, the data may be provided (for a fee or not) to original equipment manufacturers (OEMs) to enable OEMs to evaluate (and potentially compare with competitive products) how their product is performing under certain conditions. Additionally, the information monitoring and management system includes tools for importing information scanned from paper files (i.e., non-BIM data) relating of building designs and product manuals.

### BRIEF DESCRIPTION OF THE FIGURES

For a better understanding of the present invention, reference may be made to the accompanying drawings in which:

FIG. 1 is an illustration of the facility content system;

FIG. 2 is an illustration of a top-level system organizational diagram;

FIG. 3 is illustration of a particular building object;

FIG. 4 is an illustration of custom properties;

FIG. 5 is an illustration of the facility content system technology stack;

FIGS. 6A and 6B are illustrations of the facility content system sitemap overview;

FIGS. 7A, 7B and 7C are illustrations of a process flow for submittal of data for initial population of the database;

FIG. 8 and FIGS. 8A-8E are illustrations of the basic database construct with the various data fields and data types;

FIGS. 9A thru 9F are an illustration of the data standardization phase;

FIG. 10 is an illustration of a home page view for a given building;

FIG. 11 is an illustration of a room home view;

FIG. 12 is an illustration of the mechanical view;

FIG. 13 is an illustration of the electrical view;

FIG. 14 is an illustration of the structure above view;

FIG. 15 is an illustration of the structure below view;

FIG. 16 is an illustration of the room details;

FIG. 17 is an illustration of the equipment view;

FIG. 18 is an illustration of the installed equipment view;

FIG. 19 is an illustration of the equipment type view;

FIG. 20 is an illustration of interior images;

FIG. 21 is an illustration of a panoramic view;

FIG. 22 is an illustration of a list of rooms under the building view;

FIG. 23 is an illustration of a list of areas under a building view;

FIG. 24 is an illustration of various buildings seen under an account;

FIG. 25 is an illustration of a maintenance item view;

FIG. 26 is an illustration of equipment types;

FIG. 27 is an illustration of installed equipment;

FIGS. 28 through 33 are illustrations of the administration functions;

FIGS. 34 thru 39 are illustrations of the system administration functions; and

FIGS. 40 and 41 are illustrations of the mobile device application;

FIG. 42 is a block diagram illustrating an information monitoring and management system;

FIG. 43 is a system and flow diagram illustrating integration of a Building Automation System (BAS) with the information monitoring and management system as well as a process for setting up a monitor;

FIG. 44 is a flow diagram (with a library component) relating to task and ticket creation features;

FIG. 45 is a block diagram illustrating flow of an inspection feature using a task list;

FIG. 46 is a display screen, of an information monitoring and management system, illustrating setting-up of a new area for a building or facility;

FIG. 47 is a display screen, of an information monitoring and management system, illustrating adding a custom property for the area set-up in FIG. 46;

FIG. 48 is a display screen that illustrates use of a custom properties feature on an Dashboard of an information monitoring and management system;

FIGS. 49 and 50 are display screens that illustrate additional filters and a list when the custom properties features are used;

FIGS. 51-92 are illustrations of display screens and functions of the information monitoring and management system and, in particular:

FIGS. 51-53 are illustrative of a home page, dash-board, information gauges, and menu of the information monitoring and management system;

FIGS. 54-57 are illustrative of trend sets and trends of data that are sensed and gathered by the information monitoring and management system;

FIGS. 58-61 are illustrative of a monitor's feature and monitor and alarm functions of the information monitoring and management system;

FIG. 62 is illustrative of information indicative of devices;

FIG. 63 is illustrative of information indicative of sensors;

FIG. 64 is illustrative of an emailed alarms feature of the information monitoring and management system;

FIG. 65 is illustrative of Actions available to a defined Area, including the ability to add a new work order;

FIGS. 66-70 are illustrative of information, including trend data, textual, information, and visual information, indicative of a room;

FIG. 71 is illustrative of a screen that indicates Asset information, including particularly the ability to assign the asset to an Asset Group;

FIGS. 72-73b are illustrative of navigation to and information relating Asset Groups;

FIGS. 74-77 are illustrative of monitors used to monitor trend data and alarms;

FIGS. 78-83 are illustrative of navigation to and information relating to Tasks Lists;

FIGS. 84-89 are illustrative of inventory features of the information monitoring and management system; and

FIGS. 90-92 are illustrative of work order features of the information monitoring and management system.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but, on the contrary, the intention is to cover all modifications, equivalents, and alternatives falling within the spirit and scope of the present invention as defined by the appended claims.

### DETAILED DESCRIPTION OF THE INVENTION

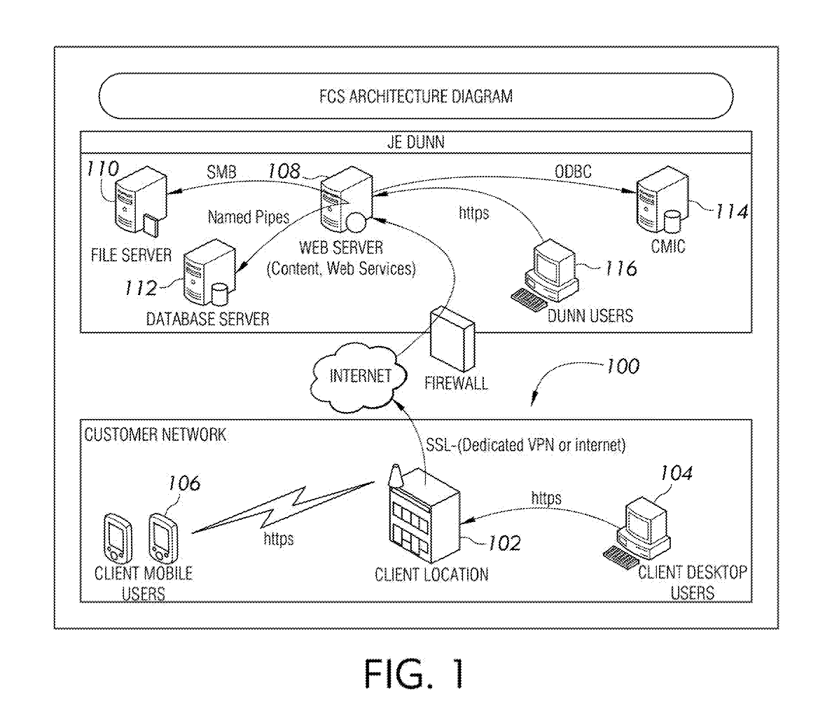

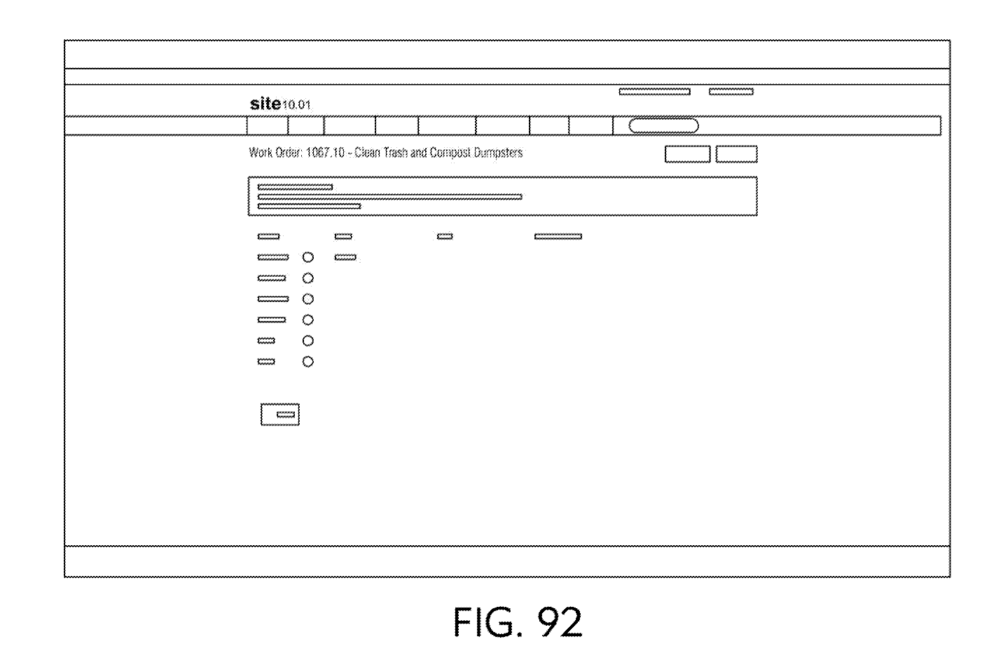

According to the embodiment(s) of the present invention, various views are illustrated in FIGS. 1-92 and like reference numerals are being used consistently throughout to refer to like and corresponding parts of the invention for all of the various views and figures of the drawing.

One embodiment of the present invention comprising a facility's content system and database teaches a novel system and method for managing a building.

The user interface (UI) of the present invention is a browser-based application having a navigation scheme. There are various navigation levels for drilling down to specific data being accessed. The main page has various different navigation tabs that can be selected by the user thereby initiating a collection of data for presenting the data fields in a screen format as defined by the rules or schema of the tab selected. The home page for each building selected can serve as a starting point for navigating to specific information regarding the building.

A service request tab can also be provided whereby a user can initiate and submit a work order and view a work order history, update a work order, or cancel a work order. A maintenance tab can also be provided where the user enters into a work order management mode to dispatch resources, view the status of a work order and change the work order status, and view the related equipment. A reporting tab can also be provided where the user can initiate and access reports regarding work orders.

A building administration tab can also be provided where the user can access building maintenance, area maintenance, room maintenance, part maintenance, and equipment maintenance views. Room facility and room equipment can also be viewed by the user.

A system level administration function can also be provided where a user can have access to varying levels of administrative tools including account maintenance and new or revised content population. The level of access for a given user can vary depending on the security access level.

If a user navigates to the Building View, general information can be viewed including building address information, general building description information, project code correlating to the original build project, a building code, and top-level images of the completed building. A user can log on, and based on the individual users' security access level, can view different levels of information regarding the building. The user can navigate to an Area View to access and view information including Large Key Plan Image, Listings of Defined Areas, and Listings of Rooms contained in a selected area. A user can select an area from list in order to view area key plan and room listing or make a selection of a room from the room list, which is linked to the Main Room View.

The user can also select an Equipment View, which allows the user to access notes relating to the unique codes that can exist for each piece of equipment that can be tied back to the Equipment View within the appropriate room. Within the Equipment View, the user can also access the Instance View which can be an aggregate of equipment type properties and equipment instance properties. Other more detailed information can be accessed and viewed in the Equipment View, including the name of the equipment, the equipment part number, warranty information, subcontractor contact information, vendor contact information, and service provider contact information. Links to specification sheets and to the equipment vendor's website can also be provided to the user.

The Main Room View can also be accessed from the Building View navigation tree. In the Main Room View, a user can view various images of the Key Plan of a floor or an area of floor. A Reference key to the location of room in building can be provided and can be linked to a larger image of the same view. The current room can be highlighted and embedded within the area image and enlarged key view images can be provided. An “Extended Room View” Image can also be provided where the surrounding areas around the room or area are shown. A description of the room can be provided and various Room Construction Codes and Facility Defined Room Codes. Links can be provided to photographs of interior of room (NESW); to within “Extended Room View” to adjacent rooms visible within view; to “Structural View Above”; to “Structural View Below”; to “Mechanical View”; to “Electrical View”; to “Facility Data”; and to a page displaying Items like Wall Paint Color 1&2, Ceiling type, Mechanical Access Requirements, square feet, cubic feet, flooring. Facility Data Types can be predefined. From the Main Room View, a user can navigate to the Structural View Above and Structural View Below, which includes an image of the structural view. The user can also navigate to the Mechanical View, which provides links to equipment information from defined hotspots and provides links to access the work order history and equipment data. The user can also navigate to the Electrical View where a room description is provided as well as the end facility room number and an image of a mechanical view. Links to an Equipment View for equipment defined within the electrical image is provided. Facility Data View is yet another option for the user, which provides a List of facility data elements defined for the room.

From the Building Homepage, the user can select Reporting, where the user can generate reports regarding submitted work orders and work orders completed by week or date range. The user can also review reports on certain metrics such as percent Work Orders Completed On Time. The user can view a Room Contents report by room with a list of equipment, including subcontractor info, vendor info and service provider info. In addition, the user can view an Equipment Contact List, including List of Equipment, Sub-contractor Info, Vendor Info, and Service Provider Info.

In addition to creating and tracking work orders, the system can have full functionality to create, read, update and delete details of the work order. There can be a Work Order ID assigned to each work order created. End users can display orders which they have created, whether active or inactive. Different views can be created and presented for the Requester and the Maintenance User. The work order can be tracked from its initial status while pending assignment all the way to completion. Maintenance personnel can have the ability to self-assign tasks in work queue based on priority and responsibilities. Users can have more than one task assigned at a time. Work order status moves through a progression from being created, to Pending Assignment, to being Assigned (status changed when Maintenance User self-assigns), to completion, or to cancellation.

The user interface of the present invention also provides an Administration function where users create, read, update and delete information in a database. The information that can be operated includes User Maintenance information such as information related to properties or Role Maintenance. Account Maintenance can also be an administrative tool provided to the user where the user can create, read, update and delete client account information, building maintenance information and area maintenance information and room maintenance information including Room Project ID, Room Description, Room Number (Building Assigned), Navigation Code (QR Code), Area (From Defined Areas), Link to “Room Equipment Maintenance”, Template Type and Facility Data. Some information may have restrictions on editing. The user can also create, read, update and delete information related to equipment maintenance including general notes relating to types of equipment in the building, warranty information, subcontractor contact information, vendor contact information, service contract information, maintenance schedule and specification sheets. The user can also perform a similar function at the Room Equipment Maintenance level where individual pieces of equipment are assigned to a room and links can be provided to the Equipment View navigation tree level. System Level Administrators can have access to Room Template Maintenance to define Room Templates to be used to drive which features will be available and in need of population for each room. The template serves as the template for room creation. This drives what is required to be populated. After room creation, these properties can be modified at the room level. A user can also create, read, update and delete Facility Data Maintenance information such as a list of available pieces of facility data including items such as paint color and carpet type which can be associated to rooms.

Other Administration functions can include automated task generation in the Work Order System where, upon completion of a previous scheduled task, a new one is created. Multiple schedules can exist for a single piece of equipment. The initial work order task can be generated and, if a part is modified, the existing task can be left as-is; and if a schedule is modified, then the existing task can be updated. When a work order task is deleted, all associated work order tasks can also be deleted. The system can also distinguish between automatically scheduled work orders and requested work orders. The following information can be included in the work order; Work Order ID; Requester; Room; Part (Optional); Description; Status; Priority (High, Med, Low); Estimated Effort; Actual Effort; Material Cost; Task List; Custom Properties; various time stamp (TS) information; Requested TS; Activate On TS; Requested Completion TS; Actual Completion TS; and Cancelled TS, as well as user stamp information for such actions.

A user having an appropriate mobile device can scan QR codes for quick navigation using a web interface. A QR code can be a unique identifier, which can be logically linked to a room or specific piece of equipment. The unique identifier will be appended to the web request as a query string. The base URL will be stored locally within the properties in the administration/setup screen. If logged on, the user will be driven to “Main Room View” or “Equipment View” within “Main Room View” depending on which is relevant. If user is not logged on, the web interface will request a logon.

Prior to delivering the FCS to the facility owner, many forms of data must be populated from various sources. Though most system data can be administered through typical administration interfaces before and after system delivery, certain tools will need to be available during the initial data population process to facilitate bulk data loading. Examples of this bulk data loading are: import template files and system exports, image content from design drawing and BIMs, integration to and from backend general contractor systems, hotspots within mechanical views linked to equipment definitions, and data submission portals.

Certain data sets used to perform the initial population of the system will be driven from systems or functions within the general contractor's organization during the original design and build phases. Examples of this are integration to and from backend general contractor systems, including image content from design drawing and BIMs, hotspots within mechanical views linked to equipment definitions and client account administration.

Finish Schedules can be generated and included. Generated Information can include Project Code (i.e. ERP Project Code), Room Code, Facility Data Type, and Facility Data Value. A room template can be populated. A CSV file can be exported from Revit and can be populated with room list and facility data. The CSV file can be uploaded via web interface. CSV data can be consumed generating room and facility system objects and Room Facility Data and Creation of place holders for Room View Child Views such as structure above. Key Plan files can be imported for each area by uploading and associating manually. Room View files can be imported including bulk import of Room View images and all room view types, including Room Home, Mechanical and Structural. The user can make room and view type associations based on naming convention.

Externally supplied tabular data and reference documents can be loaded into the system through “loader files” or bulk manual import. This data can be provided as spreadsheet documents defining data objects within the system or groups of files to be imported and associated. This can decouple data population from any particular source until more automated integration or portal submission models can be established. Use of submission portal in lieu of import templates is an option.

Equipment types can be created, and creation of room equipment associations can be achieved. Equipment schedules can be uploaded and associated with room codes and equipment codes. The information can be uploaded in a spreadsheet file as provided by the general contractor or the subcontractor. The spreadsheet file can be submitted from subcontractors or general contractor personnel in a spread-sheet file, which is different from being populated from a provided template. The spreadsheet template can be built with validation derived from the finish schedules from Revit. This can limit entry of room codes to those specified by the drawings provided. The spreadsheet file can be uploaded via web interface. CSV data can be consumed generating equipment type and equipment instance system objects. As part of the uploading process, Equipment Types and Room Equipment associations can be created. Equipment specification sheets can also be uploaded and associated to the equipment. Multiple spec sheets can be tied to a piece of equipment associated by equipment type.

Image definition and manipulation including Image region cropping and region highlighting can be managed in an external system. Images can be tagged and can be uploaded to the system and associated to Room View. Hotspots can be defined within the Room View images which can link to the Equipment View for that particular piece of equipment. These hotspots can exist independently of the underlying image so images can be updated without recreating links. Some of the Functional Requirements of the image can be selection of Room View to be processed and displayed in the user interface Room View; Display existing hotspots associated to image; Create, Update and Delete hotspots. Each hot spot will be linked to an instance of equipment that exists for the room, and each hotspot will support display text and select borders. In addition to being used to link to information indicative of equipment, hotspots also enable room-to-room navigation.

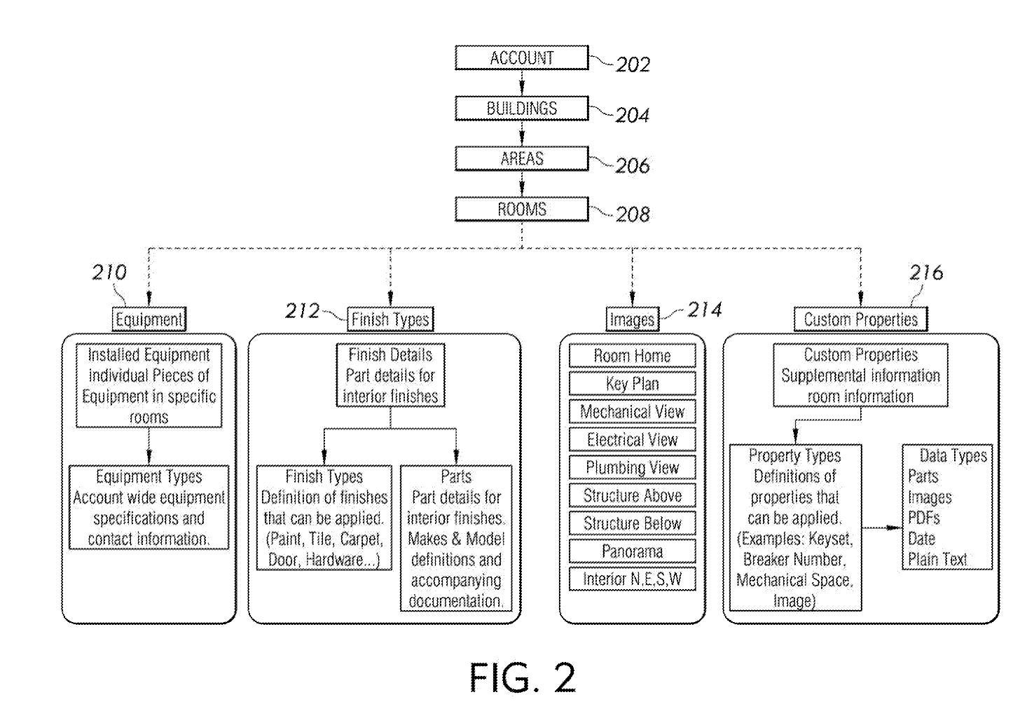

The system and method of the present invention can be implemented by application software residing on the server side. There will also be a mobile device application with barcode reading capability. An SQL server can be the main data repository for all self-contained tabular, image, document and annotation data required for the system. Refer to FIG. 2 for a possible Application Layer and Data Layer. As discussed above, import files will be used to populate data in bulk from various sources. Many of these processes can be automated. Two general types of import files that can be utilized are spreadsheet files (used to import tabular format data and can be able to be processed as CSV data) and content files. Content files can be uploaded in bulk and associated to the intended resources based on a naming convention and manual review process. Overlaps between data load of FCS and information currently stored in an ERP (or other financial and project construction management software) can be eliminated. A data repository model can be utilized for data store access. Files can be stored in the data store as binary blobs. File attributes (mime type, date modified, etc.) can be stored in an associated table. If a database bottleneck occurs, the files can be stored on the server's local file system and content can be replaced with file location string pointers. Data update and removal can be controlled at the application layer.

A mobile device browser file (MDBF) is maintained as a collection of the known browser identification strings passed in the header of an HTML request. The application can include a mobile view engine that inherits from the “default” web forms view engine. At run-time, it can search the HttpContext.Request for the calling browser (using the MDBF above). If a mobile browser is found, a mobile version of the view can be processed and sent to the client. The mobile views can exist in a pre-defined folder structure convention. The can be context driven partial views for items such as Room Properties and Equipment Properties that have associated “data types” such as “String” or “Image” or “PDF.” The application can use partial views for the entry and display of content.

Controller actions (or GET/POST action pair) can be associated with a specific View Model with the naming convention “{Controller} {Action}View Model”. The View Model can contain all the information needed for the views returned by that action. There can be several data objects that are members of a 1-M parent-child relationship. Screens for such parent objects can be handled using the following methodology: there can be one “Add New Child” JavaScript link and one “Remove Child” link per child object. The “Add” link can call a Render Action method linked to the Create method of the appropriate controller. The “Remove” link can call the jQuery remove( )method to remove the child from the DOM. The form submit input button can call a JavaScript Renumber( ) method via the “onclick” attribute. The Renumber( ) method will renumber the N children object from O to N−1. During the POST event, the default model binder can automatically instantiate N new children objects and “smartly” assign their properties from matching POST parameters with the same name. The collection of POSTed children can be matched against the set of any existing children for the parent object. New POSTed children can be added to the parent, missing POSTed children can be deleted from the parent, and matching/existing POSTed children will be updated.

Users can be associated to the Building objects to which they have access. These associations can be maintained via User Administration screens. On those screens, Buildings can be grouped by Account. A User's Role is defined as a collection of Permissions. Permissions can be the lowest functional unit of security. There can be an association between Permissions and MVC (Controller, Action) pairs. By default, if any user requests an Action from a Controller for which there is no associated Permission, then that Action can be denied to the user (known as “white-listing”).

The system can be Account-centric in that the account unit can be the focal point of client management. There can be one Account per client. Accounts can have an association with a particular Company. Building can be the organizational units used to group Areas. There can be more than one Building associated with each Account, and there can be one Building per Address. Buildings can contain Custom Properties such as external building images, PDFs, etc. Area objects represent functional sub-sections of a building. They can represent floors of the building or floor sub-sections (“East Wing”, etc.) in the case of large floors. Areas can also cover multiple floors. Areas can contain one or more Rooms. Areas can also have Custom Properties. Room objects can represent the smallest level of O&M fidelity above actual pieces of equipment. Rooms can also contain Custom Properties such as “Paint Color”, “Number of Light Fixtures”, etc. Special Rooms can be marked as “templates”. These Rooms can contain a set of common data elements from which derived Rooms can copy initialized data. For example, a “Conference Room” template may be declared from which the Room “Executive Conference Room” or Room “Small Conference Room” may be instantiated. A Room can be created from scratch, copied from a Room template, or copied from another Room. These can be “deep copies”, and, although they will maintain a link to the parent/source Room, they will be independently modifiable entities with no cascading updates to other Rooms.

Equipment object instances can be associated with a Room. Equipment can have Custom Properties. Equipment can also have a quantity value greater than 1 (though, this is only a field/property value, and does not represent multiple data instances). Similar to Room templates, Equipment templates can be intended for the user to create an Equipment instance containing common data for one or more derived Equipment. Equipment can be created from scratch, copied from an Equipment template, or copied from another Equipment instance.

A Custom Property can be a mechanism to allow users to add custom data items to Buildings, Rooms, Equipment, or other supported objects. A Custom Property can be comprised of a value and a Custom Property Type. A Custom Property Type can comprise a Name, Description, a class to which the property applies (Building, Room, etc.), and a Custom Property. Type Data Type. The Custom Property Type Data Type can determine the data entry and display method for Custom Properties. It includes such data types as: String, Number, Image File, PDF, List, URL, parts, and Date and Time. Equipment can have links to Vendors, Service Providers, and Subcontractors. Work Orders support a way to initiate, assign, and track maintenance actions associated with Equipment. Work Orders can also be associated to Users via the Requested By and Processed By navigation properties. All user-submitted files can be stored as binary blobs in the data store. Each file record can use File Properties to store file name, mime-type, etc. File Properties are (Name, Value) pairs to store File metadata. Image annotations can be stored in the same file properties object as other file properties.

For the mobile application, the home screen can consist of two large icons in the middle of the Portal Window. On the top or left will be a large version of the “Home” icon. On the bottom or right can be a large version of the “Scan” icon from the menu strip. The icons can navigate to the same place as their menu strip counterparts. The application can open to a start page with two large icons. The screen can consist of a real-time display from the photo-capturing device. There can be two buttons (either touch-sensitive areas on the screen or physical buttons elsewhere). One button can activate the photo-capture/QR scan. The other button can take the user to the application settings.

A live camera view will be visible on the screen during barcode capture. The scan engine can be enabled for all available barcode symbologies. Upon the successful scan of a barcode the browser can be directed to the URL defined in settings property and append the decoded value as a query string. Request the setup of administrative password on first entry. Require password setup before entering settings page. After initial setup of password, password is required for entry into administrative settings. Settings will control account information and target URL for app-controlled web page navigation. Settings include such things as Account Number, System URL; Home URL Segment; Work Order URL Segment; Scan URL Segment; and Admin password (password chars).

The details of the invention and various embodiments can be better understood by referring to the figures of the drawing. Referring to FIG. 1, a top-level block diagram of the facility content system architecture is shown. The diagram shows a customer network 100 located at the facility being managed. The facility being managed can be denoted as the client location 102 where the customer network is located. The customer network 100 can comprise a network of client desktop users 104 and client mobile users 106. The client desktop 104 can be equipped with a user interface and browser application that communicates across a network via an HTTP protocol interface. The client mobile users 106 can include mobile web browsing applications for communicating via the network. The customer network can be interconnected with a remotely located web server via a dedicated VPN or interne connection. The remotely located web server can be hosted remotely. The web server 108 can provide content and web services applications. The web server 108 can be networked with other servers such as the file server 110 and the database server 112 and other legacy servers such as the ERP server 114. The web server can also be communicably linked with various different work stations where administrative users can interface with the various servers.

Referring to FIG. 2, an illustration of a top lever system organizational diagram is shown. As noted above the system can be considered account centric in that the data-base structure as well as the navigational flow is centered on the client account. Within a client account 202 there can be multiple buildings 204 for which data is associated. Within each building construct there can be multiple areas 206 for which data is associated. And within an area 206 there can be multiple rooms 208 for which data is associated. Each room 208 can have various different data constructs associated thereto, including equipment installed in the room, where the equipment installed can be associated to a general equipment type. Each room 208 can also have finish types 212 associated thereto. The finish types can include data associated with finish details or part details for interior finishes. Each finish detail can be associated, with a finish type as, well as a part detail such as make and model. Also, each room can have various images 214 associated thereto. The images can include room home images, key plan images, mechanical views, electrical views, etc. Each room can also have custom properties 216 associated thereto which can include supplemental information regarding the room. Each Custom Property is created from a parent Custom Property Type that includes property type and data type.

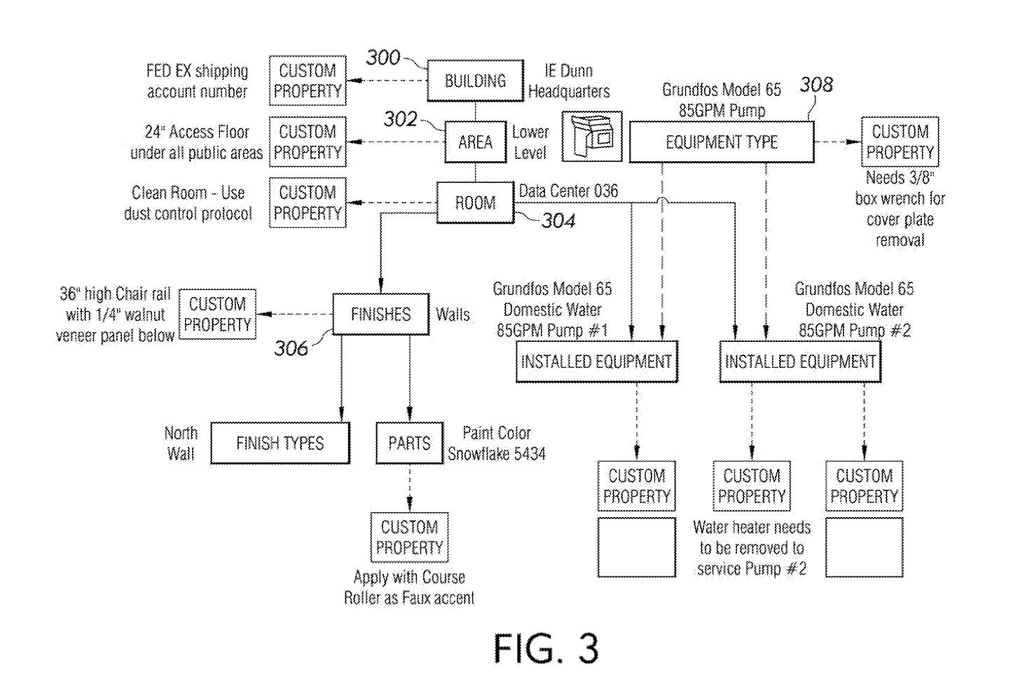

Referring to FIG. 3, a further illustration relating to FIG. 2 is shown. The building is reflected as a specific headquarters building 300 having associated thereto a specific custom property such as a FedEx shipping account number. A specific area of the building is identified as the lower level 302, again having a custom property associated thereto such as a twenty-four-inch access floor under all public areas. The room identified is specifically identified at the data center 304 which also has a custom property associated thereto (in this case a clean room using dust control protocol). The finish identified for the room is a wall 306 which has a custom property associated thereto, which in this case is a thirty-six-inch-high chair rail. The finish can have a finish type, which in this case is a North wall, and the parts for the finish in this case is a Sherwin Williams Snow Flake color. A custom property associated with the paint or part is a custom property which designates application with a course roller or faux finish accent. The equipment types specifically identified is a pump 308 and a specific model number is identified for the installed equipment.

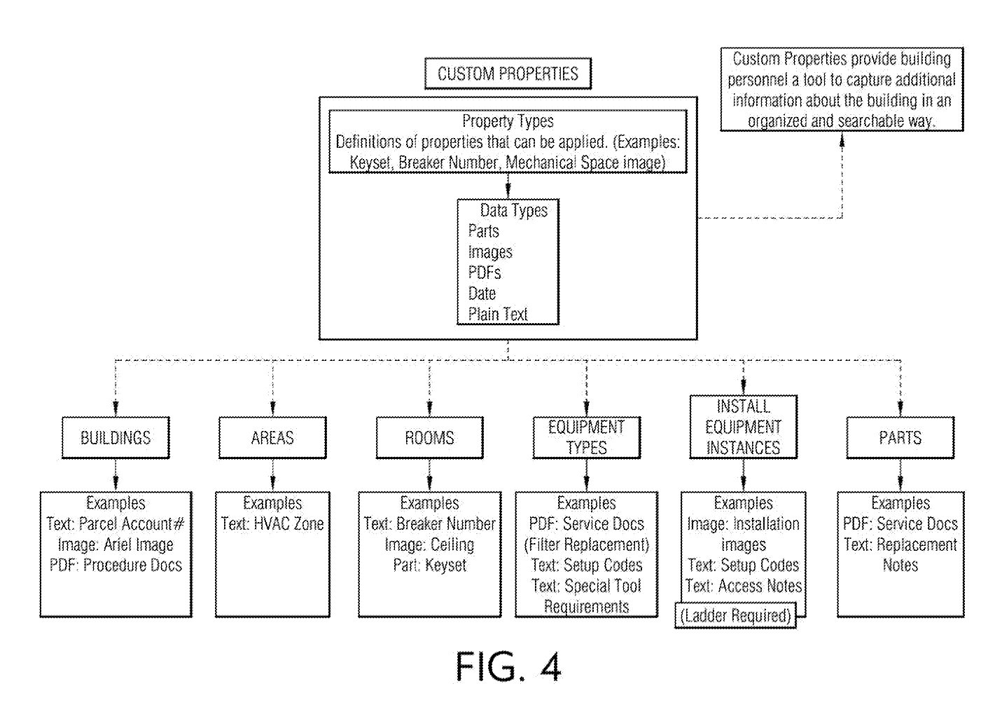

Referring to FIG. 4, a further illustration is provided as to how custom properties can be utilized to provide building personnel a tool to capture additional information about the building in an organized and searchable fashion. The custom properties can include property types and/or data types such as parts, images, PDFs, dates, URLs, Lists, and plain text. Custom properties can be associated with each of the main sub categories including buildings, areas, rooms, equipment types, installed equipment, work orders, and parts.

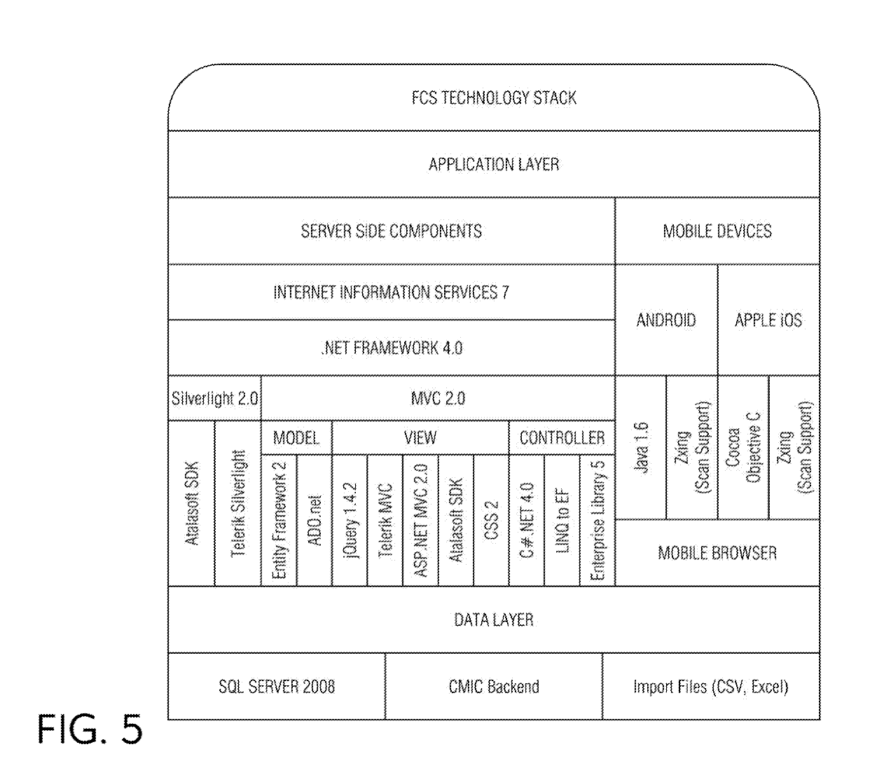

Referring to FIG. 5, the facility content system technology stack is shown having an application layer and a data layer. The application layer can include service side components as shown and mobile device components as shown. The data layer can include an SQL server database, various legacy databases including the ERP database as shown and various import files.

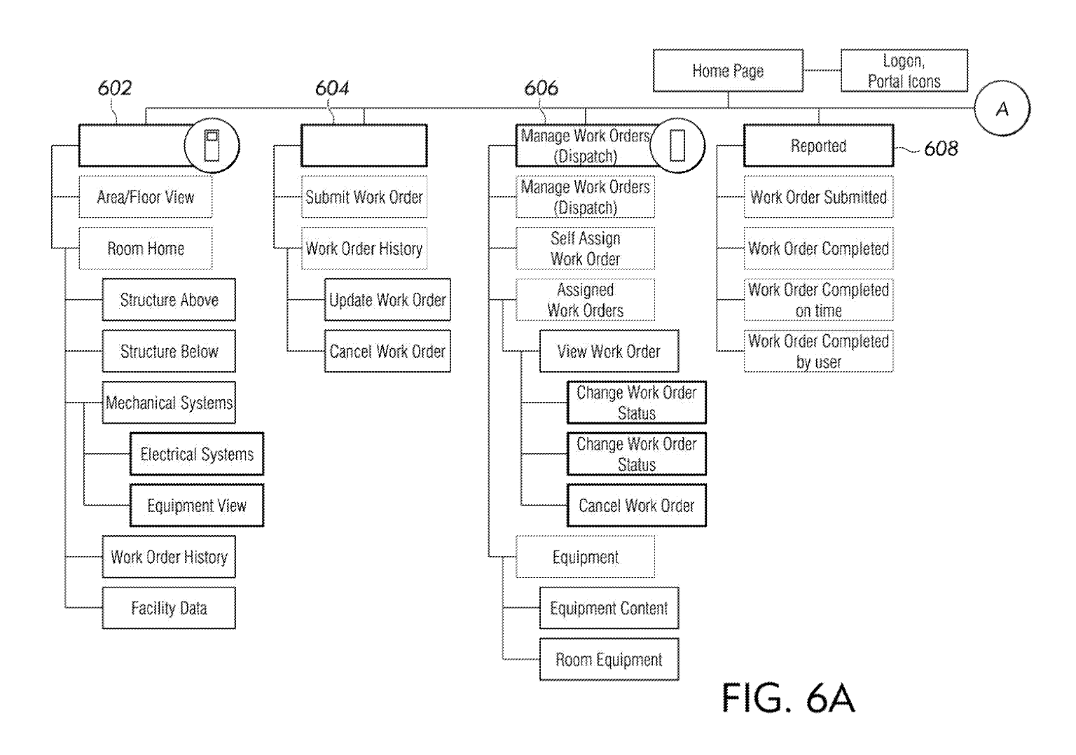

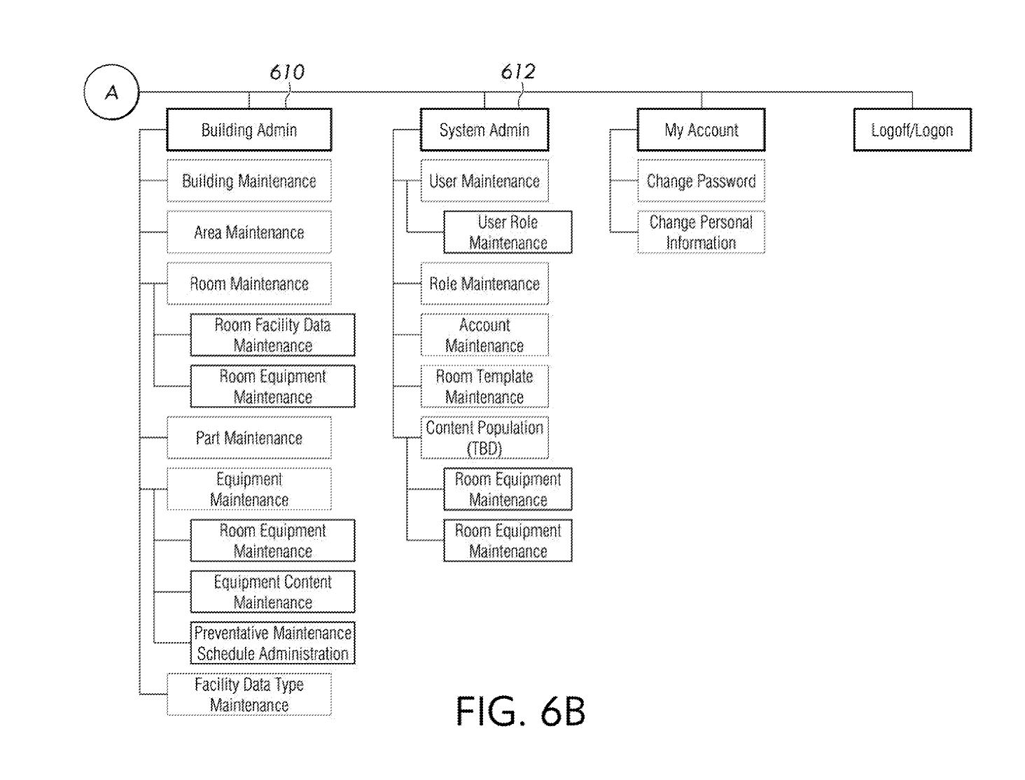

Referring to FIGS. 6A and 6B, a facility content system site map overview is shown. This figures provide an illustration of the site map for the user interface which shows the navigational tree structure for the various different pages of the site map. The home page is the top-level page shown on the site map from which a user can navigate to a building view 602, a service request page 604, a maintenance page 606, a reporting page 608, a building administrative page 610, a system administrative page 612, and various other pages as shown. From each main subpage a user can navigate to various other pages and various functions as shown by the site map.

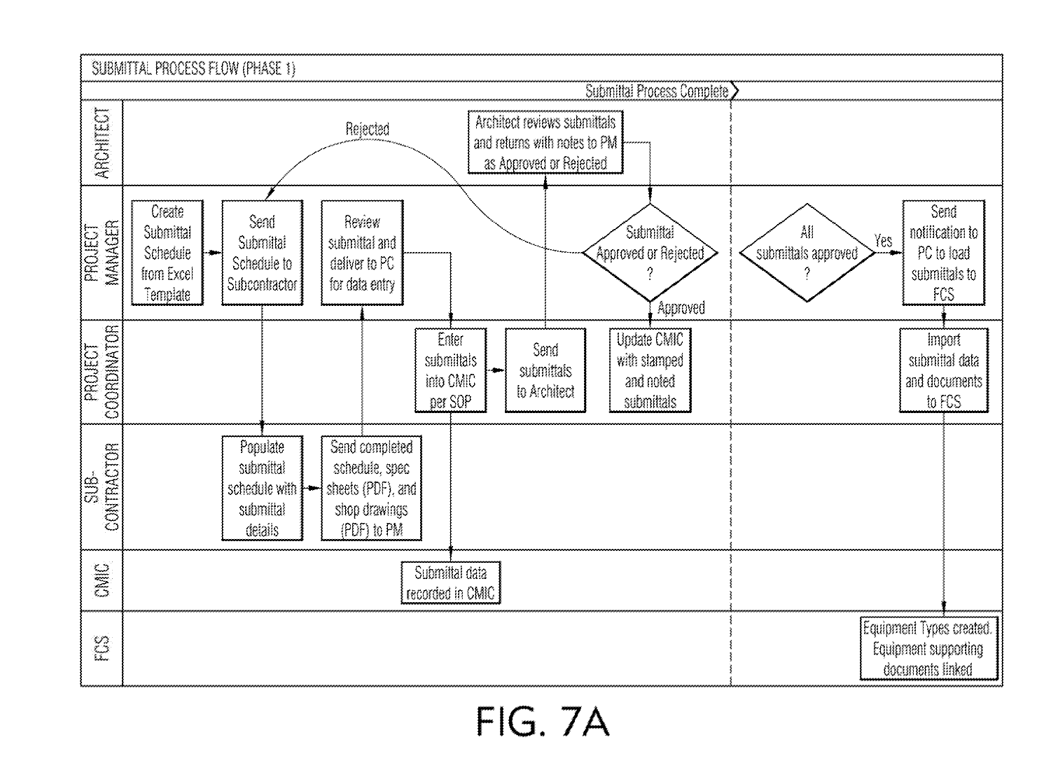

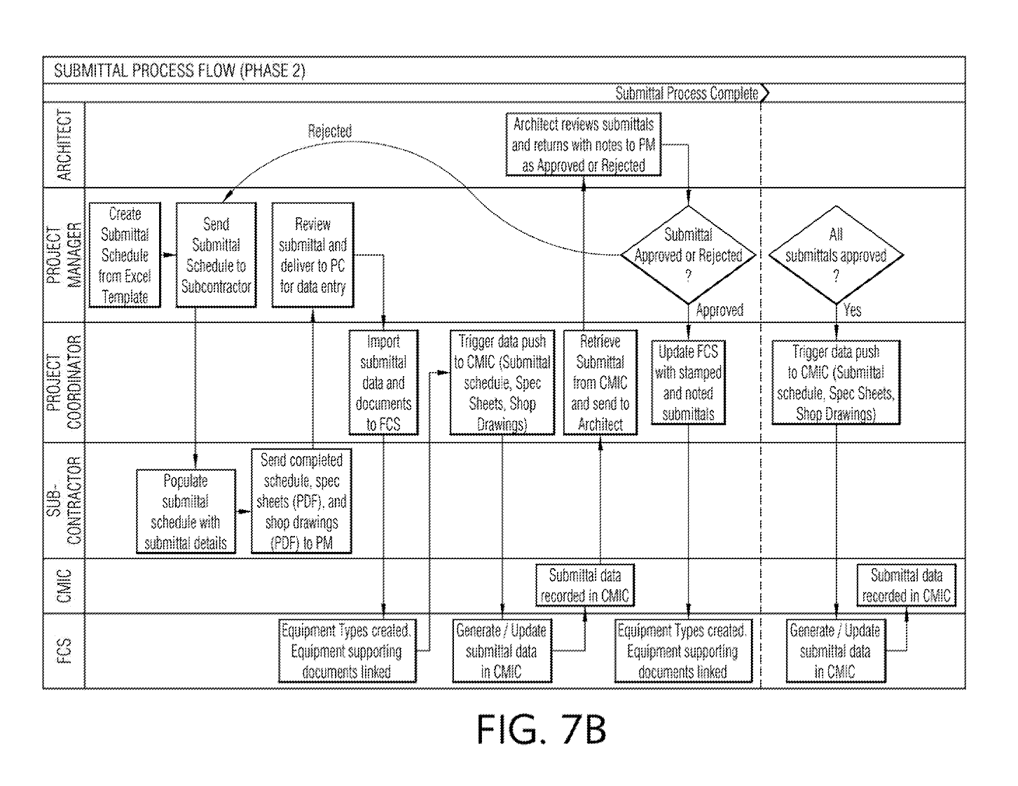

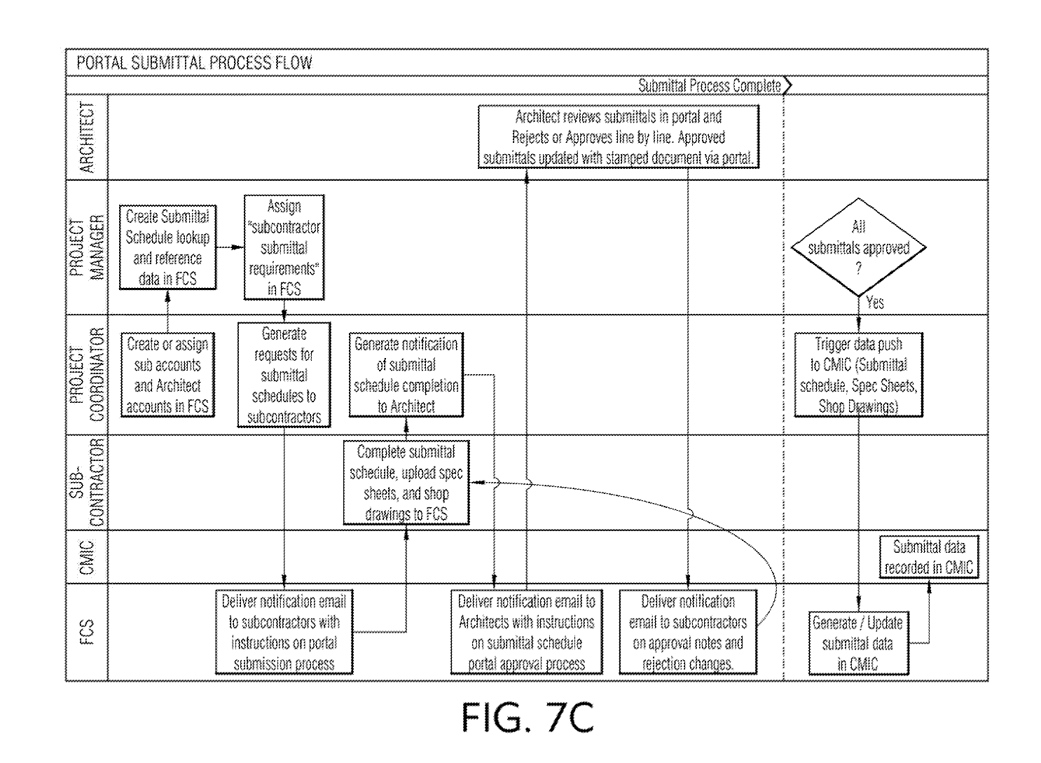

Referring to FIGS. 7a, 7b and 7c, a process flow for submittal of data for initial population of the database is shown. Various inputs from the architect, project manager, project coordinator, subcontractor, and legacy databases are shown flowing into the facility content system database. This initial process flow can be accomplished during the initial construction phase of the facility or building. This process creates a baseline database construct with the detailed design level information utilized during the construction phase of the project. The facility content system allows this information to be modified during the construction phase of the project and upon its completion. Therefore, when the facility content system is delivered to the end user for building management the database is pre-populated and ready for any further modifications to the data as daily operation of the building continues.

In one embodiment of the present invention, FCS can provide a web based “portal” interface to various users, such as project managers and subcontractors, in order for them to supply the details of the various data submittals. This portal can be used in lieu of the various legacy ERP systems, like the ERP, for submittal and entry of data. This embodiment can provide a single point of entry user interface for uniform submittal of data. Data collected in the portal can be pushed or pulled to other systems as required such as to the FCS database server. The total amount of information required by the project managers and subcontractors should not be significantly increased; however, the submittals can be standardized and organized in a more usable format. The “portal” can capture original submittal tabular data as well as the product cut sheet or information sheet. Once this data is collected, the portal can notify the approver of submittals that the submittals are ready for review. The reviewer can access the same portal and be provided with basic markup tools. Once the data has been approved it can be logged into the facility content system. Rejected submittals will start the process over until approved.

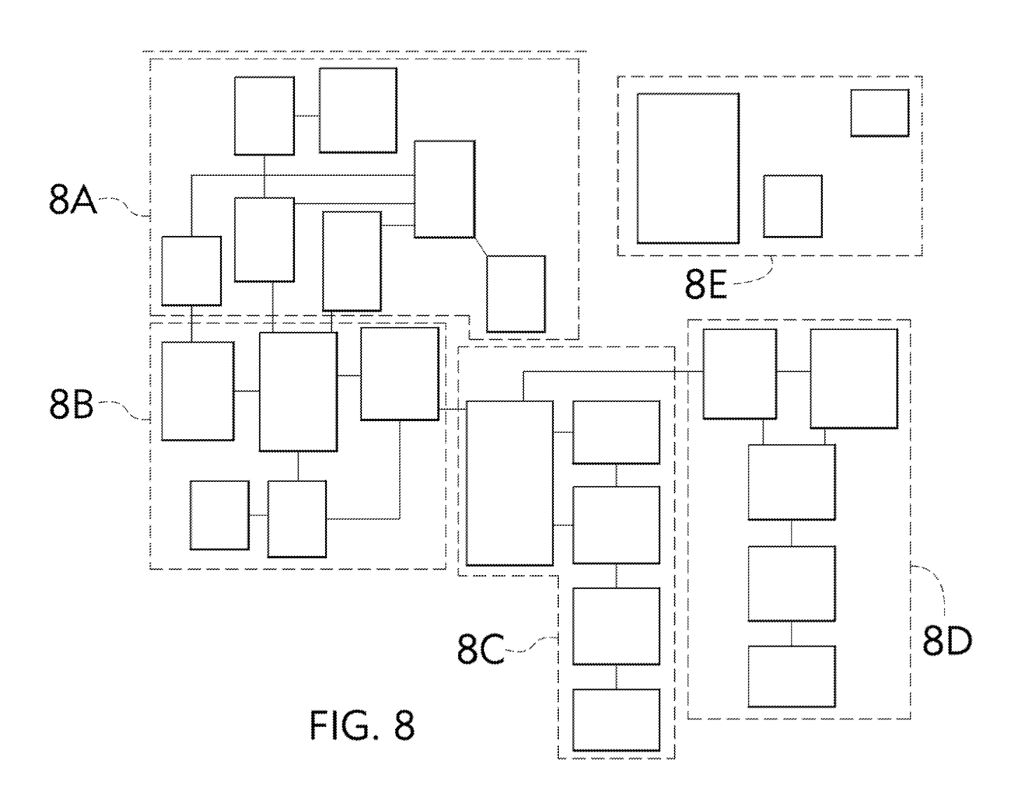

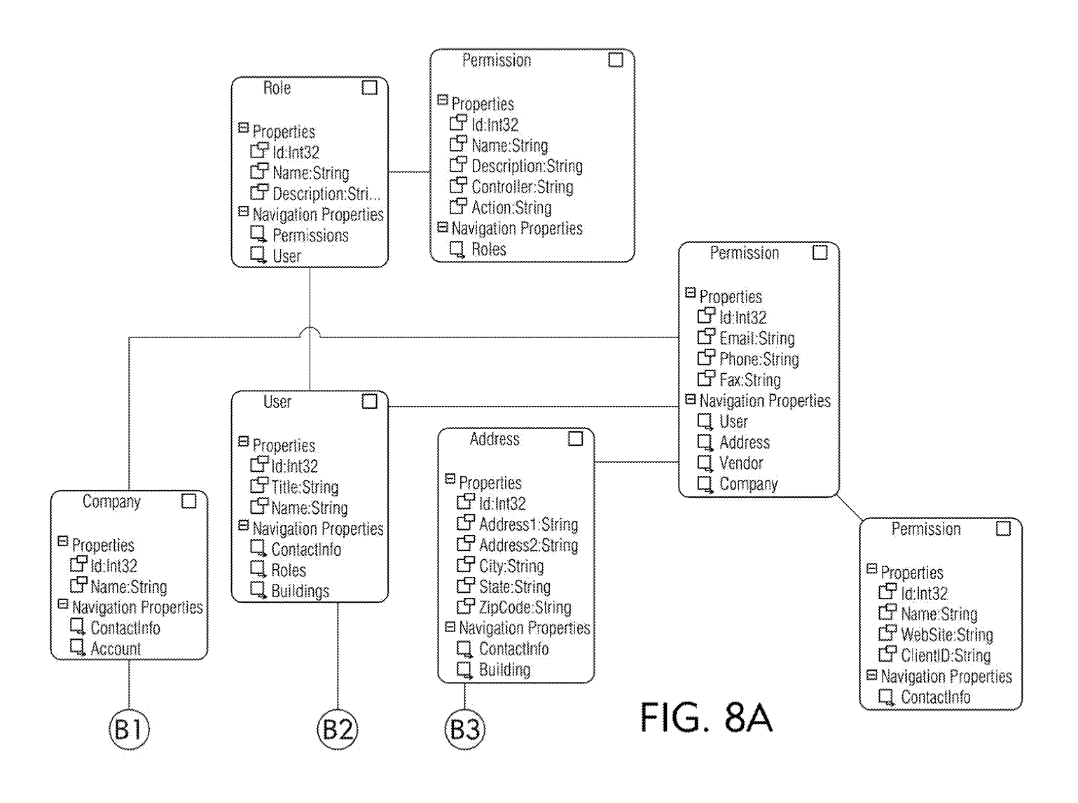

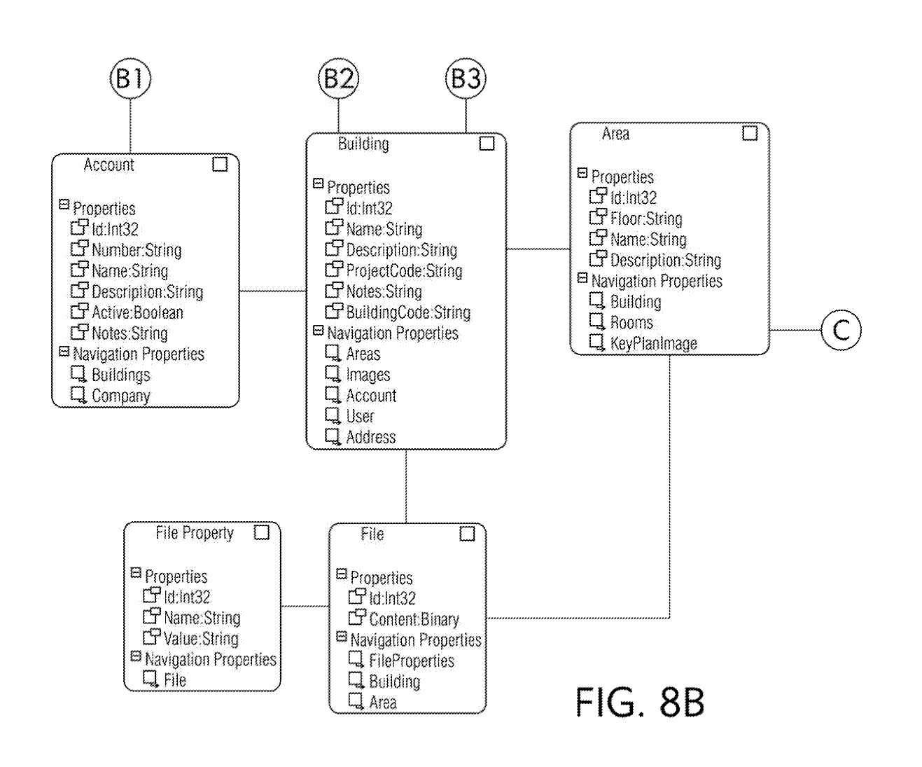

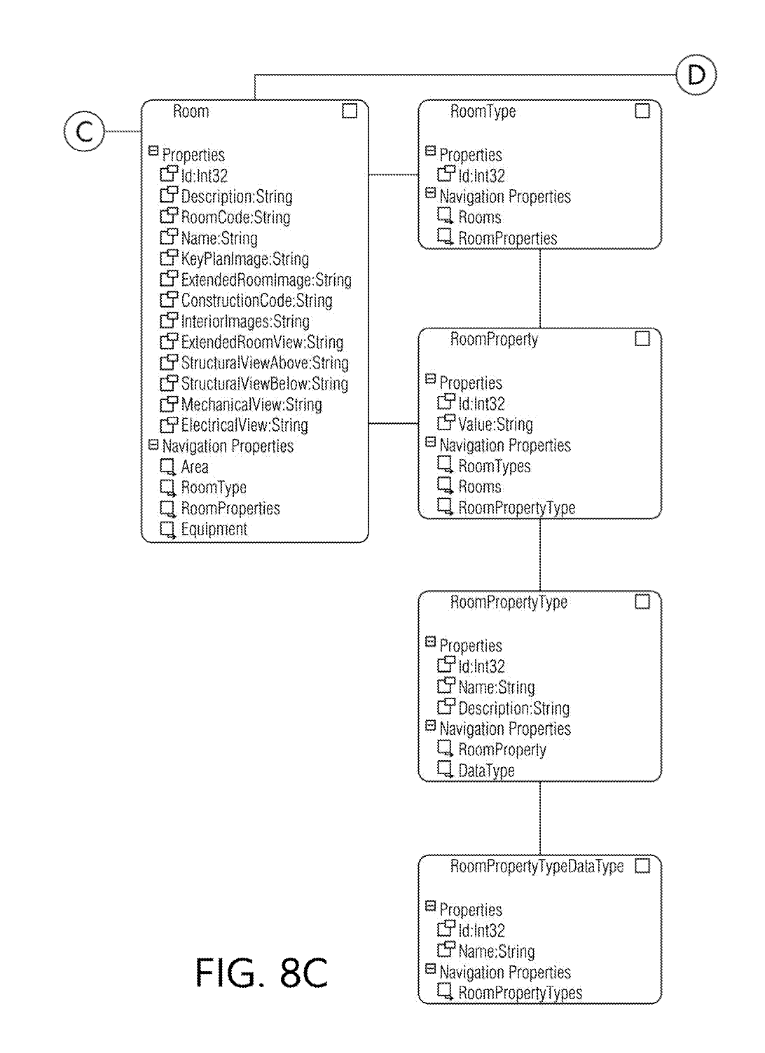

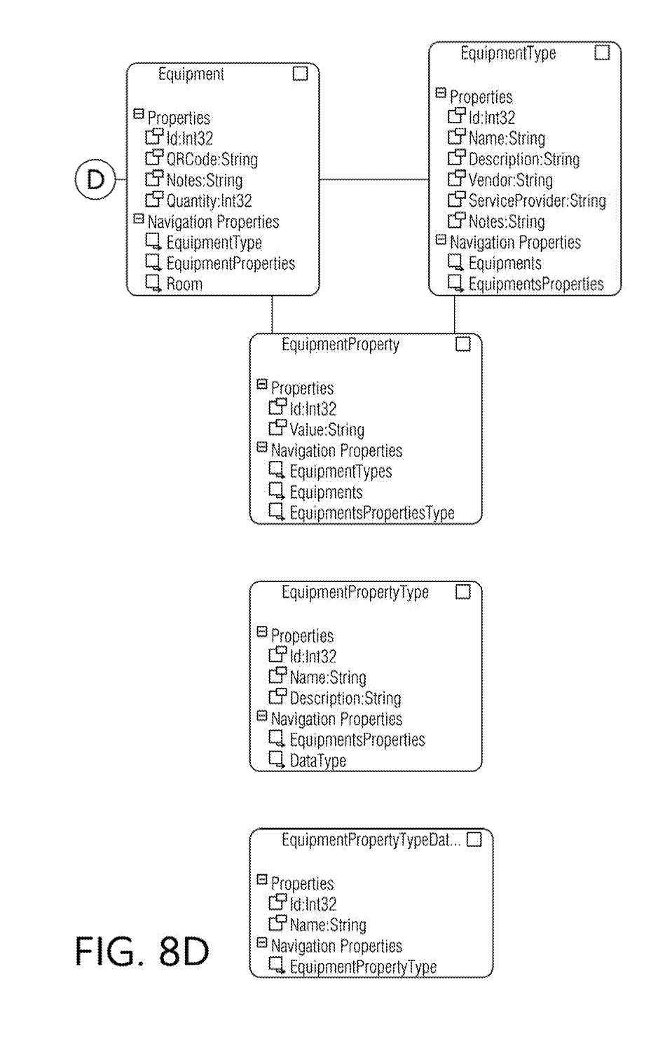

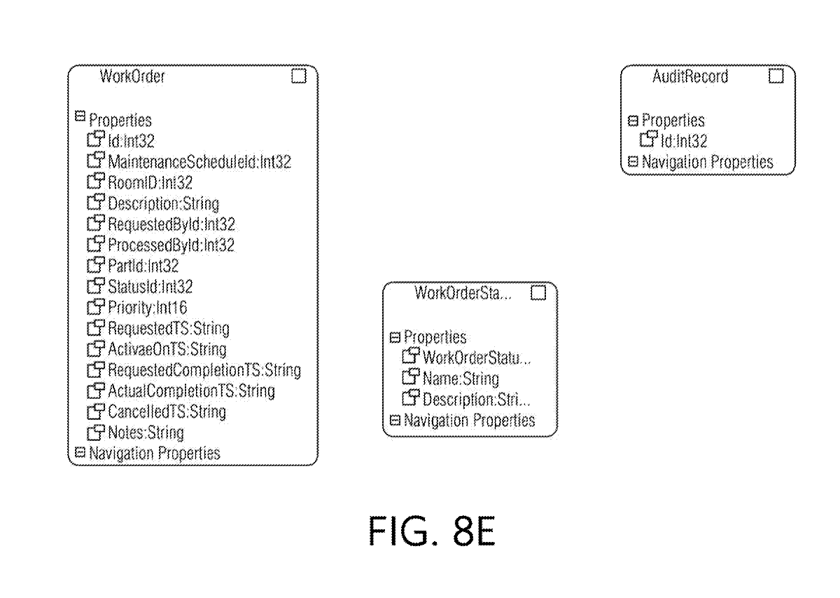

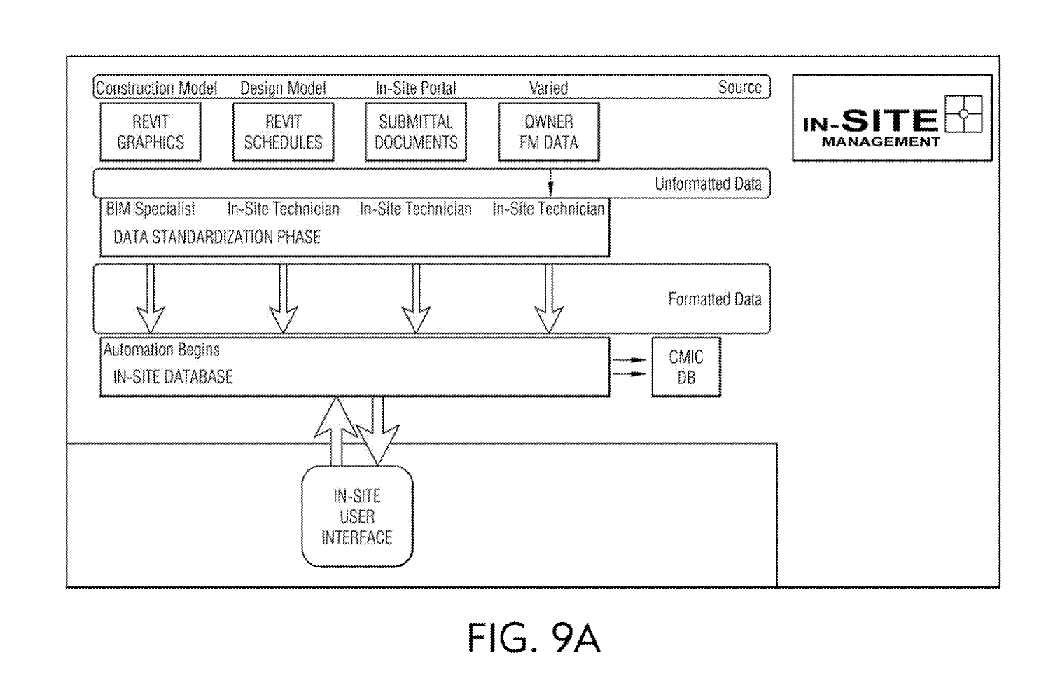

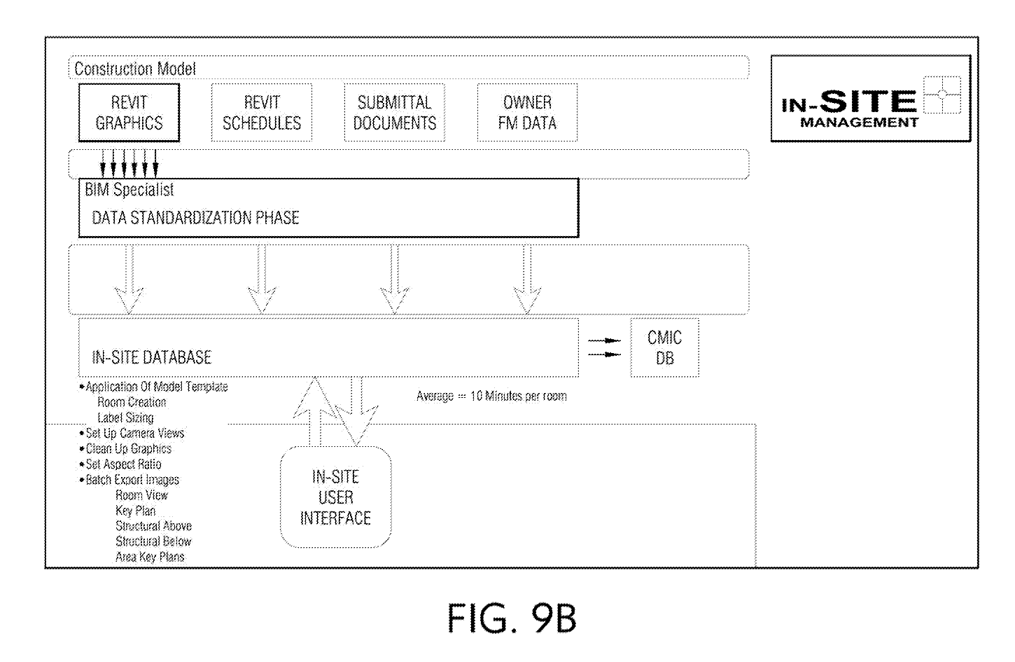

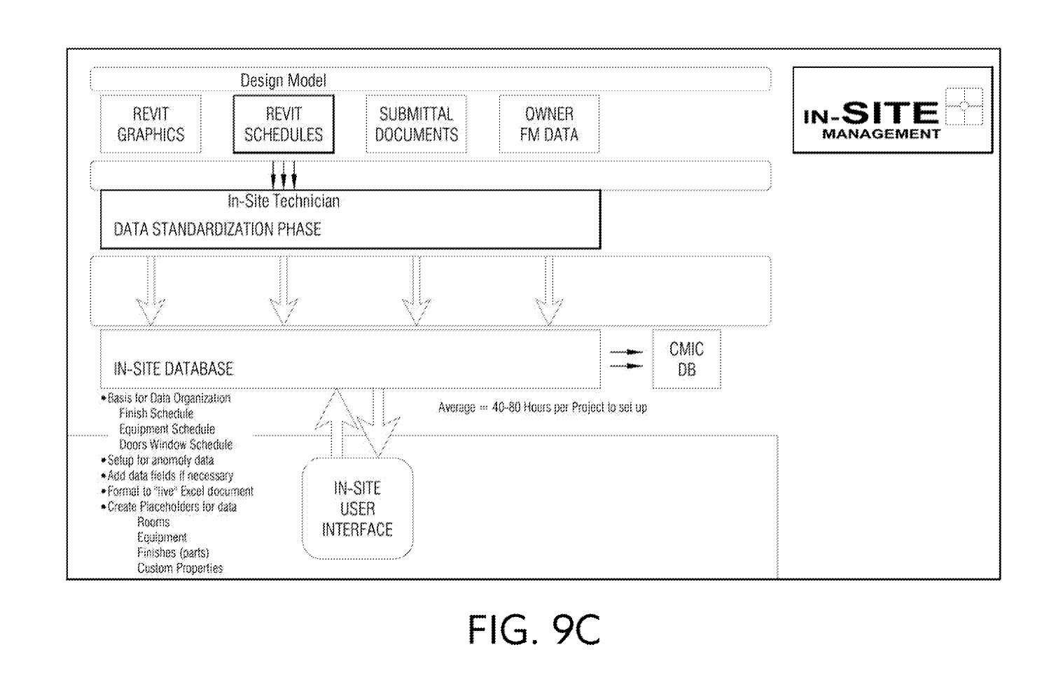

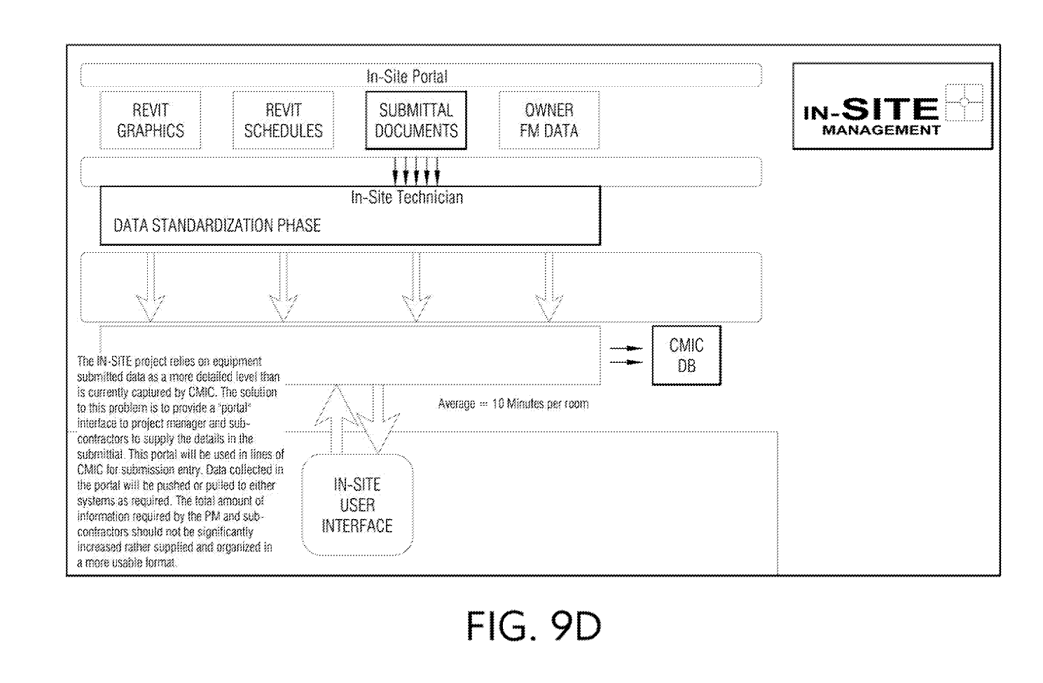

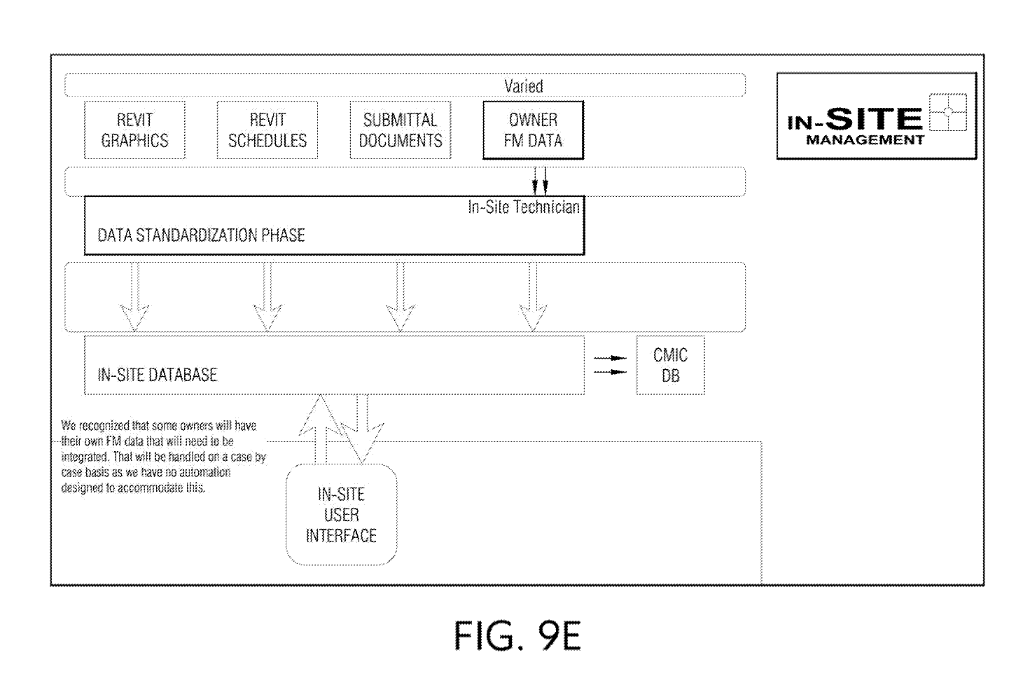

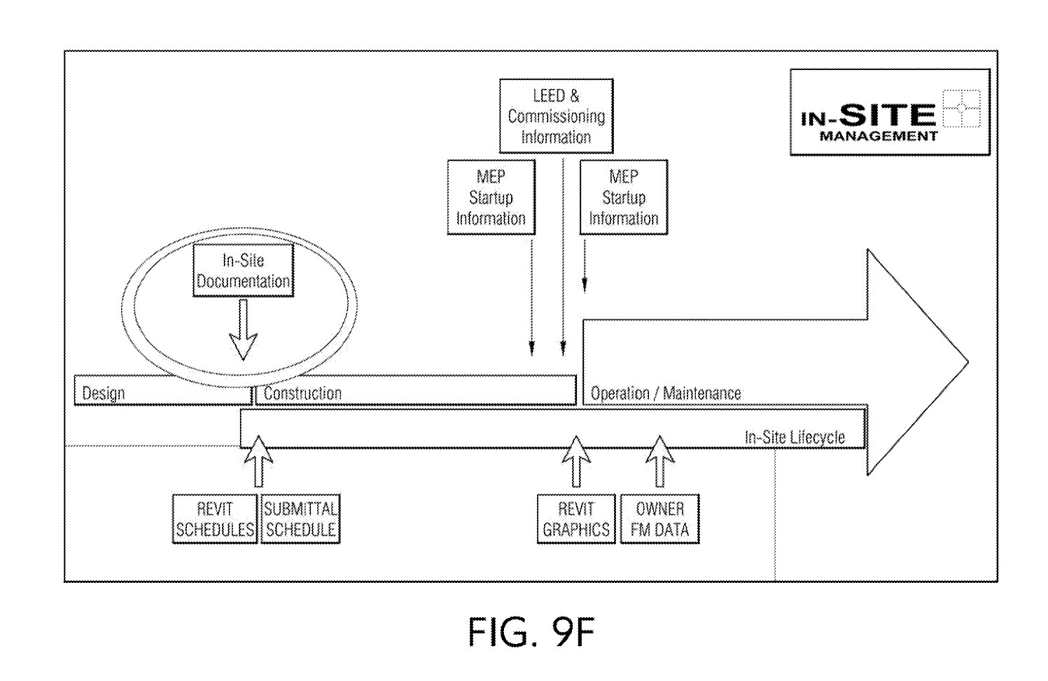

FIG. 8 and FIGS. 8A-8E are illustrations of the basic database construct with the various data fields and data types. FIGS. 9A through 9F are illustrations of the data standardization phase where the unformatted data from various different sources goes through a data standardization phase process where the data is formatted for upload.

During the initial data import process, a reference code can be generated for each piece of equipment of for each room. These navigation codes can be created in jpeg format and emailed to product suppliers. Each piece of product that goes to the site can be tagged with this navigation code that can communicate the products location or any additional instructions that need to be conveyed to the installer. All of this is possible by associating the ID code with the navigation code early in the construction process allowing the code to be used throughout manufacturing, shipping, installation, punchlist, project closeout and, finally, facility management phases.

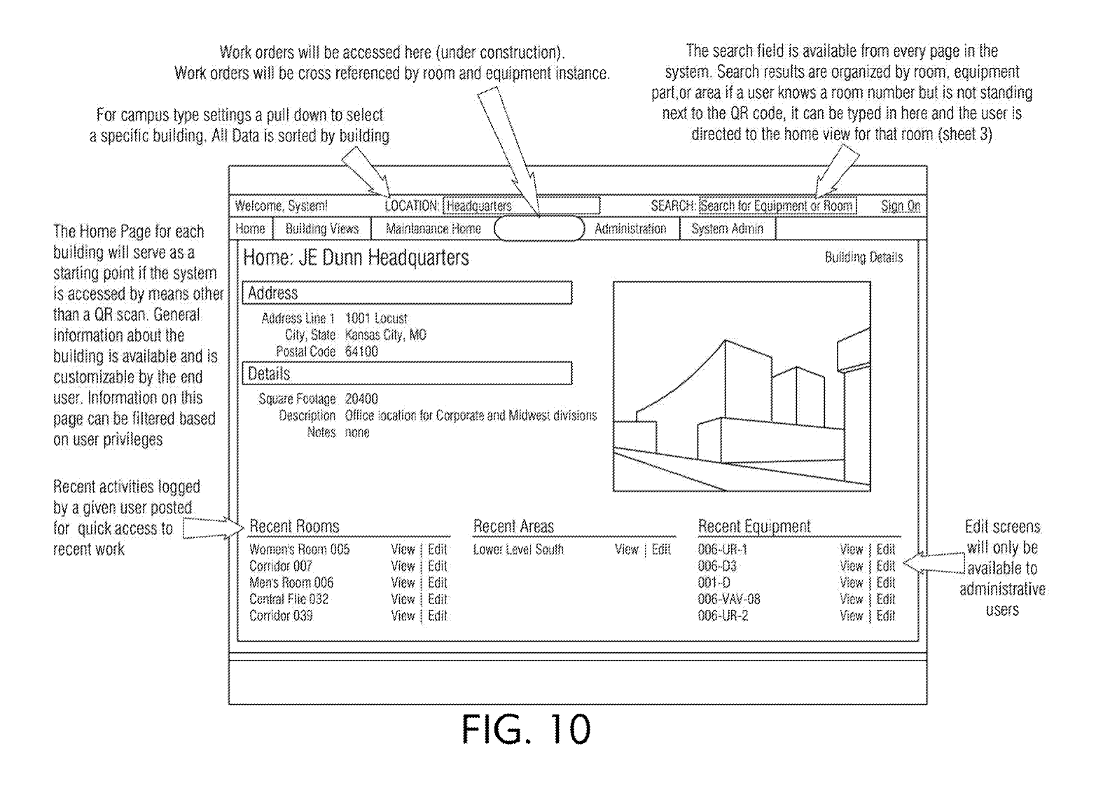

FIG. 10 is an illustration of a home page view for a given building which can serve as a starting point for a user accessing the system. General information about the building can be made available on the home page for viewing by the user. Again, the system is account centric therefore, from this home page view, a user could navigate to a different building or a location under the same account. Further, from this view a user can search based on room equipment part or area as sub categories under the building currently selected. This view can also provide the user with information relating to the most recent searches or views for which the user has accessed for quick navigation back to that location. From this home page the user can navigate to various building views, maintenance items, work orders, administration functions, and various system administrative functions if they are accessible to a given user.

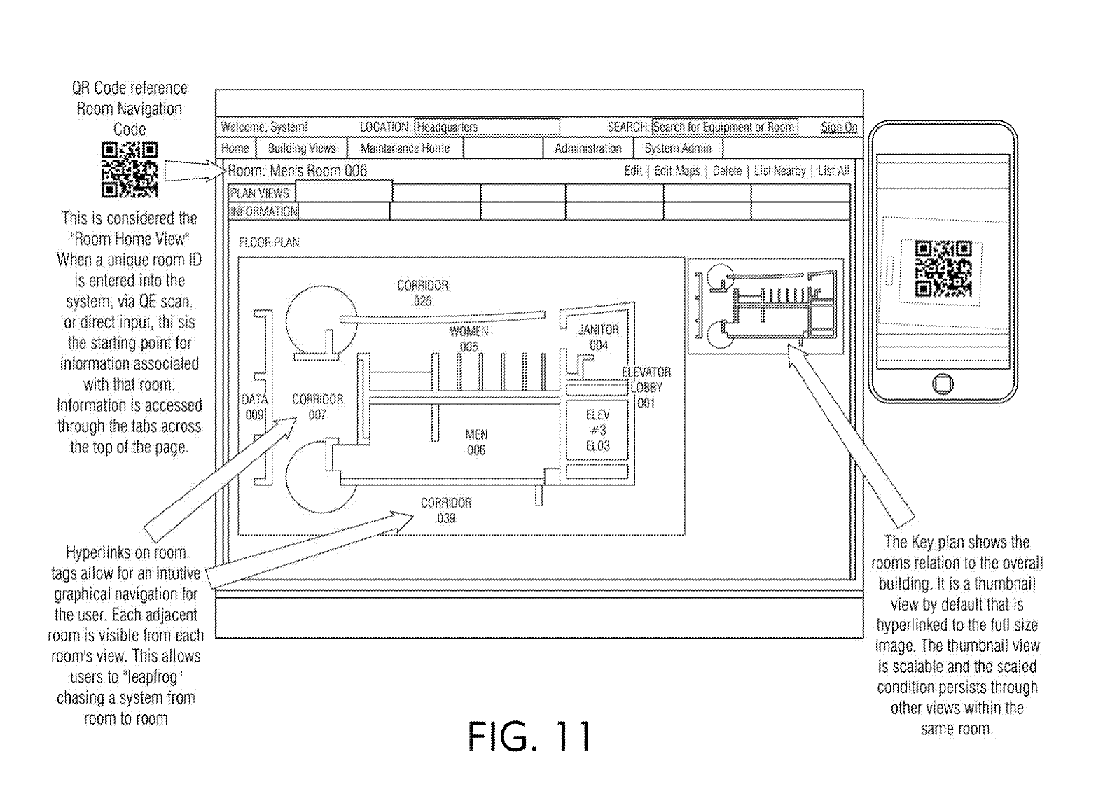

FIG. 11 is an illustration of a room home view which has been located by a unique room ID entered by the user via a QR scan or direct input. By identifying a unique room ID, the user can bypass an area view and navigate directly to a room home view as shown. Contained within the room view can be hyperlinks that allow the user to navigate to adjacent room views without having to navigate backwards. The key plan can also be shown in this view which provides the user with the relationship of the room to the overall building. This thumbnail view can be hyperlinked to a full-size image and can be further scalable. This particular illustration or view within the room home view is the floor plan illustration.

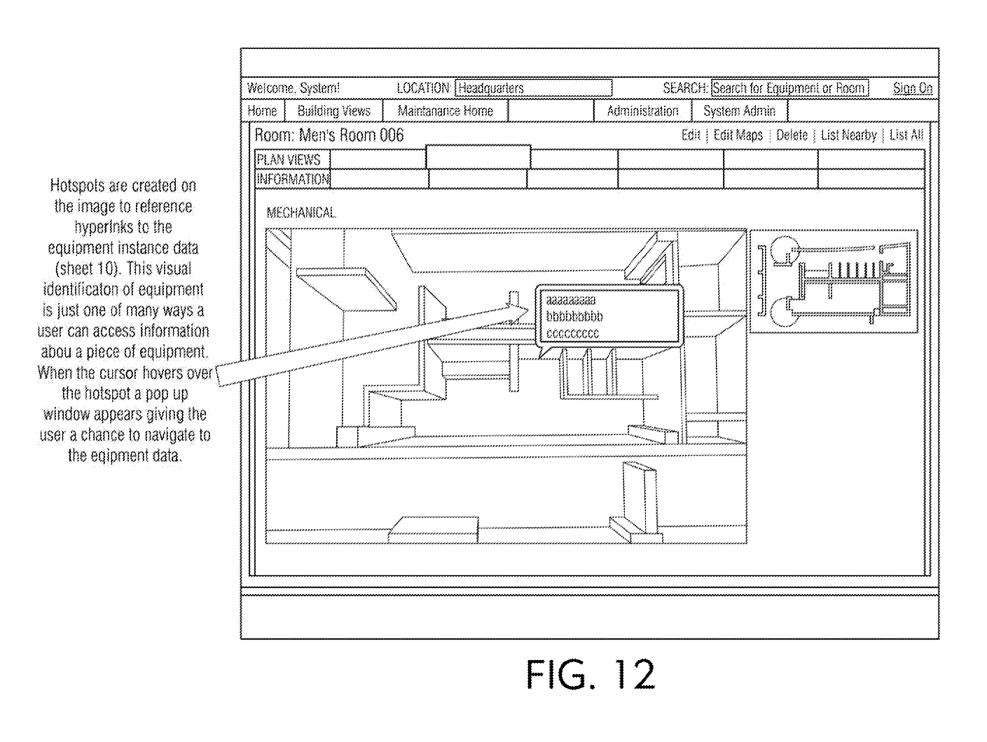

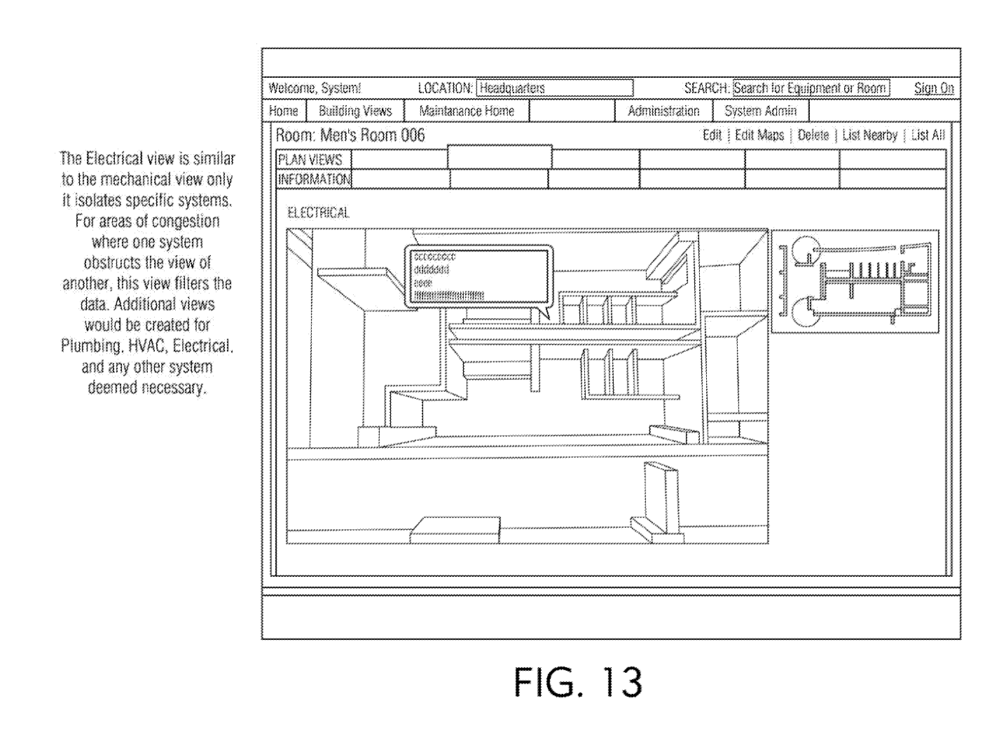

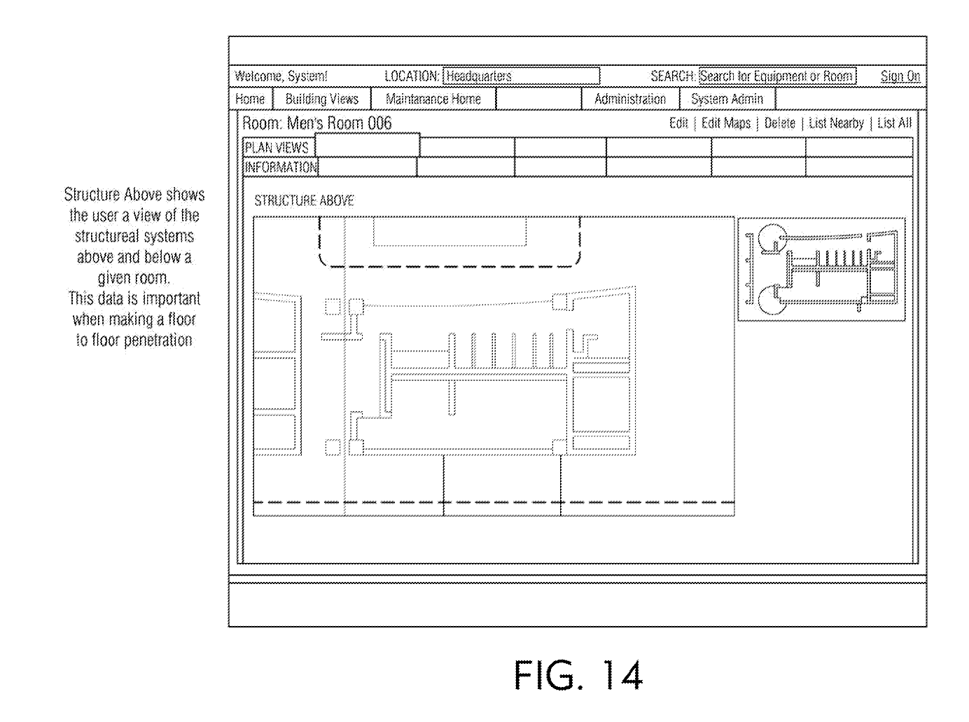

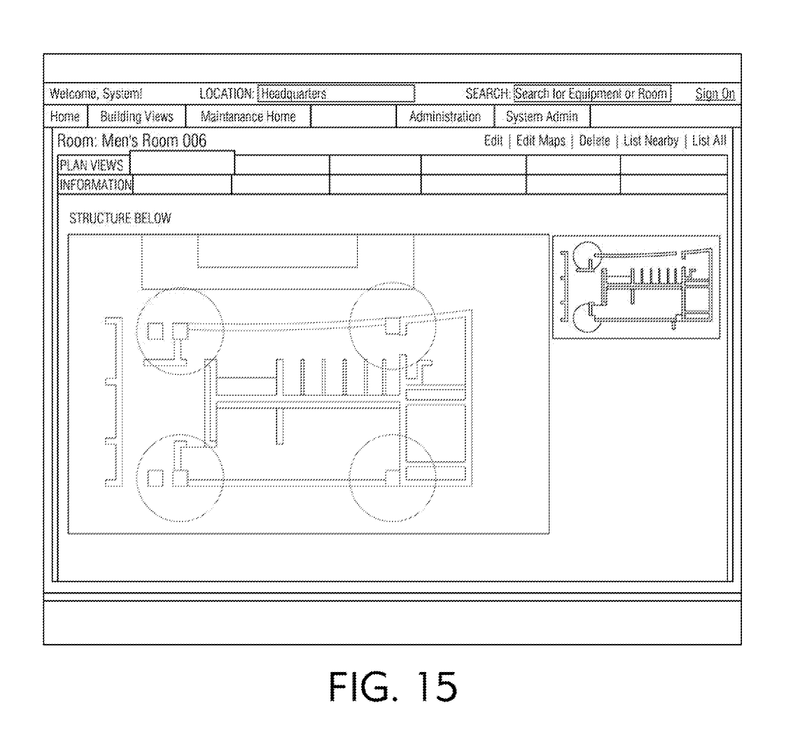

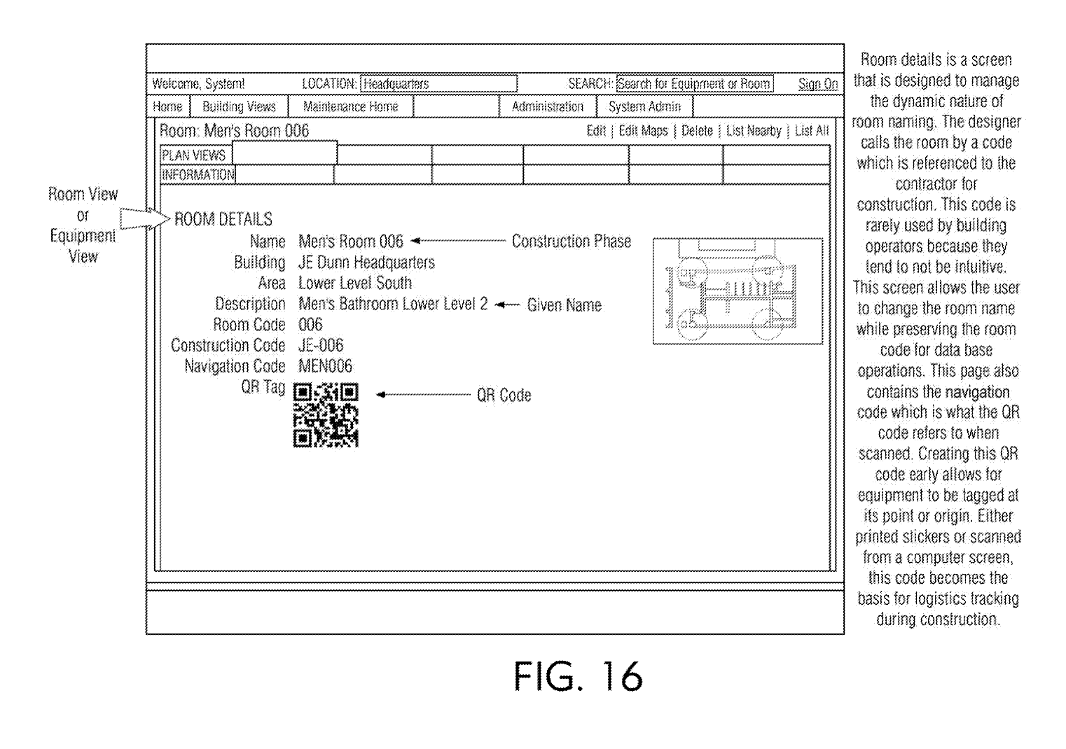

FIG. 12 is an illustration of the mechanical view. The mechanical view as shown in FIG. 12 can have various different hotspots that are created having hyperlinks to certain equipment shown in the view. The user can navigate to the equipment data by selecting the hyperlink. Similar to the mechanical view shown in FIG. 12, FIGS. 13, 14, and 15 illustrate the electrical, structure above and structure below view respectively. FIG. 16 illustrates the room details.

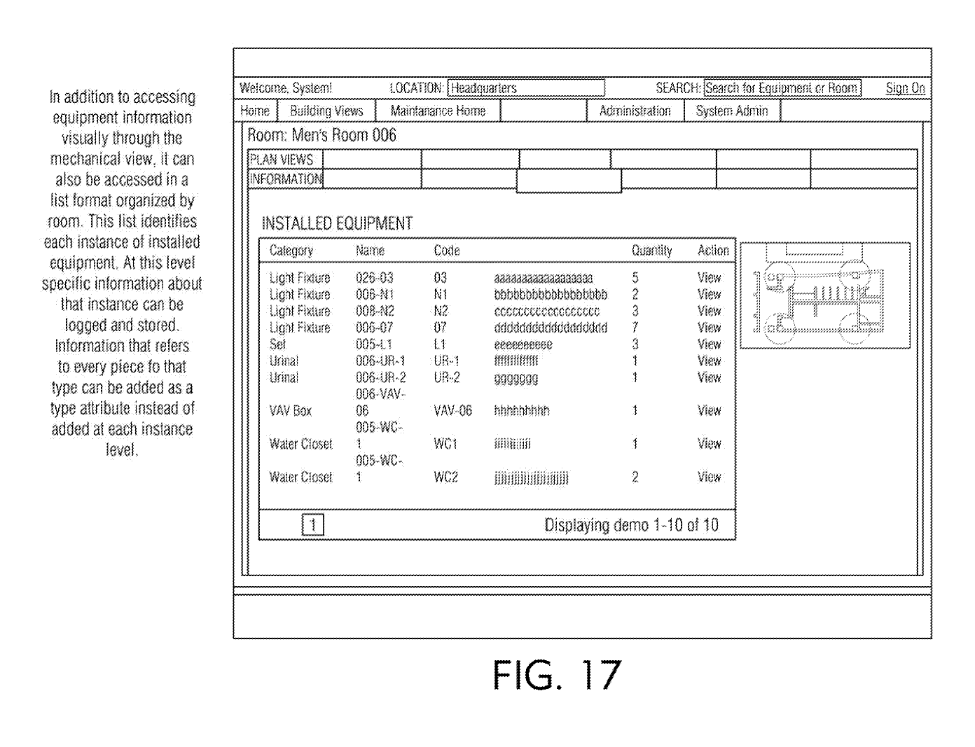

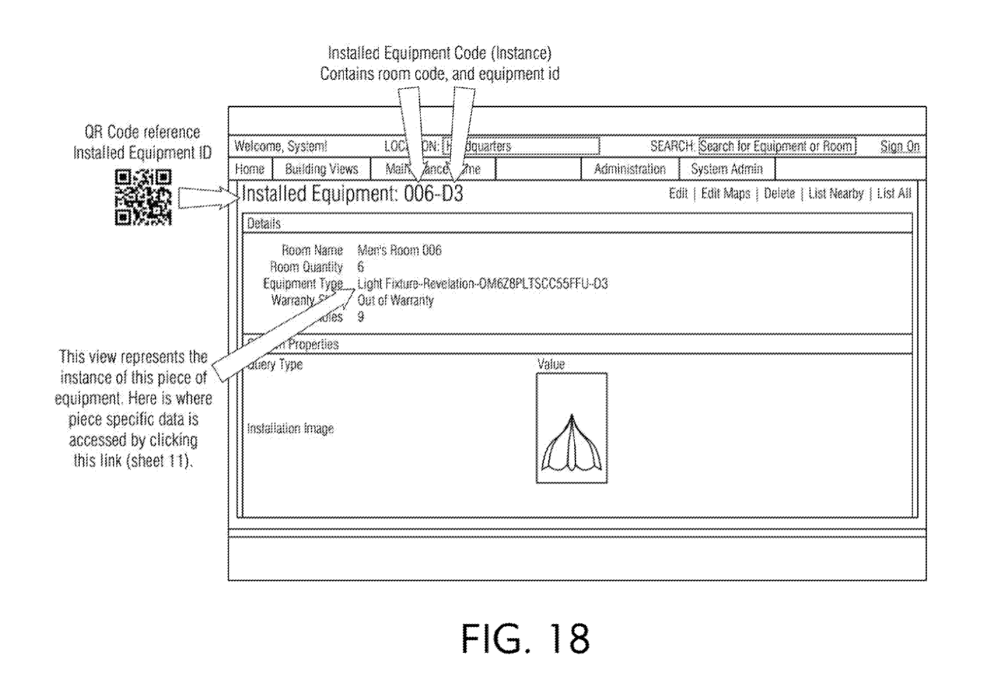

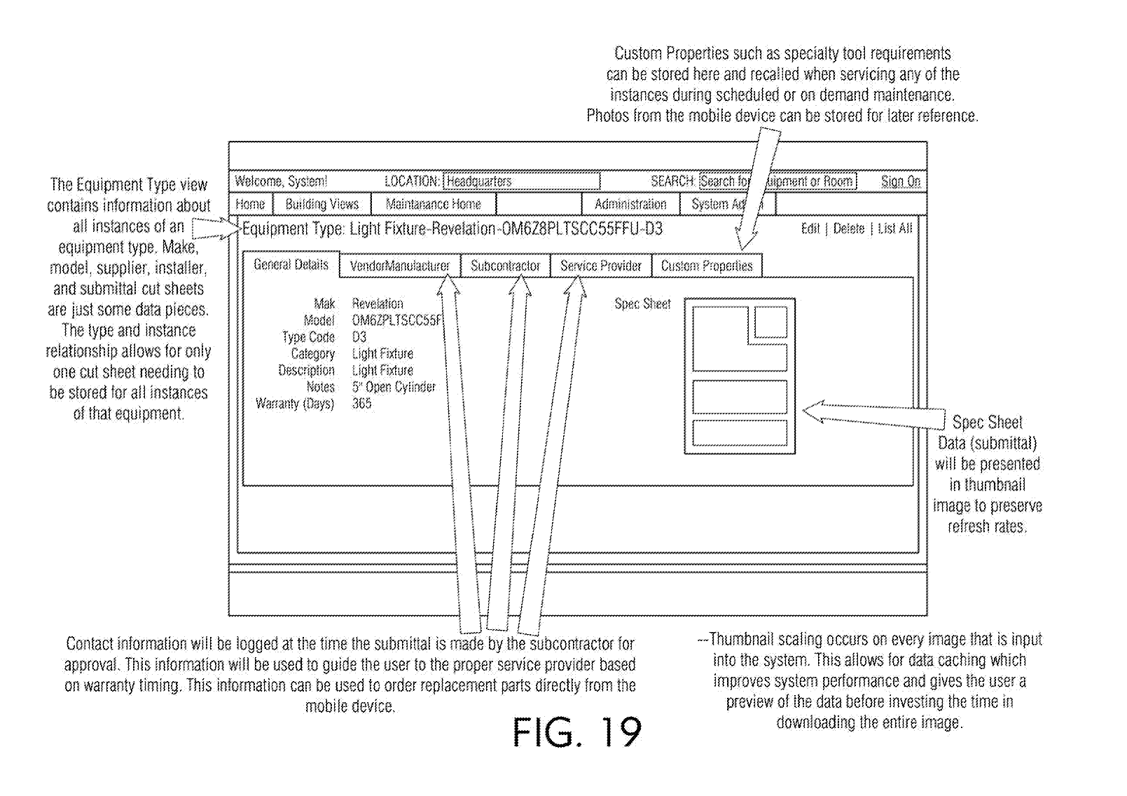

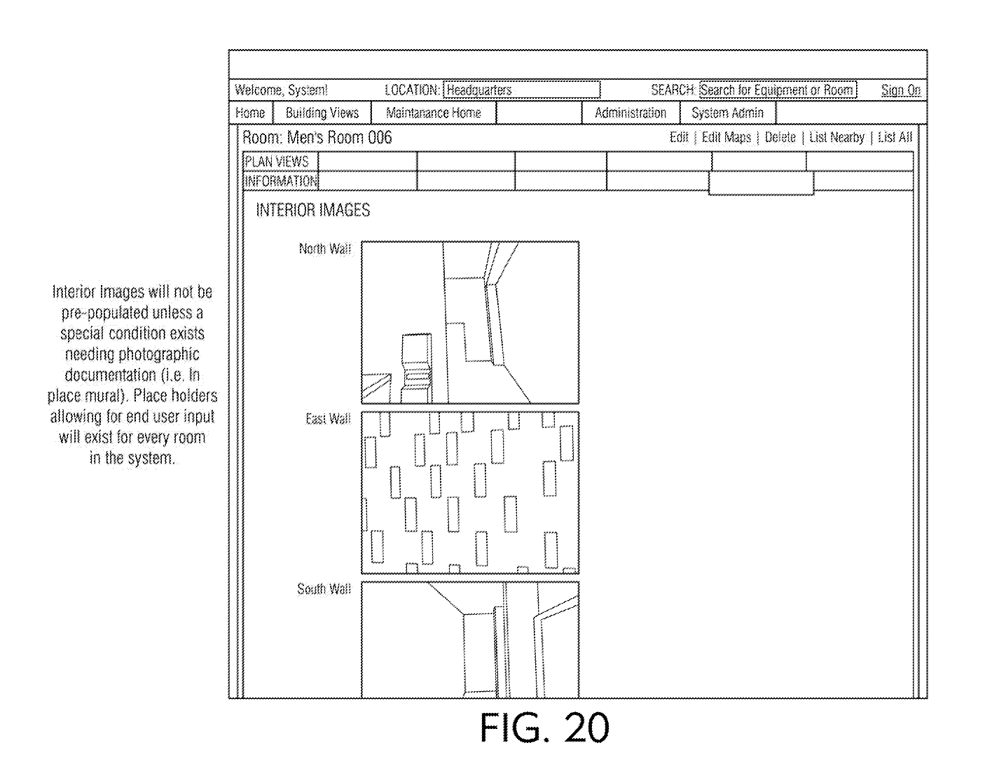

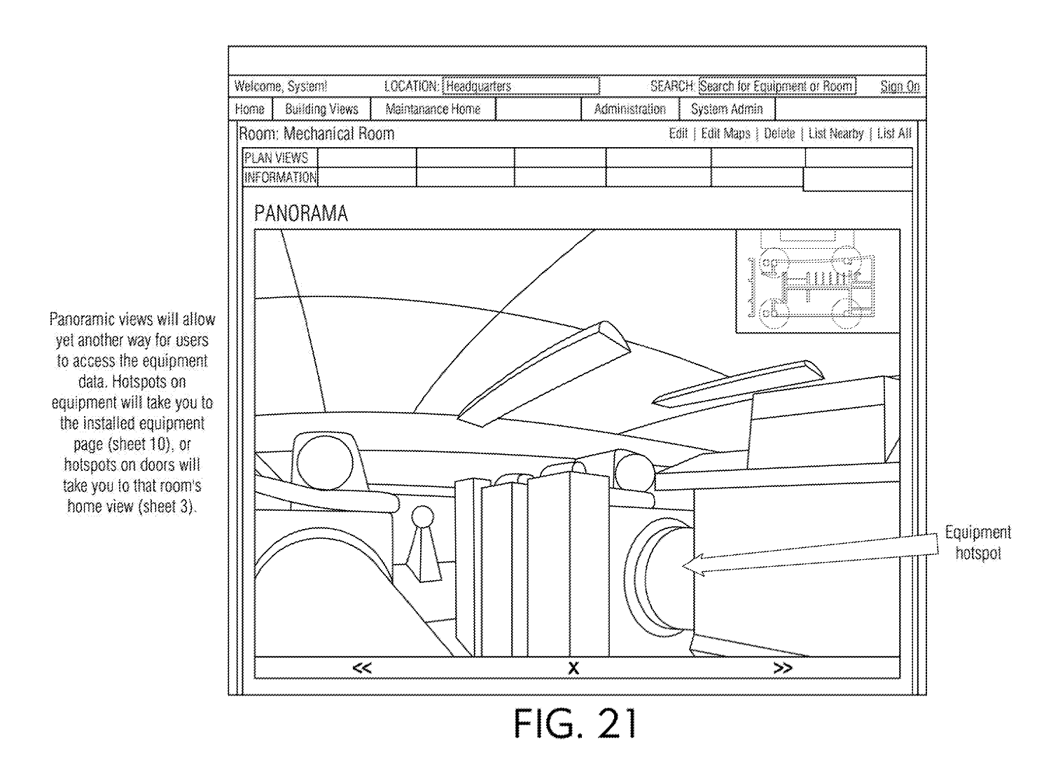

FIG. 17 is an illustration of a list of equipment installed in the room. Any given item in the list shown in FIG. 17 can be selected and further detail can be provided as illustrated by FIG. 18. Equipment type information as well as custom properties can be further viewed as illustrated by FIGS. 19, 20 and 21.

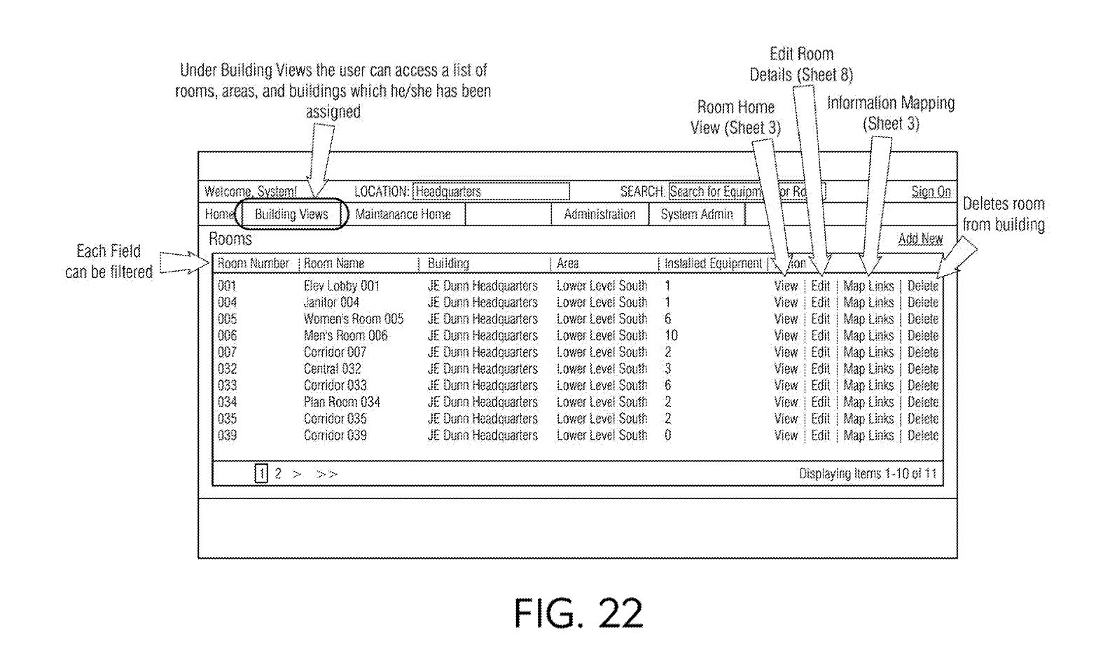

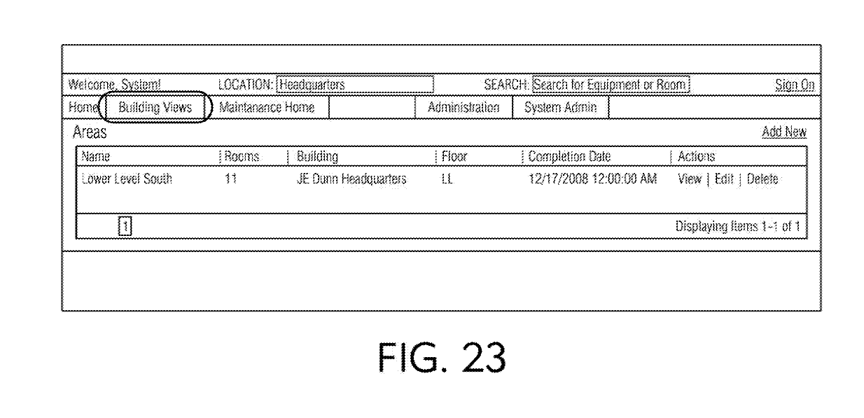

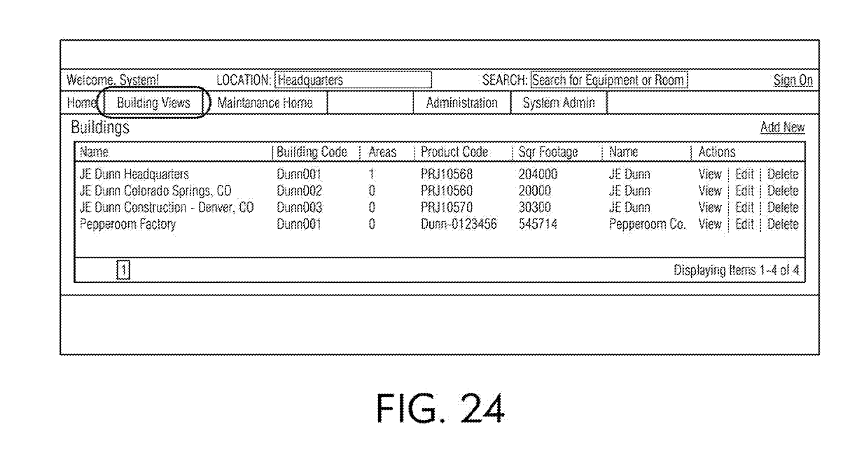

If a user does not navigate directly to a room home view based on entering a room ID or scanning a QR code, the user can access a list of rooms within a building view and select from that list as illustrated in FIG. 22. Alternatively, the user can navigate to a list of areas within a building view as illustrated by FIG. 23. As discussed above the system is account centric and within a given account there maybe multiple building views for which the user can navigate. FIG. 24 is an illustration of an account having multiple building views.

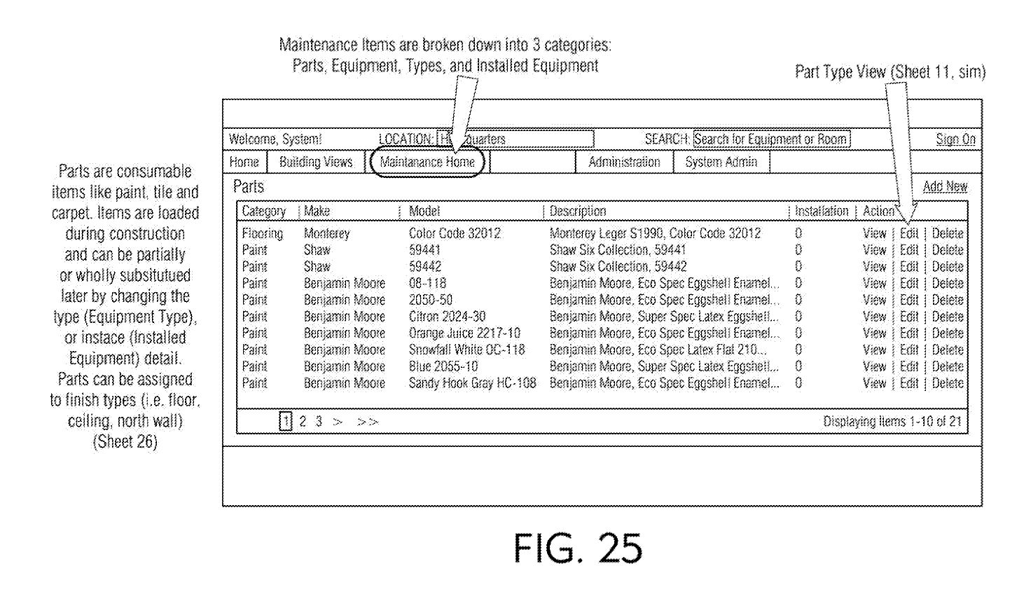

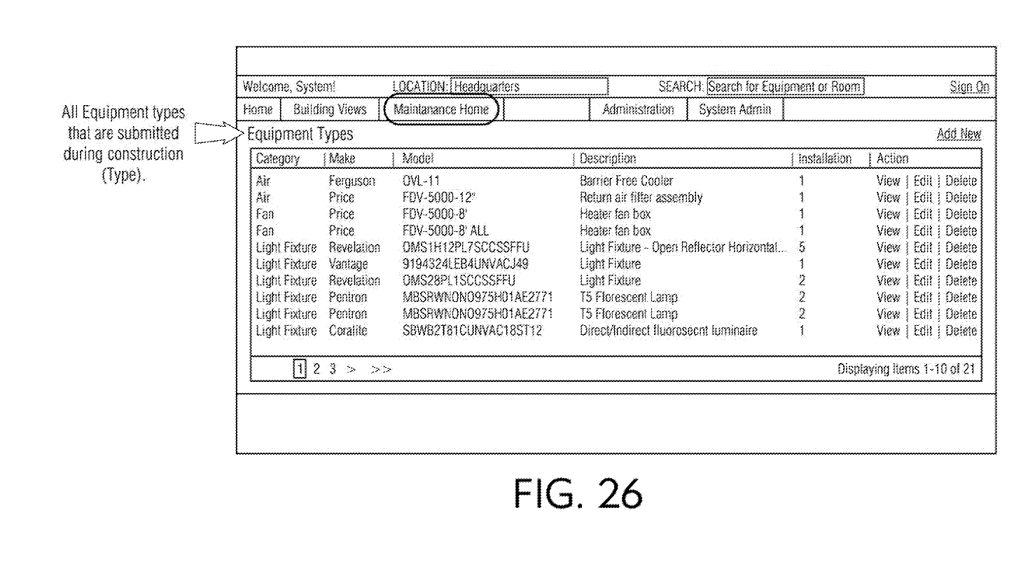

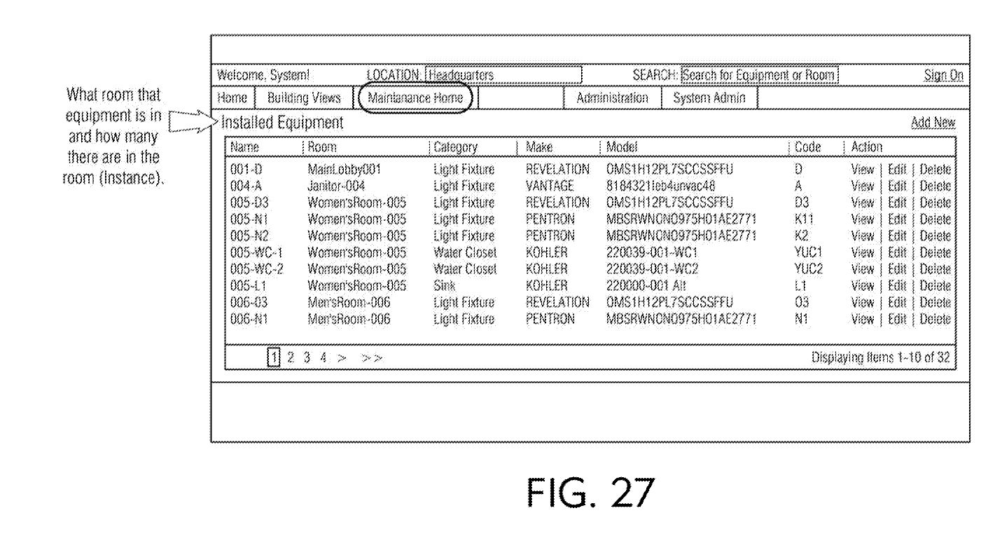

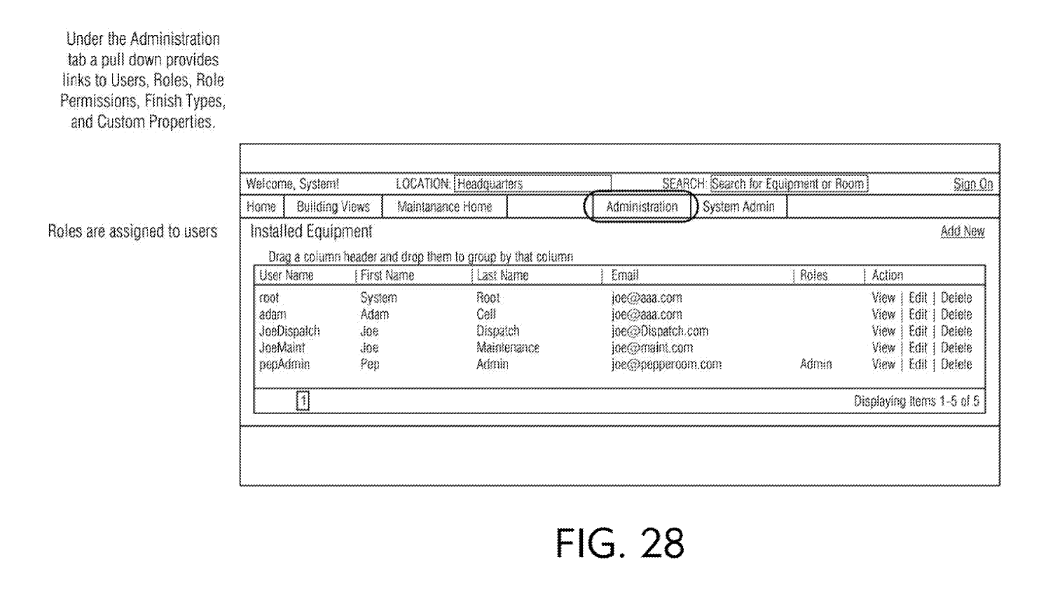

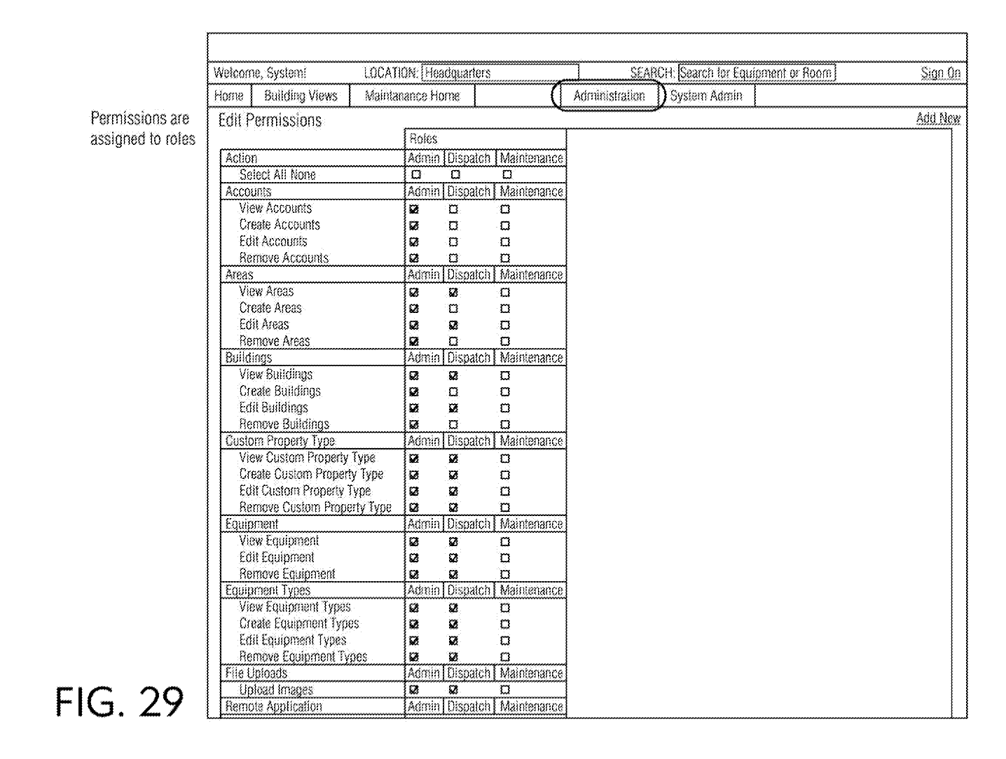

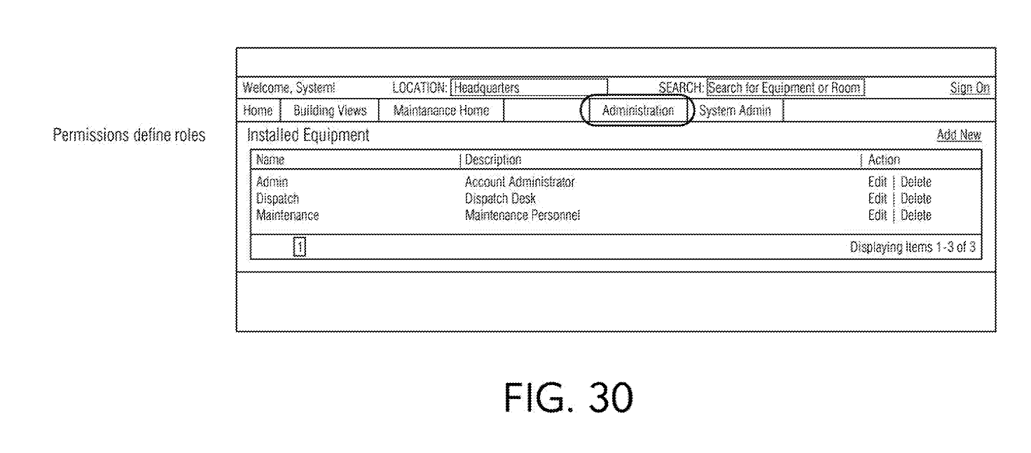

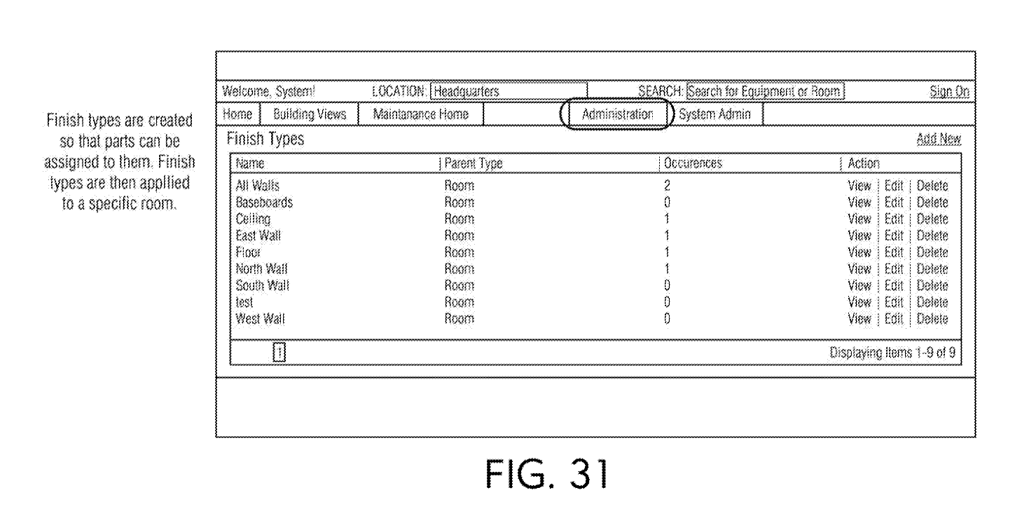

FIG. 25, 26, and FIG. 27 are illustrations of the user's ability to navigate among various maintenance items including a part category, an equipment type category, and an installed equipment category. The part category is illustrated in FIG. 25 which is a list of consumable items like paint, tile and carpet. These items are pre-loaded during the construction phase and can be modified or wholly substituted later by changing the equipment type or installed equipment details. Parts can then be assigned to the finished types such as floor in the case of carpeting, North wall in the case of paint, etc. FIGS. 26 and 27 are an illustration of the equipment type list and installed equipment list respectively. [0120] FIGS. 28 through 33 are an illustration of the user administration function which provides links to the user function, the role function, the role permission function, the finish type function and the custom properties function. Within the role function, roles are assigned to users as illustrated by FIG. 28. FIG. 29 is an illustration of the permissions that are assigned to each role. The level of permissions provided define the role, such as admin dispatch or maintenance, as reflected in FIG. 30. The finish types are created so that parts can be assigned them. The finish types are applied to a specific room as illustrated in FIG. 31.

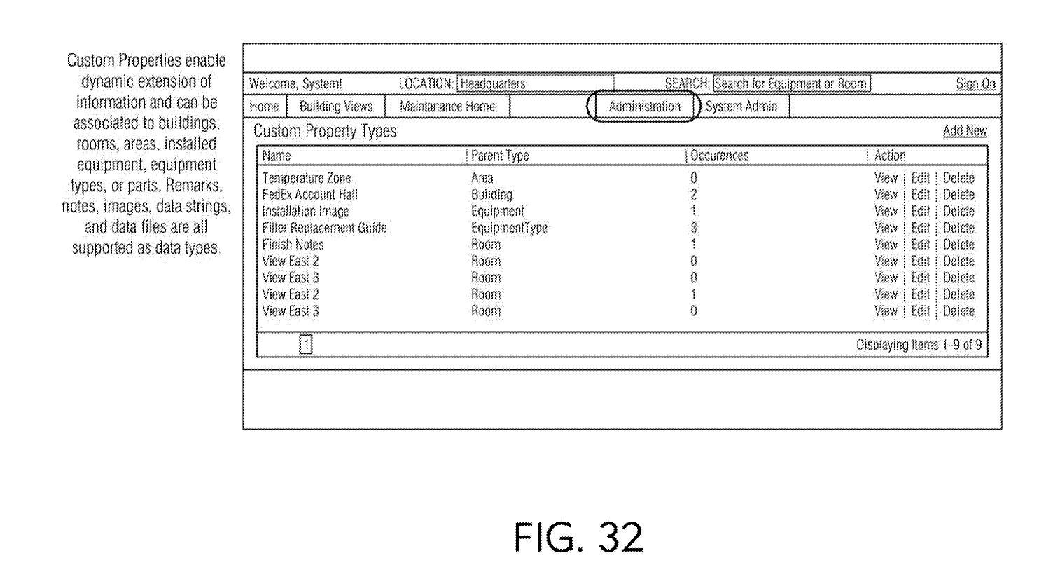

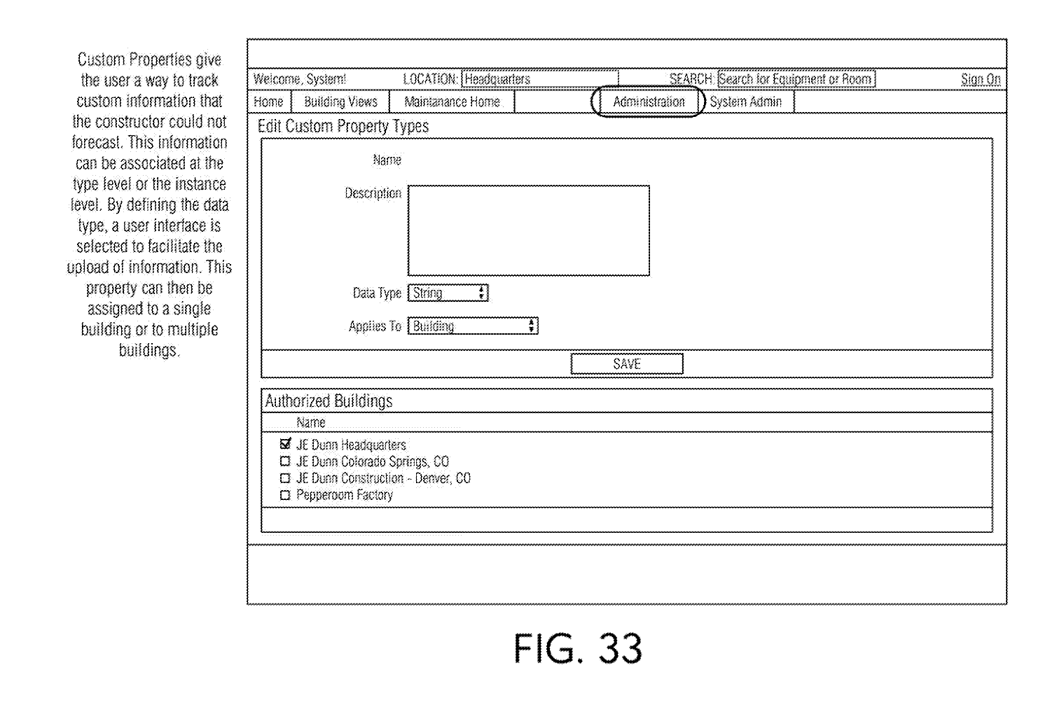

FIGS. 32 and 33 are illustration of the custom property types within the administrative function. Custom properties enable dynamic extension of information that can be associated to buildings, rooms, areas, installed equipment, equipment types, or parts. Remarks, notes, images, data strands, and data files, PDF files, and URLs are all supported as data types. Custom properties give the user a way to track custom information that the constructor could not forecast. This information can be associated at the type level or at the instance level to any object. By defining the data type a user interface is selected to facilitate the upload of information. This custom property type can be available to be assigned to a single building or multiple buildings.

In addition to the ability to add custom properties, the FCS can also provide additional functionality of the system with regards to asset management. The FCS can allow for Company owned equipment, artwork and furnishings to be stored for each room in the system. In the same way equipment is associated with a room, Assets can be linked as well.

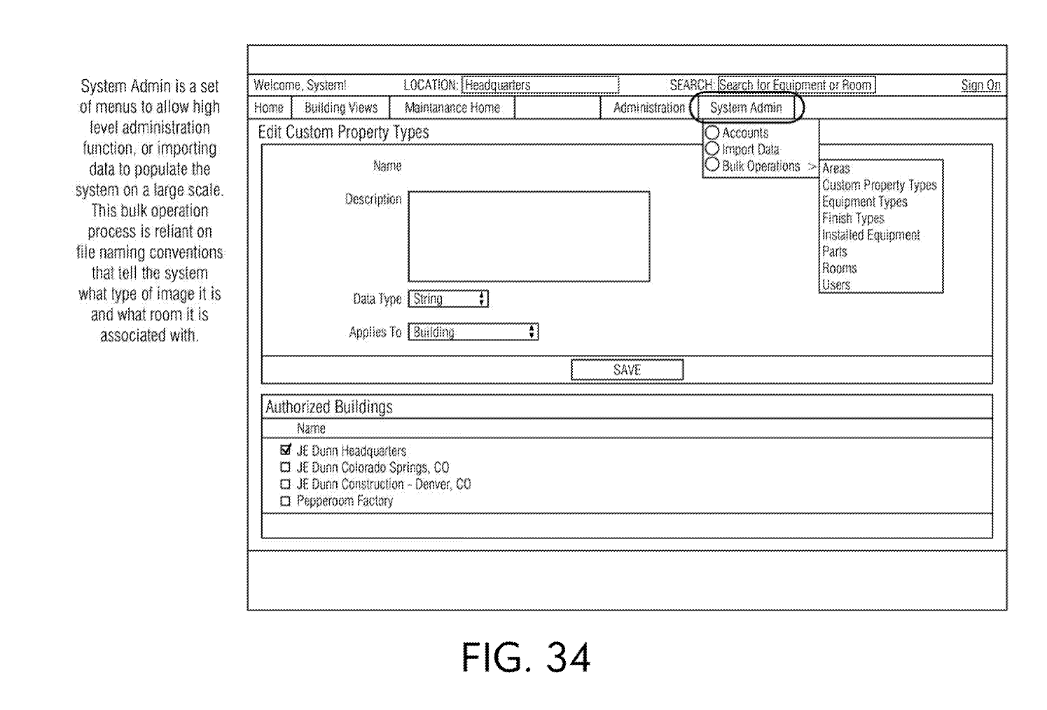

FIG. 34 is an illustration of the system administration function which is a set of menus to allow high level administration or importing of data to populate the system on a large scale. This bulk operation process relies upon file naming conventions that tell the system what type of image it is and what room it is associated with.

FIGS. 35 and 36 are an illustration of audit functions under the system administration function. The room status screen as shown in FIG. 35 allows a system administrator to see an audit trail for what has been loaded and what has yet to be completed. This allows the administrator to confirm that all image data is loaded. FIG. 36 is an illustration of a more detailed audit report of a finished schedule import process generated ahead of each import. This allows the administrator to verify the creation of all necessary rooms and areas before the data is loaded into the system.

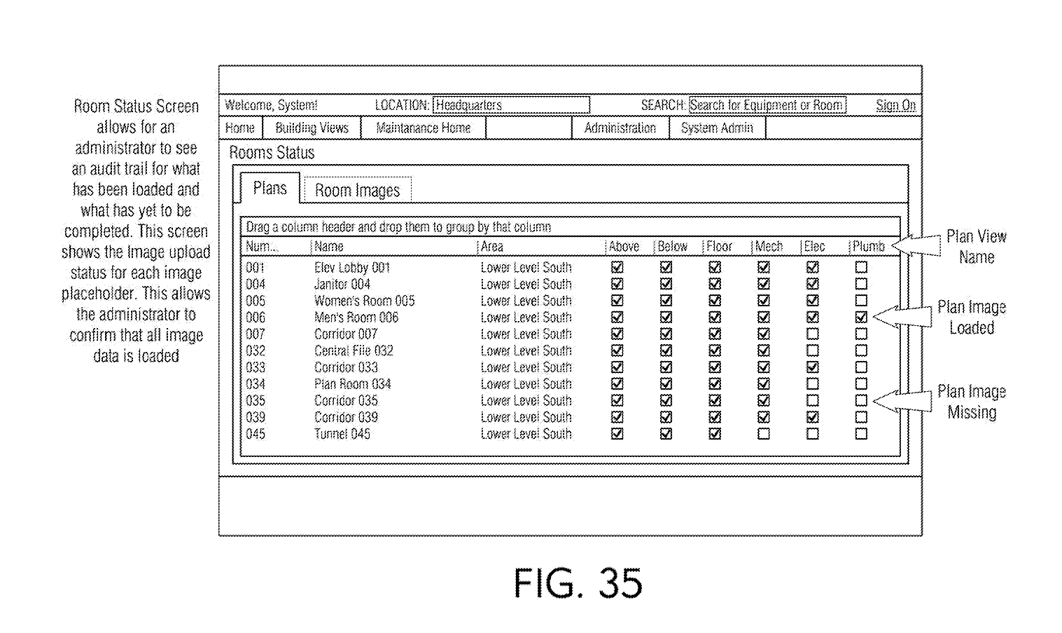

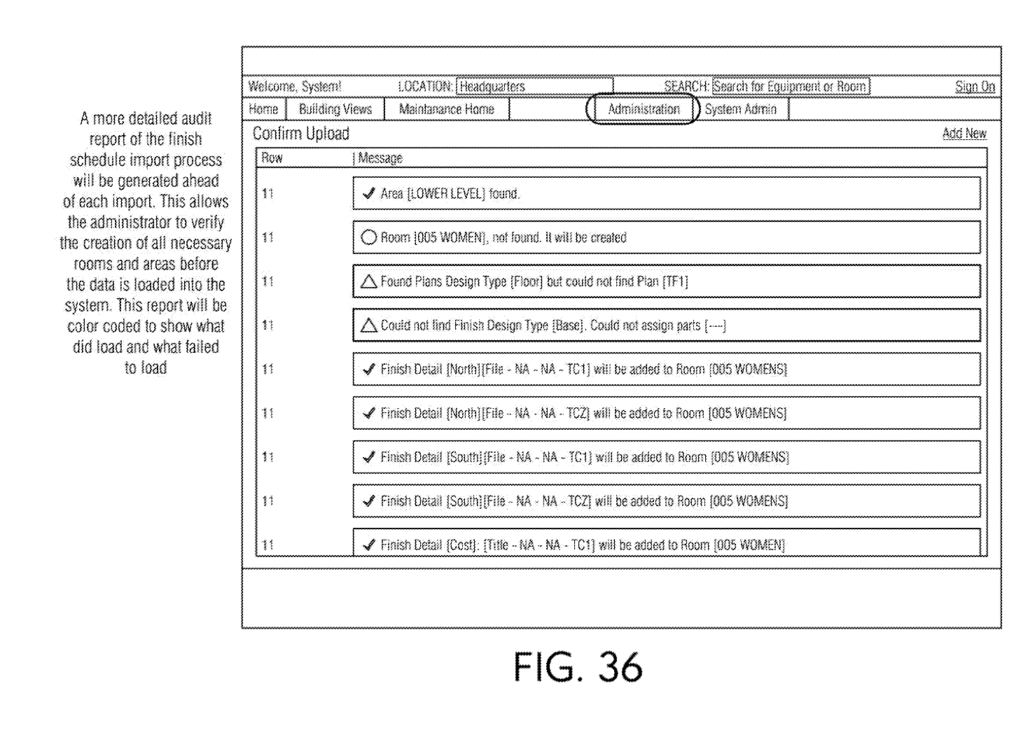

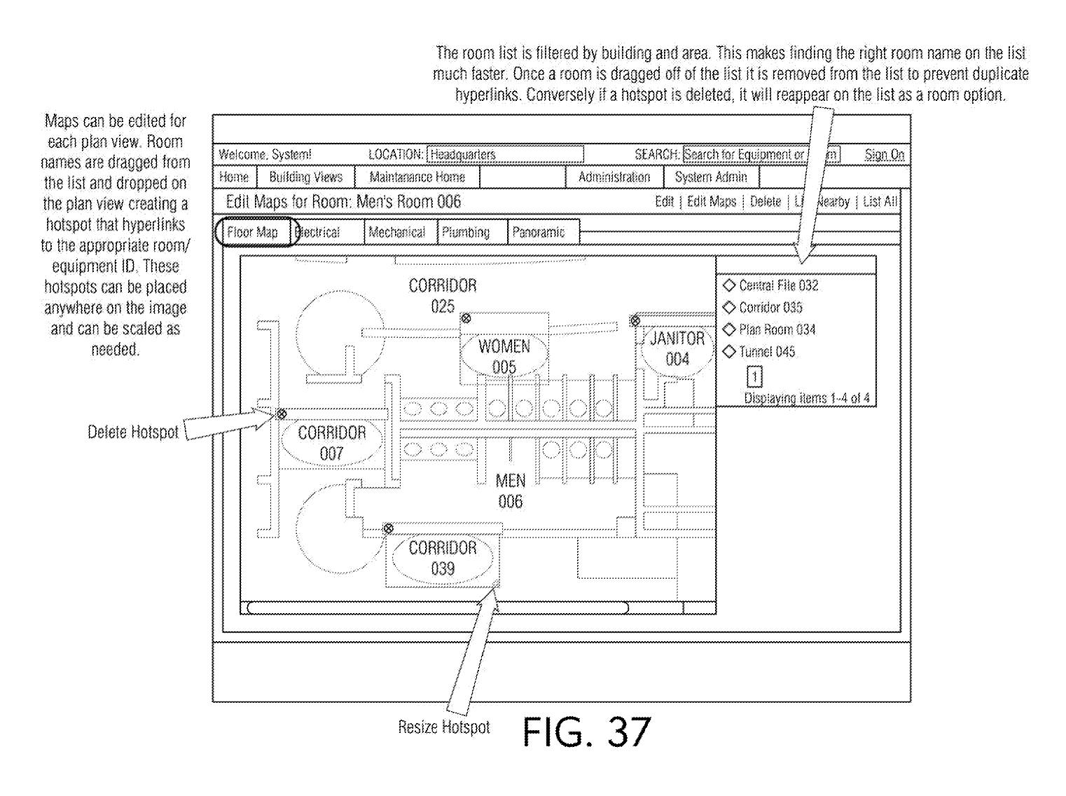

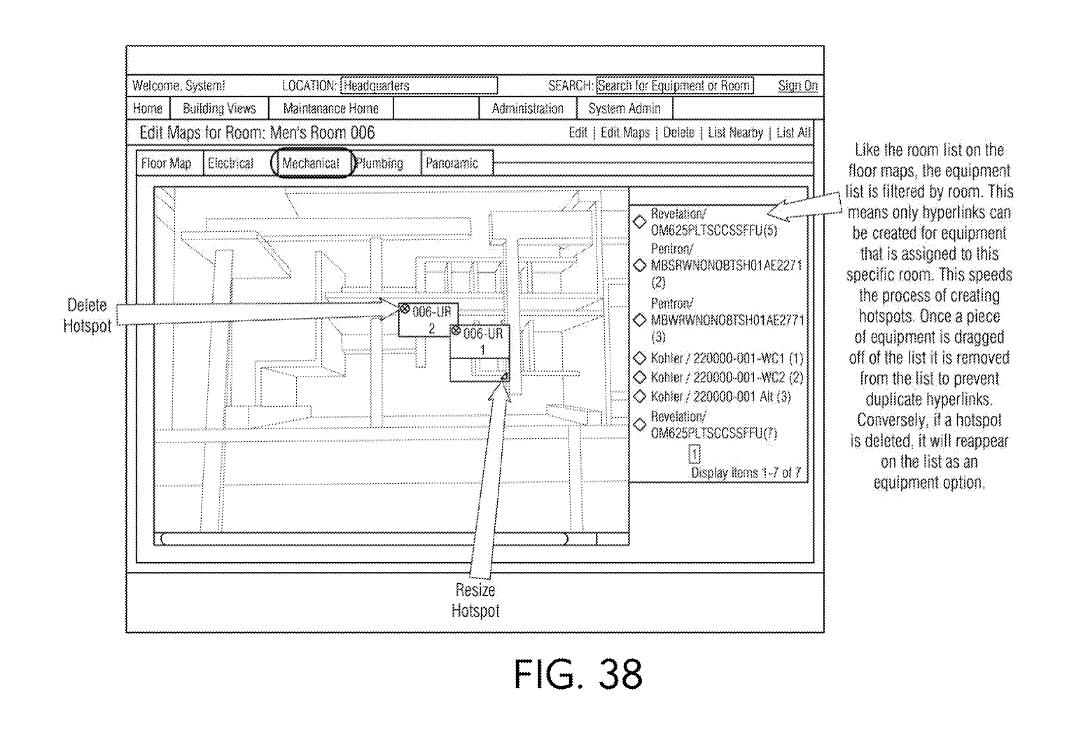

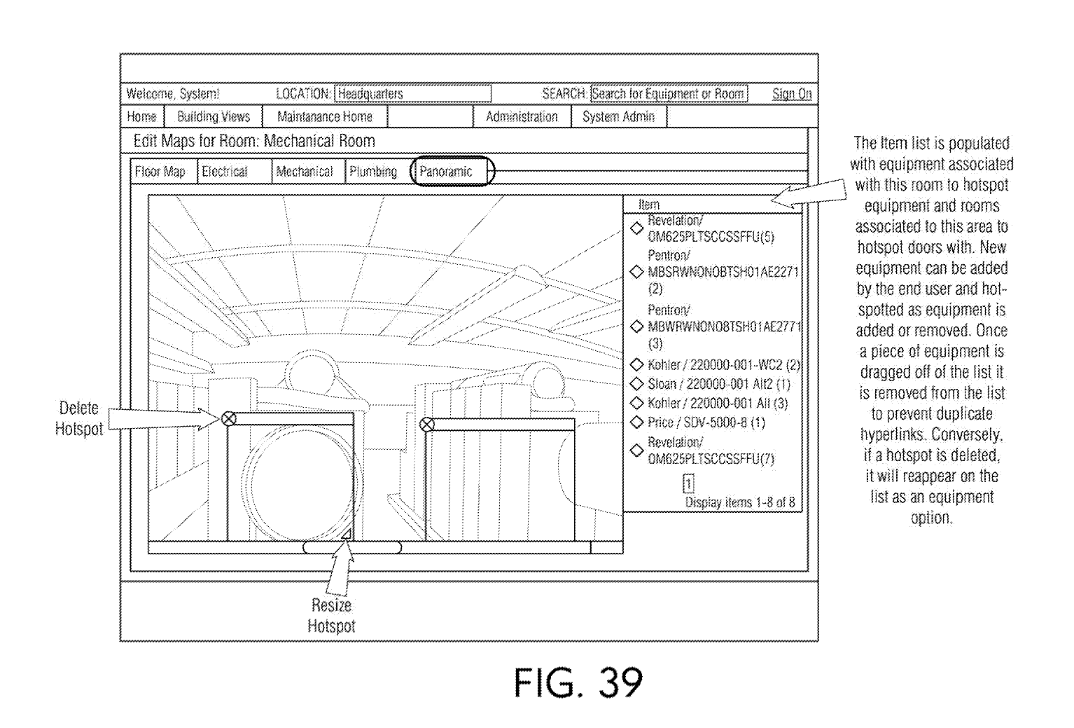

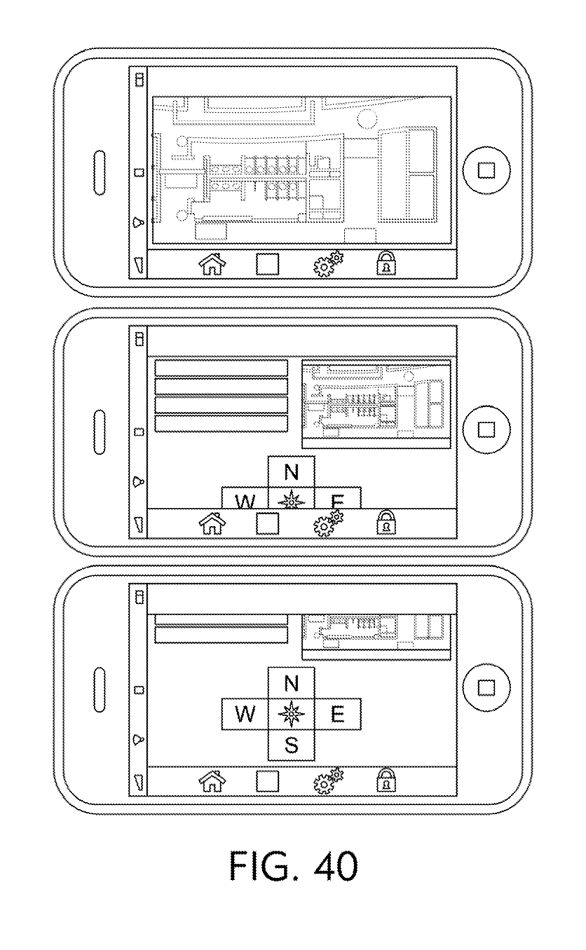

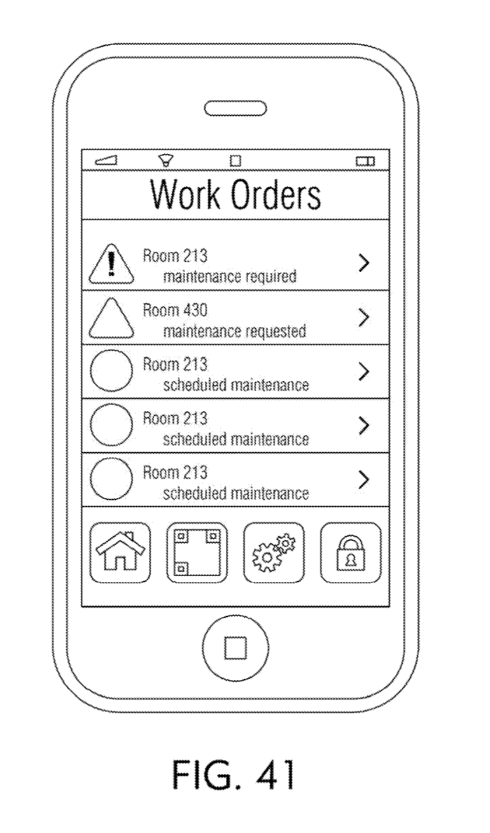

FIGS. 37, 38 and 39 are an illustration of the various edit functions available to the system administrator. In addition to an administrator, such functionality may be provided to anyone given permission to access such functionality. FIGS. 40 and 41 are an illustration of a typical view seen on a mobile device for accessing room views and work orders. These mobile devices can be made available to various maintenance personnel for accessing various room information including equipment information and work order schedules.

One practical application and embodiment of the present invention is an FCS network server communicably coupled to a customer client network comprising a content network server having executable content ERP systems and web services applications residing thereon.

The FCS network server can be communicably coupled with a file server function, a database server function with associated computer readable storage medium and data structure, a legacy project construction management application server function with associated computer readable storage medium, and an administrator computer work station operable to execute the ERP systems and web services applications to thereby pre-populate the database server function content with detailed design and construction data during the construction project. A customer client network web server communicably coupled via a local area network to a customer computer work station having a computer executable browser based user interface application residing thereon and to a mobile computing device having a computer executable mobile browser based user interface application residing thereon, and where said customer client network web server is communicably coupled via a wide area network to said content network server and where said customer computer work station is operable to execute the ERP systems and web services applications to thereby maintain content.

The facility content system network server communicably coupled to a customer client network can further comprise a computer executable web-based portal interface application executable by the administrator computer work station for pre-population of the database server function content. When executed, the web based portal application can be operable for users, including project managers and subcontractors, to access via a single point of entry the ERP systems in order to submit for pre-population the detailed design and construction data in a uniform manner during the construction project, where the detailed design and construction data collected in the portal is selectively pushed or pulled to other systems as required.

The detailed design and construction data submitted during the construction project can include equipment data, and, during data submission, the web-based portal interface application can be operable to generate a reference code for each piece of equipment and associate the reference code to each piece of equipment, where the reference code identifies product information and room location. The web-based portal interface application can be operable to capture original submittals including tabular data and product information sheets.

The web-based portal interface application can be operable to capture original submittals including spec sheets, floor plans, shop drawings, notes, equipment support documents, vendor information, finish types, images and equipment manufacturer information.

One application of the invention can include a method for managing facility content data for building management in a customer client network environment comprising the steps of executing content ERP systems and web services applications residing on a content network server communicably coupled with a file server function, a database server function with associated computer readable storage medium and data structure, a legacy project construction management application server function with associated computer readable storage medium and an administrator computer work station. The method can also include pre-populating the database server function content with detailed design and construction data during the construction project by executing the ERP systems and web services applications.

A user can initiate executing a computer executable browser-based user interface application residing on a customer client network web server communicably coupled to a customer computer work station where said customer client network web server is communicably coupled via a local area network and coupled to a mobile computing device. The customer client network web server can be communicably coupled via a wide area network to said content network server.

The method can further include the steps of executing a computer executable mobile browser-based user interface application residing on said mobile device and executing the ERP systems and web services applications using said customer computer work station to thereby maintain content. Executing the computer executable browser-based user interface application residing on a customer client network web server and executing the computer executable mobile browser-based user interface application can allow a user to display, view and manipulate facility content data.

The various FCS examples shown above illustrate a novel system and method. A user of the present invention may choose any of the above embodiments, or an equivalent thereof, depending upon the desired application. In this regard, it is recognized that various forms of the subject invention could be utilized without departing from the spirit and scope of the present invention.

As illustrated and described, the Facility Content System FCS is a useful system and set of digital and/or online tools for use in managing and maintaining a building. Additionally, the FCS may include additional functionality and/or be a part of, and integrated with, a more comprehensive information monitoring and management system that monitors a number of other or additional sensors, including Building Automation System (BAS) sensors and/or Internet of Things (IoT)-type sensors and that receives additional information from other systems and sources of data.

In particular, as described above, in embodiments, the FCS described above is a component of a cloud-based Internet of Things information monitoring and management system and platform. Such a system and platform enables monitoring of data in at least substantially real-time from a variety of sensors, setting alert and alarm thresholds, generating alerts and alarms, automatically generating work orders based on alerts and alarms, storing, displaying and communicating data trends, provision of digital regulatory management recording-keeping tools, provision of data trend information and recommendations for energy-use optimization and management, cost center management, provision of statistical analysis and tools to aid in capital planning, and other functionality. The ability of the information monitoring and management system to collect data over time from a variety of sensors enables deep data analysis to enable managers of the systems and/or machines and/or equipment being monitored by the system to better understand operations and to make informed decisions that improve efficiency, productivity, capital allocation, planning, and purchasing decisions. Additionally, in embodiments, the data may be provided (for a fee or not) to original equipment manufacturers (OEMs) to enable OEMs to evaluate (and potentially compare with competitive products) how their product is performing under certain conditions.

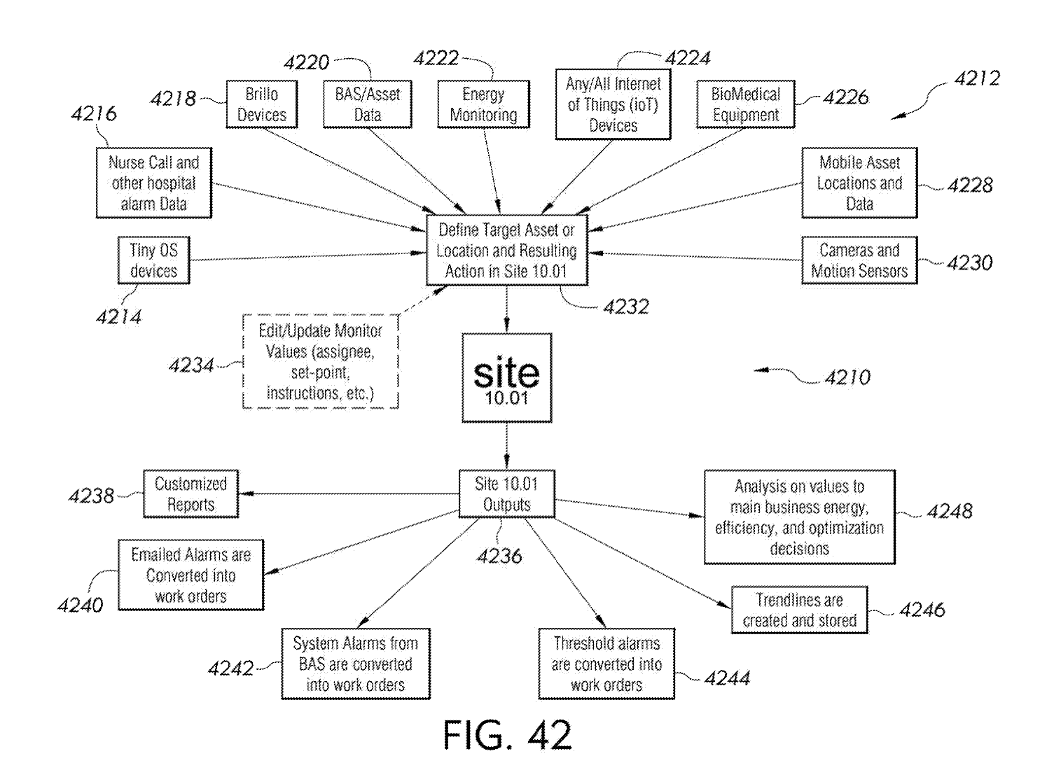

In that regard, with reference to FIG. 42, an information monitoring and management system is denoted generally by the reference numeral 4210. Information monitoring and management system 4210 is a cloud-based digital platform that enables a wide-variety of inputs and outputs for use in monitoring, managing, and maintaining a physical resource or a number of physical resources that employ(s) connected sensors, such as buildings (and related building systems including but limited to electrical systems, HVAC and air handling systems, plumbing systems, etc.), data centers, industrial works (such as sewers, dams, electrical stations and distribution equipment, etc.), laboratory equipment, manufacturing equipment, warehouse supply chain and inventory equipment, vehicles, cargo containers, smart/connected appliances, etc. It should be understood that system 4210, while primarily described as a cloud-based embodiment, may additionally or alternatively be stored, installed, and/or executed on a server or servers that are located at a facility at which the system is deployed.

As used in the following detailed description, the following terms and terminology have the noted meanings; the term “asset” refers to a particular item (i.e., equipment, machinery, fixtures, electronics, etc.). An “asset type” means a type of asset such that all assets so typed have some commonality with other assets similarly typed. In other words, assets may be grouped by asset type. As an example, a particular building may have a number (say, twenty-two) of a particular light fixture. Each of the individual light fixtures is considered an asset and each of those assets may be the same type of light fixture, such that the light fixture is an asset type consisting of the twenty-two assets of that particular type. Accordingly, in a hierarchical sense, asset type is a parent to asset. A “part” is a commodity item that is associated with an asset. In the example given, each light fixture includes a light bulb—the light bulb being a part. A “sensor” senses a state, an output, or a behavior of an asset. In the example of a light fixture, a sensor on the light fixture may sense a change of state from on to off or off to on, how long a light has been on or off, etc. Other examples of sensors include, temperature sensors, position sensors, humidity sensors, proximity sensors, motion sensors, ambient light sensors, particulate sensors, air or material flow rate sensors, etc. It will be appreciated that a host of other sensors may be used with the present invention and that a sensor may sense anything that may be sensed. A “monitor” is the association between a sensor and an asset and/or a location. A “device” is similar to an asset type in that is a parent-level label to sensors (meaning that sensors of a particular type are called devices). In this regard, as will be appreciated by those with skill in the art, a controls contractor can only group a limited number of sensors into a group, so a group of sensors are labeled “device” (e.g., there may be a device for each floor of a building, a device for each system such as an HVAC device, a plumbing device, a lighting device, etc.).

Information monitoring and management system 4210 includes a number of inputs denoted generally by reference numeral 4212. It should be appreciated that the inputs 4212 can be inputs from essentially any type of source that is monitored or produces an output. Examples include Tiny OS devices 4214, nurse call and other hospital alarm data 4216, Brillo devices 4218, BAS/Asset Data 4220, Energy Monitoring Data 4222, data from Internet of Things (IoT) Devices as indicated by reference numeral 4224, data from BioMedical Equipment as indicated by reference numeral 4226, Mobile Asset Location Data and other Data as indicated by reference numeral 4228, and data from cameras and motion sensors (and other security devices) as indicated at reference numeral 4230. Inputs from components 4212 are input into an electronic processor (not shown in FIG. 42) of the information monitoring and management system 4210. These inputs may be stored, analyzed, computationally manipulated according to a set of rules, compared with stored or variable thresholds, etc.

As will be appreciated, sensors and communications functionality may be located on a wide variety of equipment (smoke detectors, carbon monoxide detectors, motion detectors, lights, vents, ducts, elevators, escalators, door handles, switches, locks, window coverings, kitchen appliances, HVAC systems and components, filtration equipment, dispensing equipment such as toilet paper dispensers, paper-towel dispensers, soap dispensers, etc.). For example, dispensing devices may send an alert when they are running low of the commodity that they hold.

Mobile smartphone devices include sensors such as compasses, altimeters, accelerometers, gyroscopes, GPS receivers, motion sensors, and the like. Data from these sensors may be received by system 4210 enabling the system 4210 to identify, based on that information, the position of the device and a corresponding asset in proximity to the mobile device. Room sensors may indicate how many people are in a room and that information, for example, may be combined with temperature and time and can be stored. As discussed in more detail herein, trends can be identified and stored.

More particularly, TinyOS devices 4214 are low-power devices with an embedded TinyOS operating system. Similarly, Brillo devices 4218, which are devices using a reduced version of Google's Android operating system, are particular examples of the more broadly termed Internet of Things devices 4224.

With respect to data from nurse call and other hospital alarm data denoted by reference numeral 4216, existing hospital systems include communications system that enable a patient in a patient room to communicate with an operator or nurse at a nurse's station using a communications device that typically includes communications equipment housed in a housing that may be strapped or hung from the patient's bed frame. Such devices are well-known and have, in addition to other functionality such as volume control, a call button for calling the nurses station, a microphone, and a loudspeaker.

As is known, when a patient presses the call button on the communications device, a notification is indicated at the nurse's station that a call is coming-in from the particular room or bed in a room with which the calling communication device is associated. A staff person (such as an operator or a nurse) can audibly respond to the patient over the communications system and may, for example, verbally respond by saying, “yes, how can I help you?”. As will be appreciated, the request or need from the patient will be particular to the patient's need or desire at that time and can range from minor requests to emergency medical requests. Non-limited examples may include requests such as “I need to use the toilet and I need help”, “I'm hungry”, “it's too hot (or cold) in my room”, “I would like my bed adjusted”, “I would like the lights dimmed”, “I accidently spilled my drink all over the floor”, “I need help with the television”, “I am in a lot of pain”, “I am having difficulty breathing”, “I accidently pulled the IV out of my arm”, etc. Depending on the nature of the need, the staff-person receiving the request identifies the correct person to fill the need and communicates the need to that person (and possibly takes other actions which could lead to still further actions, such as entering or indicating an emergency code, etc.).

Information monitoring and management system 4210 provides a user-interface to the nurses (or nurse operator) station to enable inputs relating to the patient's call and/or the hospitals response to the call to be entered. For example, system 4210 may include an application program interface to enable existing hospital systems to interface with system 4210 such that any request that is related to maintenance is input into system 4210 to enable a work order to be generated and distributed to the appropriate staff. The creation of a work order related to a maintenance issue that is indicated by a patient using a nurse call system enables room history and maintenance to be accurately recorded.

Additionally, as will be appreciated, inputs indicative of an emergency may also be input into the hospital system. For example, a nurse may call-in or enter a “code blue” (a heart related emergency) for a particular room. Some current hospital systems communicate with facility control systems such that entry of certain inputs or codes into the hospital system results in a control of systems or electrical devices relating to the room to which the input/code pertains. To illustrate as an example, in the case of the “code blue” example, the hospital system may communicate instruction messages to a facility control system to take certain actions in reaction to the input code blue. For example, reactions might include turning on all the lights in the patient's room, lowering the air conditioning (in anticipation of many more people entering the room), making sure any locked doors are unlocked and, if doors are automatic, automatically opening the door to the room, opening the blinds in the room, etc.

Information monitoring and management system 4210 is enabled to integrate with and/or interface with such control systems such that all of that data is recorded. As will be appreciated, the information pertaining to all of the actions taken are stored with timestamps in association with information indicative of the room in which the actions take place. Additionally, because system 4210 monitors the data relating to such sensors in at least substantially real-time or periodically on a frequent basis, system 4210 will have also logged the status of all sensors just prior to such action being taken, during the time that care-givers are responding to the incident, and thereafter. As a result, the stored data can be analyzed, compared with medical information related to the incident that caused the code to be entered which in turn cased facility controls to be activated and/or adjusted, and evaluated. For example, information indicating an extreme spike in room temperature just prior to the patient incident might (but may not be) be an indicator that the temperature spike played a part in the incident. To the extent the incident involved issues relating to infection, an analysis of data that is indicative of air control and flow in the room could be useful to determine whether the air was properly turning over in the room at times prior to, during, and following the incident.

Additional representative examples of hospital data and alarm data that may be input into system 4210 includes data from badge readers, security doors, and security cameras, data indicative of air changes, window shades/blinds settings, light settings, room temperature, room humidity, air quality, etc. It will be appreciated that system 4210 may similarly be used in any building environment and, in addition to hospitals, is also particularly useful in laboratories and data centers in which conditions are closely monitored and controlled. Accordingly, system 4210 enables collection of information over time from sensors that can then be used to analyze and determine what system and environmental conditions were present just prior to, during, and after an incident relating to the room or area to which the incident pertains.

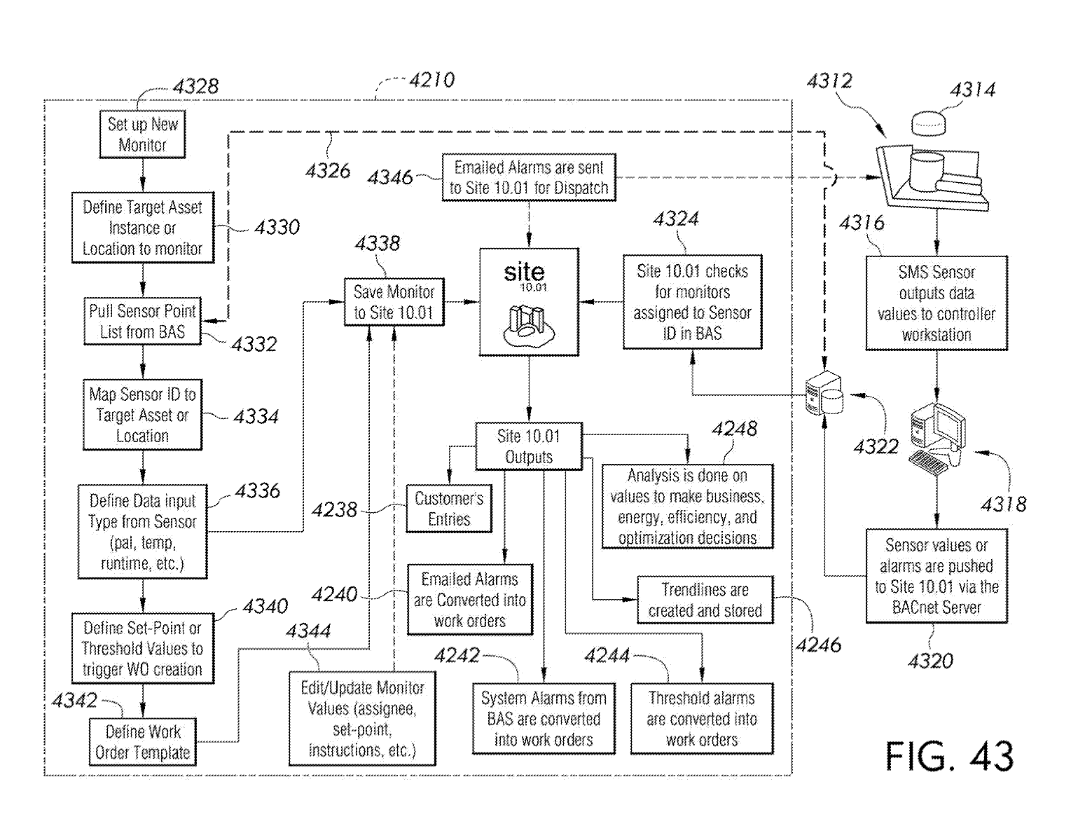

As denoted at block 4220, system 4210 receives data from a Building Automation Systems (BAS) and/or assets (i.e., equipment, fixtures, machines, electronics, etc.) located in the building. Building Automation Systems (BAS) are sophisticated control systems that automate and control various building systems and equipment. As discussed in more detail below with reference to FIG. 43, system 4210 receives data from a BAS implemented in a building and/or data from assets located in the building.

As denoted by reference numeral 4222, system 4210 monitors energy data. In particular, system 4210 monitors energy usage data and enables energy use trend information to be stored and graphically displayed, printed, and communicated. Additionally, system 4210 can interface (such as with an application program interface) to energy handling systems to enable receipt of alerts from such systems as well as to receive data, compare it with thresholds, and generate alerts or alarms. For example, system 4210 could identify that a piece of equipment is short-cycling and generate a corresponding alert (including a message to maintenance stall), or that a piece of equipment is on and should be off or vice versa (and issue a corresponding alert).

As stated and discussed above, and denoted by reference numeral 4224, system 4210 receives information from Internet of Things items.

Regarding data indicative of biomedical equipment as denoted by reference numeral 4226, biomedical equipment used in a medical facility or laboratory is often mobile equipment. Such devices are increasingly including integrated sensors including sensors that enable the equipment to be tracked. For example, such equipment may include radio-frequency-identification-devices (RFID) to enable the equipment to be tracked in a radio-frequency identification system. System 4210 interfaces with such systems and records received data (any quantity sensed; battery level is one example) as well as location data from such devices. The received information may be used in maintaining such equipment.

As illustrated, in addition to biomedical equipment (which is often mobile), system 4210 is enabled to receive sensed data and location data from a wide range of mobile devices as indicated at block 4228. In addition to mobile communications devices (such as smartphones and tablet computers), mobile devices may include refrigerators, food warming carts, and a wide-variety of mobile laboratory equipment that may be regularly moved as new lab experiments are set-up and initiated, etc. It will be appreciated that system 4210 may receive information from any type of mobile device, such as mobile equipment, machines, active tags and labels, vehicles, electronics, and other articles.

Regarding cameras and motion sensors (and other sensors) as depicted at reference numeral 4230, in addition to receiving image data from cameras and/or indications that a motion sensor was activated and/or indications of an event from a glass breakage sensor and/or and receiving date and time information or associating the received information with date and time using a system clock, location data may be received from (or sent from a separate but similarly located device, such as a GPS receiver on a police car) mobile cameras and sensors. Information received may include information indicative of a change of light status in response to detected motion (such as street lights getting brighter when people or vehicle movement detected nearby), the change in status of traffic signals, information from cameras that is indicative of traffic and/or traffic patterns on roadways or at intersections, etc.

Additionally, the information monitoring and management system 4210 obtains data from other external sources. For example, weather data from a third-party weather source may be stored along with sensor data and time to enable evaluation of system performance in various weather conditions. Weather information and weather trend information (over time) may be compared with sensor data as well as stored and displayed in association with sensor data and for visual comparison purposes. Additionally, the information monitoring and management system 4210 may employ or, using application program interfaces, interface with cognitive and other systems that extract information from documents and data files and generate patterns, relationships, or insights based on the extracted information.

As illustrated at box 4232, which includes the stated action “Define Target Asset or Location and Resulting Action”, system 4210 identifies a particular asset with which the data is associated and/or a location with which the data is associated. In particular, information received from a particular asset may include identifying information that indicates the asset from which the information is received. Location information may be received with the data. Alternatively, or additionally, information indicative of the asset may be used to look-up stored location information for that asset or to look-up stored room information which has associated location information. Received location information may be generated from a wide-variety of location determination techniques as described herein and/or as are known in the art. Accordingly, the system 4210 (and, in particular, an electronic processor and associated software used in system 4210) receives information from inputs that are associated with the asset and/or location to which the information pertains. System 4210 stores the received information in association with the asset and/or location to which the received information pertains.

As indicated at box 4234, system 4210 enables the user to edit and update monitor values. In particular, a user that has appropriate editing permissions may edit settings (such as set-points, thresholds, alarms, etc.) on a monitor. The ability of a user to edit information gives the user control of their systems and the information being generated by the systems. This enables users to keep their data up-to-date and responsive to changes in the system or the environment in which the monitors reside.

Additionally, information monitoring and management system 4210 produces outputs, denoted generally by reference numeral 4236 such as customized reports 4238, emailed alarms that may be converted to work orders as denoted by reference numeral 4240, system alarms including system alarms from the BAS that may be converted into work orders as denoted by reference numeral 4242, threshold alarms that may be converted into work orders as denoted at reference numeral 4244, trendlines that are created, stored, and displayed and/or are retrievable for display, printing and sending as denoted by reference numeral 4246, and reports indicative of computational analysis on values stored in or produced by the system 4210 for use in making business, energy, and optimization decisions as denoted generally by reference numeral 4248.

The ability of system 4210 to convert any kind of an alarm into a work order gives the users of system 4210 prompt and timely information of what needs to be done to react to the alarm. Regarding threshold alarms, these alarms may include alarms based on the thresholds that a contractor placed on a sensor, based on and depending upon user-settings based on user preference. Additionally, or alternatively, as described, system 4210 enables the user(s) of system 4210 to establish their own desired thresholds that may differ in level or in timing from contractor-established thresholds such that system 4210 will itself generate alarms when thresholds are crossed.

Additionally, system 4210 analyzes the received information from inputs 4212 and compares with it with historical or threshold value information for the purpose of determining whether a resulting output action should be taken. Additionally, rules-based algorithms corresponding to particular types of data may be stored in memory and applied to the received information to aid in determining if an output is to be made and, if so, the type of output to be generated. For example, alarm data that is received may correspond to a known potential solution (such as “slow down fan speed”). Association of potential solutions with alarms enable work orders to provide the user with proposed solutions to alarms. In addition to algorithmic analysis, the gathered data may be analyzed by individuals (such as contractors, building and systems management professionals, consultants, etc.) and used to make management and optimization-related decisions pertaining to systems upkeep, energy management practices, etc.

With reference now to FIG. 43, FIG. 43 illustrates an embodiment and flow chart in which a Building Automation System (BAS) (see reference numeral 4220 in FIG. 42) is integrated with the information monitoring and management system 4210.

Modern commercial buildings are equipped with control systems and related machinery/equipment. Companies such as Honeywell, Johnson Controls, and Siemens are leading providers and installers of such control systems. These systems monitor information pertaining to systems in the building and, in particular, monitor those items in the building systems that the programmer of the control system indicates should be monitored. As one example, if the controller of the control system is monitoring an air handling unit (AHU), then perhaps those items being sensed include CFM, outdoor air temperature, mixed air temperature, return air temperature, and supply air temperature, etc.—measurements that may be considered for an AHU. For a chiller, the items to be monitored would be completely different, such as condenser temperature and/or condenser pressure, etc. As will be understood by those with skill in the art, the controller is in communication with the sensor and the sensor senses data from the particular machine or piece of equipment to which the sensor pertains.

Additionally, with the aid of the controller, a sensor that is on the machine/equipment may also regulate the machine/equipment. For example, a building may have two chillers that are programmed to switch between the chillers every week. In such a scenario, the sensors that are on the chillers will, based upon instructions from the controller, perform that scheduled operation programmatically by shutting off one chiller and starting the other chiller according to the preset program. Additionally, it will be understood and appreciated by those with skill in the arts of building control systems that the automation controls for a building are based on the needs and intended uses of the building. For example, while an office complex involves one type of building use having certain air handling and turnover needs, a laboratory in which careful experimentation or handling of infectious properties occurs has a very different type of use and environmental/air handling needs (compared to an office building), and therefore building automation systems are programmed for control depending on the needs of the physical space to which the building automation system is applied.

As will be understood, the information monitoring and management system 4210 of the present invention is enabled to receive data from such building automation systems (BAS) and use that data in a wide variety of ways as described herein. In addition to monitoring data from such a BAS control system, as will be appreciated from the foregoing, information monitoring and management system 4210 of the present invention is a cloud-based platform that may be used to monitor a wide variety of other variable data from buildings and other assets, including information from Information Technology systems, and may receive a wide variety of information from a wide range of sources, such as financial data, inventory information, temperature data, market data, asset location information, etc.

Reference numeral 4312 denotes a machine or equipment in a building automation system (BAS). As denoted at step 4316, a sensor 4314 on the machine or equipment 4312 outputs data values to a controller work-station 4318. The BAS may be set-up to transmit data from sensors according to a desired frequency, such as each one (1) minute, every five (5) minutes, every ten (10) minutes, every fifteen (15) minutes, etc. The controller workstation 4318, as illustrated, is locally installed in the building being automated by the BAS. However, it will be understood and appreciated that the data values from the sensor may be output to a cloud storage account associated with the BAS (and a local controller workstation may not be included in the BAS). Additionally, or alternatively, it will be appreciated that data may be transmitted to the cloud for storage and then from the cloud to the local controller workstation 4318, or from the controller workstation 4318 to the cloud, or from the sensor 4314 directly to both the cloud and the controller workstation 4318, according to user needs and/or preferences.

The sensor data values, or alarms that are identified by the controller of the BAS, are pushed to information monitoring and management system 4210, as denoted at step 4320. In one embodiment, communications from the BAS to the system 4210 are via the BACnet protocol, which may employ a locally designated server 4322 (or may use cloud communications not shown). As indicated at block 4324, the information monitoring and management system 4210 checks for monitors that are assigned to the identification of the sensor in the BAS. In that regard, as depicted by the dotted line 4326, server 4322 communicates with system 4210 to associate the sensor ID in BAS with an asset as identified in system 4210. In that regard, an asset may have numerous sensor points (i.e., assets and sensors are not necessarily and are likely not a 1:1 ratio) so the sensor ID from BAS is associated with an asset or location in system 4210.

As one example, consider a building that has 100 rooms. That building may have, for example, three hundred (300) sensors monitoring eight hundred (800) data points. For example, a sensor such as a thermostat might sense temperature (first data point) and humidity (second data point) as well as having a set-point corresponding to the goal temperature for the room (e.g., 72 degrees Fahrenheit) (third data point) in which the thermostat resides. The thermostat may also have upper and lower temperature thresholds (e.g., 66 degrees and 78 degrees Fahrenheit, respectively) (fourth and fifth data points), each of which are used to trigger corresponding alarms (sixth and seventh data points). The BAS has a table that includes these data points and all other data points in the BAS system. To enable connection of a selected asset or room location to a sensor, the information monitoring and management system 4210 pulls all of the data point names (e.g., Room Temp 205, Room Humidity 205, etc.) The pulled information would likely also include a label or indicator, such as a unit of measurement (e.g., degrees Fahrenheit, CFM, PSI, etc.) depending on the data being sensed.

Turning to the left side of FIG. 43, a process for setting-up new monitors in the information monitoring and management system 4210 is illustrated and described. This process is used both in conjunction with setting-up system 4210 for integration with a BAS as well as for other setting-up other monitors related to any other inputs, such as the inputs identified above in FIG. 42.

At step 4328, the user selects a tab or menu-item, served by system 4210 for display on the display screen of the user's computing device, corresponding to setting up a new monitor. As described above, a monitor is defined as the combination of a sensor and an asset and/or location. When creating the new monitor, as indicated at step 4330, the user selects an asset or a room location that the user wishes to monitor. At step 4332, the user selects the sensor that the user wishes to apply to the asset or room selected at step 4330. Additionally, system 4210 enables the user to select multiple sensors to be associated with a single asset or room. At step 4334, system 4210 maps the selected sensor or sensors to the selected asset or room location. At step 4336, the user defines the data input type from the selected sensor (i.e., psi, temperature, runtime, etc.)

As indicated at step 4338, following step 4336, the user may save the new monitor to the information monitoring and management system 4210. Additionally, or alternatively, the user may optionally select, at step 4340, to additionally define set-point threshold values to trigger work order creation. In that regard, step 4340 gives the user the opportunity to set thresholds for triggering the creation of a work order, where that user-defined threshold may differ from thresholds and alarm settings set by a programmer of the BAS. Additionally, in addition to setting-up customized thresholds and alerts that can automatically trigger work orders, system 4210 enables the user to select whether he or she wishes to capture all of the alerts and alarms generated by the BAS. In particular, the alarm from the sensor is its own data point and that data point can be added to the monitor. As will be appreciated, a BAS alarm data point is a true/false indication (i.e., is an alarm/is not an alarm), so the user could choose to select the alarm data point (but not select, for example, the threshold data points that are used by the BAS for generating the BAS alarm data), and have alarms from the BAS electronically communicated to system 4210 for dispatch, as indicated by reference numeral 4346. Accordingly, system 4210 provides the user with a flexible system that enables the user to make changes to thresholds, alarm settings, etc. without requiring adjustment to BAS alarm/threshold settings.

As illustrated at step 4342, when the user has elected to define set-point or threshold values at step 4340, the user defines work order templates for use with work order creations. At step 4338, the new monitor is saved.

As illustrated at step 4344, the saved monitor values may be edited and updated by the user as previously described.

During operation of system 4210, the data from the various sensors associated with the saved monitors is stored. Any resulting actions based on that data and corresponding to settings of the corresponding monitor, such as the outputs 4236 (previously described), are processed. Advantageously, system 4210 stores all of the incoming data in a system that enables automatic generation of work orders based on operational events of the BAS; the operational history, alarm history, and preventative maintenance actions and history are all stored in a common system. Additionally, the system 4210 enables pre-assignment of work such that, when a particular unit goes into alarm, system 4210 automatically assigns the created work order to an individual associated with, and pre-assigned to, that type of issue, thereby potentially eliminating layers of communication and delays in addressing the problem identified by system 4210.

Accordingly, as described, a Building Automation System (BAS) and, in particular, a control system for controlling systems, machines, and equipment in a building communicates with the information monitoring and management system 4210 using one or more communications networks and communications protocols such as BACNet. This communication allows for performance-based maintenance by allowing the information monitoring and management system to dispatch work orders based on an asset's performance rather than simple periodicity as is often done currently in the workplace. As described, alarms and alerts captured within the BAS may be communicated to the information monitoring and management system, based on user-defined preferences, allowing for the dispatching of technicians. Additionally, or alternatively, as described, the information monitoring and management system 4210 enables the user(s) to establish and edit thresholds, set-points, and alarm and alerts independently of the BAS, thereby giving the user(s) greater control over their systems and data and the ability to flexibly change parameters and/or system settings based on changes and updated needs or requirements. Sensor trend data captured by the information monitoring and management system 4210 can be used to aid in troubleshooting and system monitoring. By using API communications, data for individual assets is captured and used to drive workflows. These workflows are documented and stored to provide users the ability to track asset work history as well as providing supplemental documentation for regulatory agencies in the event of an inspection.

Accordingly, the information monitoring and management system 4210 provides a data platform and communications interface between building systems and maintenance operations and helps bring important data, such as security, fire, leak detection, overheating, and other building management systems information, from data silos in many conventional building management and automation systems that require building operators to access multiple different systems to get a holistic picture. The information monitoring and management system 4210 collects data from individual assets as well as from other assets within that asset's group which affect an individual asset's performance.

Additionally, the information monitoring and management system is useful for automatically performing trouble-shooting duties. In that regard, when a problem is indicated at an asset or location, the system can generate automatic queries (or enable user-entered queries) to determine the performance of assets that are related to the noted problem. For example, if sensor data from a temperature sensor in a thermostat in a room indicates a problem, data from other sensors in the thermostat can be queried, data from other sensors in the related room may be queried, data from other sensors related to assets or locations in a defined area relating to the room may be queried, all sensors of that type (i.e., “devices”) may be queried, etc., and this information may be used to evaluate the scope and/or nature of the reported problem. Additionally, as described, the information monitoring and management system 4210 captures data from all of the sensor points and aggregates them into a single dispatch and ticketing system. In this way, the monitoring and management information system 4210 enables a better understanding of the interrelationship between assets and provides the ability to solve problems in a more informed and holistic manner. This is achieved by collecting data from several systems, applying rules that enable determining what actions are needed, and automatically generating work orders or enabling user-created work orders, and sending digital communications for the purpose of accordingly dispatching a maintenance professional/technician.

Additionally, the collected data may be analyzed and processed to develop reports and analytical information to enable better management decisions, such as building maintenance and energy management systems, for the purpose of optimizing usage of systems, equipment, and/or machinery, as well as for financial planning and expenditure decisions. As an example, data from a sensor on a pump can be compared with known performance data (include results and outcomes based on that known performance data) and an analytical report can be generated based on that comparison, such as “based on the rate at which the pump is running it is anticipated that the operational life of the pump will be reduced by one year from its normal use-expectancy of seven years”. As discussed further herein, trend data regarding historical information for the pump can be stored and trend lines, graphs, bars, etc. showing that historical information may be displayed, printed, and/or electronically communicated.

The ability and functionality of system 4210 to monitor data from many sensors, develop and store trend information related to the monitored data, and the ability to compare that data, which is indicative of actual operation of an asset, with known information enables the system 4210 process and generate both event-based alerts or alarms as well as predictive alarms. For example, a system 4210 would have information indicating that a light bulb has likely burned out enabling a maintenance ticket to be generated and the issue potentially addressed before a tenant calls the maintenance department about the issue. As will be apparent from the description herein, system 4210 enables a wide variety of information to be collected, analyzed and reported (e.g., did a sensor indicate an issue that was ignored? how can this help assess priority? What impact did a missed work order have on an energy bill, etc.).

Additionally, the information monitoring and management system 4210 includes features to enable a user to define areas, which are particularly useful for tracking information, costing maintenance and inventory use to a cost center, and for regulatory compliance purposes.

In particular, the information monitoring and management system 4210 enables the user to define particular areas. For example, an area of a building may be identified by a text label and a number of rooms in the building may be selected for inclusion in that area. More particularly, a user interface of the information monitoring and management system 4210 may enable a user to select a room by selecting a graphical representation of the room on a digital map displayed on a display screen and then associating the selected room with a labeled area. Alternatively, or additionally, a room may be selected from a list or a menu of rooms in a building and then associated with a defined area by linking information indicative of the room with the labeled area. An area may include rooms on the same floor of a building and/or may include rooms on different floors of a building. Indeed, an area could include rooms in different buildings on a campus of buildings. Grouping rooms by area is useful to building maintenance managers to track and maintain buildings by area. According to a hierarchical data structure of the information monitoring and management system 4210, rooms are associated with areas (areas can be assigned a building floor value). Areas are associated with buildings and buildings are associated with user-accounts.

As noted, areas may cross floors of a building. This enables using defined areas in a building to capture tenants or cost centers. For example, in a ten-story building, a tenant may occupy the east half of the ninth and tenth floors of the building. The east half of the ninth and tenth floors may be defined (including a name (i.e., Area 89E), descriptive text (i.e., 8th and 9th floor East), and have other associated information stored in association with the area (i.e., Tenant: XYZ Company). All of the rooms of the building on the east half of the 8th and 9th floors can be associated with the defined area. This enables the cost of maintenance to be tracked (and, if desired, billed) by area. As an example, each apartment unit in an apartment complex may be a defined area. As another example, the spaced leased by each lessee in a commercial building may be a defined area.

Additionally, defined areas may include identifying information indicative of functions that are performed in an area, regarding employees that work in an area, or indicative of the types of employees that work in an area. For example, in a hospital, rooms associated with the emergency room may be an area, rooms associated with cardiology may be a different area, rooms associated with labor and delivery may be yet an additional area, etc. These areas may be considered and even identified as cost centers such that maintenance work and/or parts used for maintenance is/are charged to a particular cost center based on the defined area for which the maintenance was performed, or the parts were used. Additionally, particular information can be stored in association with an area. For example, an Information Technology (IT) map of components, cables, etc., used for a tenant in a particular area may be stored in association with just the area associated with tenant. As an additional example, an emergency evacuation plan and map may be associated with a particular area to which the plan/map pertains.

Additionally, the information monitoring and management system 4210 calculates the square footage for each room based on a value input at the room level and sums the square footage for the rooms associated with an area. The square footage is calculated by room, by area, and by building such that, as the user moves up the hierarchy, the sum of the square footage for the level being viewed (i.e., room, area, building) is displayed or displayable by selection.

In embodiments of system 4210, the information monitoring and management system 4210 employs Single User Sign-on (SSO). Each user is assigned or creates his or her login credentials. Accordingly, the actions of each use in the information monitoring and management system 4210 are tracked and recorded on a per-user basis. Reports of a user's activity and work may be tracked by user, such that a user's actions are reported to one or more other users or managers. This enables productivity tracking as well as the ability to verify when and by whom certain task items were performed. In embodiments of system 4210, customers who use the information monitoring and management system 4210 are charged on a basis other than the number of users, such as on a square-footage basis, number of assets basis, etc. As such, there is less temptation for a user to share his or her login credentials, thereby adding a greater degree of certainty in the recorded data pertaining to who performed a task item, a matter which is important in regulatory compliance.

As described, system 4210 may receive information from sensors on mobile communications devices, such as smart phones and other connected equipment, such as survey equipment as one example. In accordance with aspects of the invention(s), system 4210 interfaces with mapping and/or other GIS systems and senses/receives, and employs techniques for using, position information of mobile devices. For example, the location of a mobile device may be determined in a wide variety of known ways using one or a combination of the Global Positioning System (GPS), radio-frequency identification devices (RFID), Tri-angulation/Trilateration using known reference data, points, or network nodes, and other georeferencing and geolocation techniques. Additionally, data from embedded sensors such as a compass, accelerometer, motion sensor, gyroscope, etc. may be used to indicate the direction a maintenance professional is moving or facing.

Using the known position and other location-related information from a mobile device, such as a maintenance professional's tablet computer or smartphone, information relating to the room or area in which the professional is working can be automatically sent to the professional's mobile device based on location. For example, system 4210 determines that, if the professional is likely in Room 104 in proximity to and/or facing the chiller, information indicative of the chiller that is stored in system 4210 may be transmitted to the professional's mobile device without the necessity of any or many inputs from the professional. Accordingly, this location/position/direction information can be used to automatically hyperlink room navigation or asset navigation hotspots.

Sensed location/position/direction information can also be used to track mobile assets inside and outside buildings (e.g., mobile biomedical equipment, trucks in a fleet, etc.) and track assets over large spaces (such as a municipal water system). Additionally, as will be appreciated in view of this description, the information monitoring and management system 4210 may be used for buildings and facilities of a wide variety of types and use-purposes, but may also be used in a variety of other environments such as industrial workings (such as, but not limited to, sewers; determining with sensors locations at which water is rushing at greater than a threshold rate indicating a leak or locations at which material in a sewer (or other material handling system) is not flowing at a defined rate indicating a clog) and with mobile assets of a variety of types (such as, but not limited to, moveable equipment in a laboratory or factory or moveable equipment such as trucks in a fleet, cargo containers, construction equipment, etc.).

In accordance with particular embodiments of the invention, mobile hospital equipment is tracked and information indicative of the location of the hospital equipment is received and stored by information monitoring and management system 4210. The location of such mobile hospital equipment (i.e., mobile X-Ray machines, diagnostic equipment, pharmaceutical administration equipment, anesthesiology equipment, beds, carts, etc.) may be tracked using bar code systems, which include passive tags on equipment, or with other location-based systems as are known and/or as are described herein (i.e., active or passive RFID tags, triangulation using known reference data, etc.) and that have communications components for transmitting their position periodically, upon query, and/or in at least substantially real time.

Additionally, in some operational environments such as hospitals, there are sensors in the room (such as above the ceiling) that are statically located that read information from equipment that enters within a range of the sensor. For example, in the hospital environment, a sensor above the ceiling may sense a tag or device on a piece of hospital equipment that enters the room (such as an X-Ray machine) to identify and communicate to a system for bringing up a display at an operator station an indication of the location of particular X-Ray machine (e.g., X-Ray Machine No. 2 is in Room 429). As will be appreciated, numerous other room sensors operate in the same environment (temperature sensors, etc.).

Such sensors are important components to the operation of the building and the work and/or care carried out in the building (consider again the hospital environment). As will be appreciated, such sensors also require maintenance and upkeep. Accordingly, these sensors and related components are also monitored (e.g., battery is low, etc.) by system 4210 so that the sensors may be preventatively maintained and/or replaced before problems occur. In particular, system 4210 considers these sensors as objects and data received from such sensors are stored in a separate layer of data that includes information from, and indicative of, these sensors (i.e., active RFID tags, wi-fi bridges, GPS receivers, communications components, etc.). Such sensors are or may be, using the features of system 4210 described herein, associated with assets and/or locations.

As will be understood from the foregoing description, monitoring and management system 4210 enables custom properties to be assigned at multiple data levels. A custom property is a data attribute that may have a custom value as well as a custom field name. Custom properties can be a value that is assigned, for example, to buildings, areas, rooms, asset types, assets, parts, sensors and work orders. The functionality of the attribute is related to where it is assigned within the system. Custom properties can be of the data object types-string, number, date, True/False value, image, PDF, part, panorama, file or a URL. Additionally, or alternatively, a custom property may be a list. The user may define and create lists of items that are then selectable by the user to associate with any object (such as buildings, areas, assets, asset types, asset groups, rooms, parts, work orders, PM schedules, etc.). The ability to define lists is useful for preventing or limiting occurrences of different users entering different text for the same item. In particular, enabling the user to define and create lists and associate a list with any object allows the user to place tags or identifiers on objects that makes those objects easier to find in system 4210 in the future. For example, a maintenance technician may want to identify something with the term “spec.”. Different users may enter “SPEC” or “spec” or “Spec.”, etc. The ability to define a list with, for example, “spec.” simplifies as well as unifies user entry. As another example, a particular system may, in practice, be referred to by many different names, such as HVAC, HVAC System, Air Handling System, Cooling, Heating, Cooling system, Heating system, etc. By using the Custom Property of type List feature, the user creates a list with a desired naming convention and then all users thereafter have those choices to pick from so that particular assets are able to be easily found in the system 4210. Such an approach also aids in eliminating spelling and/or typographical errors (e.g., entering “H AVC” instead of “HVAC”, which would result in difficulty locating the item tagged HAVC when looking for HVAC). Accordingly, by creating a List, the naming convention is the same across all objects that utilize that List.

As a specific example of this feature in use, the information monitoring and management system 4210 may be used to assign a custom property of “cost center” to an area. A custom property named “cost center” may be entered and then selectable from a list of custom properties. The user may navigate to an area (for example, the cardiology area of a hospital) and add the custom property called “cost center” to the area by selecting, for example, an add custom property function from a menu and then selecting “cost center” from a list of displayed custom properties. Once added, the information monitoring and management system 4210 makes available a drop-down list of cost centers that have been added and the list will now include the added cardiology area. Accordingly, when as user of system 4210 wants to assign a custom property of cost center to an area (e.g., an area labeled cardiology), the user selects the custom property “cost center” from the list. Then, after the user adds the cost center to the area, system 4210 includes the area (e.g., cardiology) in a drop-down list that has all of the included cost centers the building (e.g., cardiology, labor and delivery, admissions, emergency room, etc.). The user then selects cardiology from the list to so that the cost center custom property, with the value of cardiology, is assigned to the cardiology area.

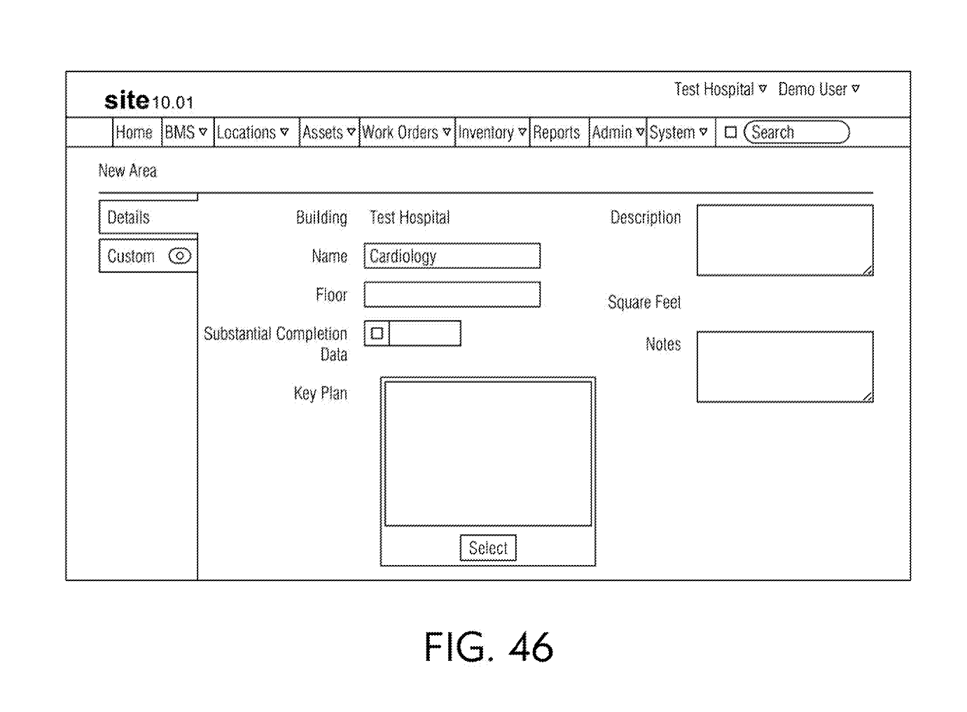

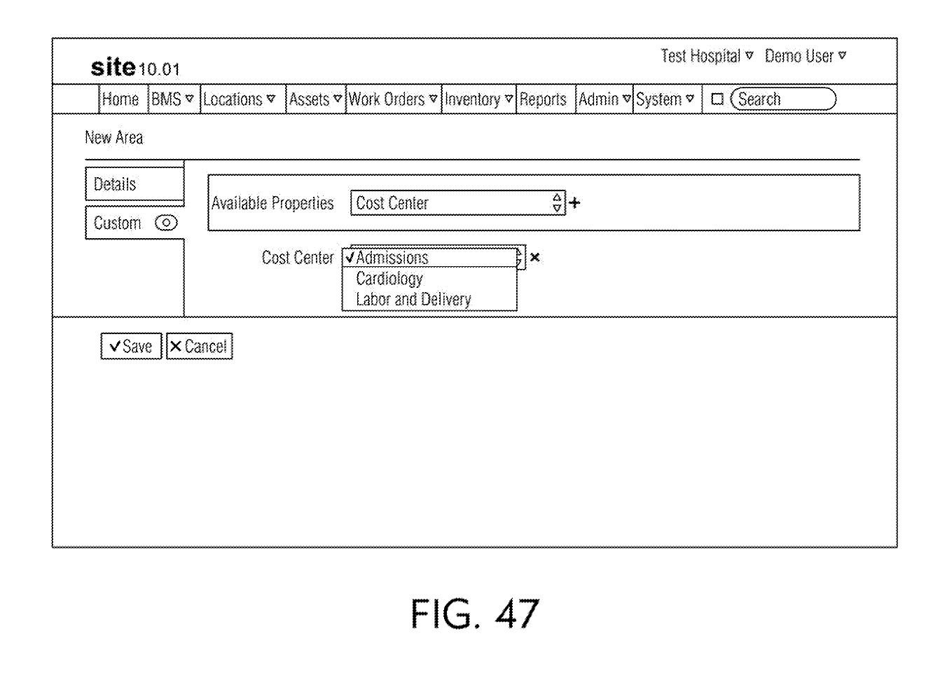

This process is illustrated in FIGS. 46-47. FIG. 46 illustrates use of information monitoring and management system 4210 to create a new area called Cardiology. FIG. 47 illustrates, on that same screen under the Custom tab, the user is adding a custom property called “Cost Center”. The custom property Cost Center has a list of specific values assigned to it (Admissions, Cardiology, Labor and Delivery). Once the custom property Cost Center is selected by the user, the user selects one of the values (i.e., cardiology) to assign it to the object (i.e., the object is an area in this example).

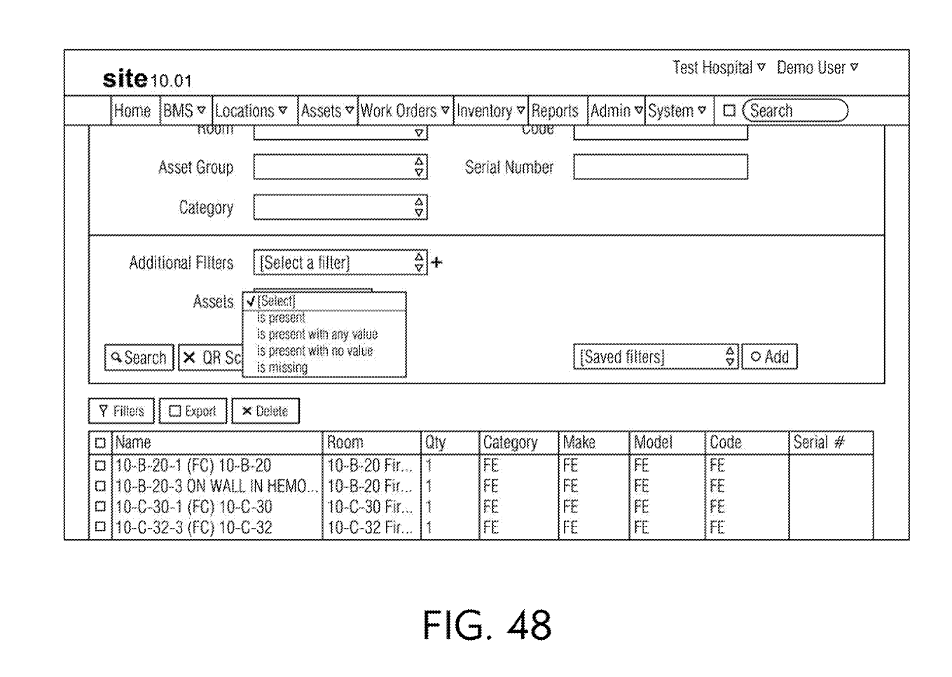

FIG. 48 illustrates use of the Custom Properties feature of system 4210 on any Dashboard in the system 4210 (assets, asset types, rooms, areas, buildings, asset groups, work orders, PM schedules, parts, etc.) to search for a specific subset of that object. In the case illustrated, the asset dashboard is shown, and a custom property called Asset has been selected (which is of type Image). Selectable options are displayed (these same options are displayed for, in addition to type Asset, types true/false, file, panorama, and PDF).

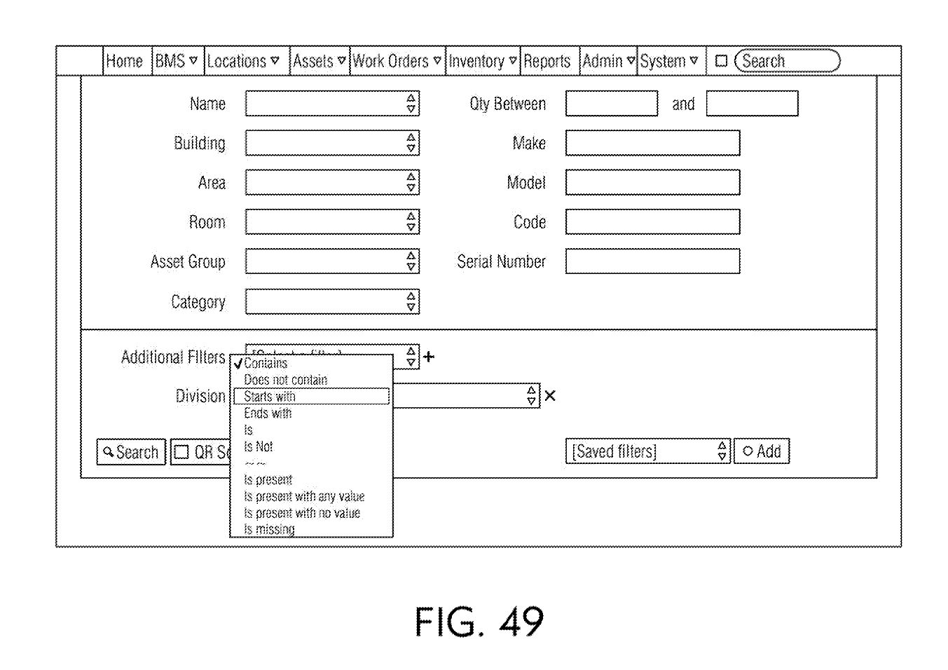

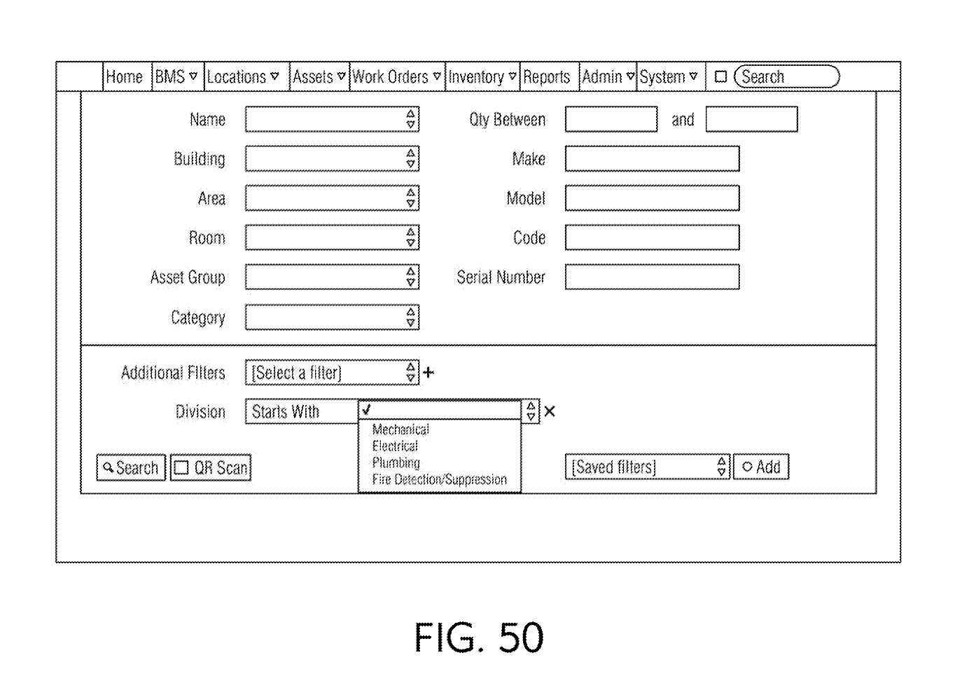

FIGS. 49 and 50 illustrate additional filters for the Custom Properties feature when the user has chosen a Custom Property of the type List. FIG. 49 illustrates, in the drop-down menu, the same items as described above in FIG. 48 plus a few additional items and FIG. 50 illustrates, in the drop-down menu, the “list”.

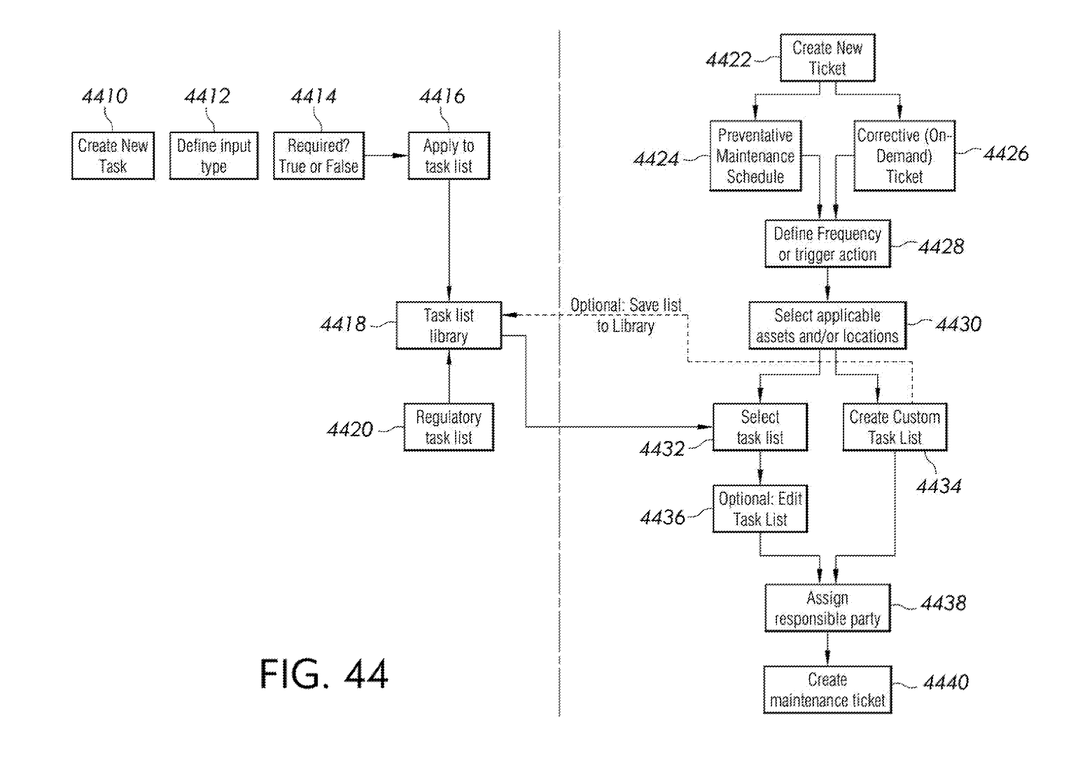

With reference now to FIG. 44, a flowchart indicative of creating a new task item and creating a new ticket are illustrated and described. Additionally, incorporated by reference herein in its entirety is U.S. patent application Ser. No. 14/186,578, filed Feb. 21, 2014 and entitled System and Method for Assessing and Managing a Facility, which claims priority to and incorporates by reference U.S. Provisional Patent Application Ser. No. 61/768,267 filed on Feb. 22, 2103, each of which are assigned to the Assignee of the present application.

At step 4410, the user selects a menu item or tab displayed by system 4210 for the purpose of creating a new task item. At step 4412, the user defines the input type (such as pass/fail, text entry, number value, date). At step 4414, the user marks whether the task item is a required task item. At step, 4416, the new task item is applied to the list of task items, known as a task item list and stored in a task item list library, as denoted at reference numeral 4418. Additionally, as denoted at reference numeral 4420, system 4210 enables other task item lists, such as regulatory task item lists from third parties, to be stored in the task item list library 4418.

As noted at step 4422, system 4210 also enables the user to create a new ticket. As illustrated, system 4210 gives the user a selectable option to create a new preventative maintenance schedule (having a frequency or trigger for action(s)) at step 4424 or to create a one-time corrective (on-demand) ticket (that does not have a frequency of action(s)) at step 4426. At step 4428, the user defines a frequency (preventative maintenance schedules only) and/or trigger action for maintenance. At step 4430, the user selects applicable assets and/or locations to be associated with the ticket being created. System 4210 provides the user a selectable option of selecting a pre-existing task item list, as denoted by step 4432, or creating a custom task item list, as denoted by step 4434. As illustrated, when the user selects to create a custom task item list at step 4434, the user may optionally save the newly created custom task item list to the task item list library 4418. When the user selects a pre-existing task item list at step 4432, system 4210 enables the user to edit that selected task item list at step 4436. If the user edits a task item list at step 4436, those edits will be updated in the task item list library 4418 and all items associated with that task item list will be similarly updated. At step 4438, the user can assign a responsible party (or parties) to the ticket and at step 4440 the ticket is created.

As an example of an advantageous use of creating a task item, assume that a building has 47 electrical panels. A task item list having a preventative maintenance schedule for electrical panels is assigned to every electrical panel in a building, totaling 47 preventative maintenance schedules. When the electrical code changes in such a way that the maintenance schedules must be updated, instead of updating each of the 47 preventive maintenance schedules separately, system 4210 enables the user to update the task item list once and the update applies across all of the associated objects, which in this example are the 47 preventative maintenance schedules assigned to that list.

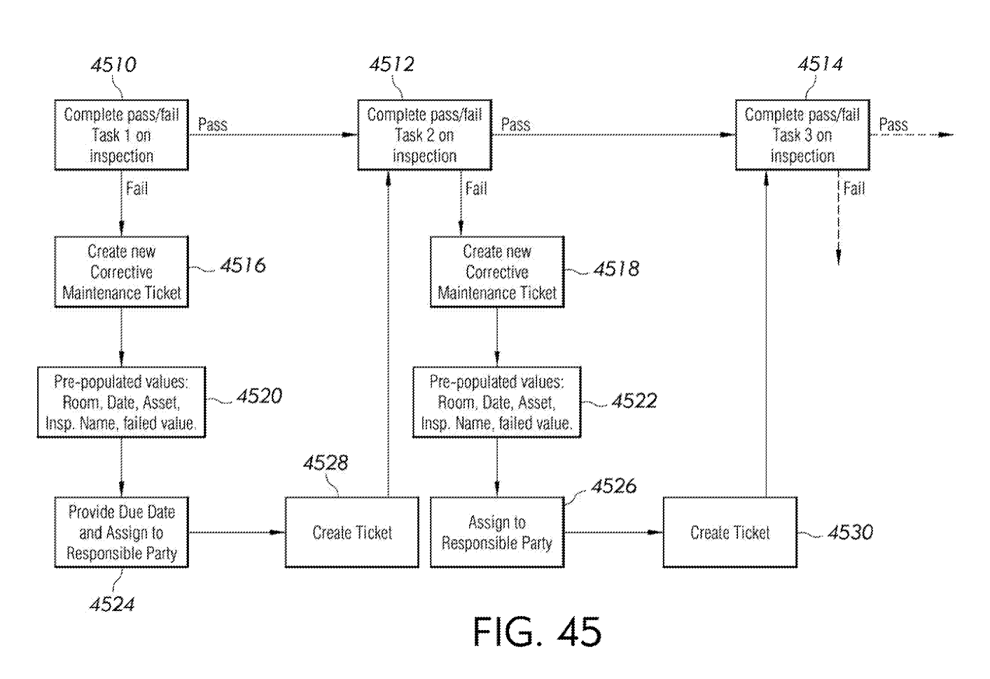

With reference now to FIG. 45, a flow diagram indicative of using a task item list on a work order is illustrated and described.

By way of example, assume that a task item list has three task items to be completed. As illustrated, a maintenance technician performing work outlined by a task item list, or for example an inspector who is reviewing the status of systems or equipment or maintenance work, indicates on an electronic work order at step 4510 whether a first task item is successfully completed (“pass”) or not (“fail”), at step 4512 whether a second task item is successful completed, and at step 4514 whether the third task item is successfully completed. As illustrated, when a task item is not successfully completed and is marked “fail”, system 4210 enables and prompts the user to create a new corrective maintenance ticket (see steps 4516, 4518). When a new corrective ticket is created, system 4510 prepopulates the ticket with pertinent values (such as room, date, asset, inspector's name, failed value, etc.) (see steps 4520, 4522). At steps 4524, 4526, the user may enter a due date for the respective task item and assign the task item to one or more responsible parties. At steps 4528, 4530, the new corrective maintenance ticket is created.

The ability to track and store pass/fail task item list steps is an important feature for regulatory compliance purposes. This stored data provides reporting ability and verification that particular work was done and was done at an appropriate time (notably, marking an item pass or fail also stores the date/time associated with that action). For example, suppose that a regulatory requirement states that the fuel level on a generator must be checked monthly, then an indication that this this work was completed at particular date (and time) needed.

As will be appreciated, each item on a task item list can be completed independently of the other items on the task item list. So, in the noted example, perhaps the first task item is a critical task item according to regulations, but a second and third task item are non-critical items according to regulations. In the event the first task item was properly and timely completed, but the second and third task items were not completed and the work order having those uncompleted second and third non-critical task items is still open, the user can still go back to prove to a regulatory agent, using the separately stamped date/time stamp on the first task item, that the first critical task item was timely completed. Additionally, when a task item is marked fail, but a new corrective ticket is created as described above, that new corrective ticket goes back into the queue and is linked to the previous ticket. Accordingly, this functionality also provides a way of illustrating to a regulatory agent that a follow up ticket was immediately made for a failed item (which may or may not yet be completed).

Additionally, in embodiments of system 4210, in addition to indicating a task item list item as pass/fail, system 4210 enables the worker to record a value in association with a task item. In one embodiment, every task item list item has a pass/fail selection and, additionally, the user has an option to record a value. Recordation of values (i.e., fuel level, oil pressure, voltage, etc.) is important for certain regulatory compliance. These values may be entries by the user and/or may be in response to provided menu-items that are provided to the user based on the known asset or location on/in which the user is working. Additionally, entry of a value may be communicated for storage in system 4210 so that trend information is developed and maintained. That trend information gives the maintenance professional an idea of whether a unit being monitored is performing well or is not performing well and, if not, system 4210 can suggest corrective actions based on comparisons with known or historical information.

As described, a task item list having a number of task items to be completed may be assigned to multiple people, with different items on the task item list being assigned to different people. As described in U.S. patent application Ser. No. 14/186,578, filed Feb. 21, 2014 and entitled. System and Method for Assessing and Managing a Facility, incorporated herein by reference, a worker completing a task item may take a photograph and transmit the photograph for storage in association with information indicative of the task item. The photograph provides a visual verification that the work was completed (or the status of the work at the time the photograph was taken). The photograph may also be transmitted to mobile devices of other assignees of the ticket along with an indication that a step in the task item is complete. This, as one example, is a useful feature in a lock out/tag out procedure in which one worker at one location in a building, for example, turns-off an electrical breaker and locks out and tags out an electrical panel so that a worker in another part of a building can safely complete an item on the task item list.

While system 4210 may be implemented, for example depending on user preference, such that multiple actions of all different kinds are combined into a single ticket, doing so may complicate the work order history. For example, one ticket that is assigned to the building but pertains to both the chiller and the boiler will not provide an accurate work order history to either asset. Additionally, or alternatively work orders may be grouped together or assigned to the same person at the same time (or a new ticket may be assigned to a person that is assigned to an existing work order or upcoming preventative maintenance work order), thereby increasing productivity. This allows the work to be group in a way that it is done simultaneously without sacrificing the integrity of the asset work order history or work order organization.

Further, costing information may be included on work orders. In this regard, monitoring and management system 4210 enables the cost of parts used in a work order to be added to the work order and/or digitally associated with the work order. Additionally, information relating to amount of time a worker worked on a particular task item and/or on the work order may be entered or counted using a timer that starts upon user-input of task item initiation and subsequent user input indicating task item completion (such as a pass/fail entry) and takes into account the hourly wage rate of the particular worker completing the task item. This information may or may not be presented on the work order but is stored and available to permitted users of the system 4210 to enable more accurate cost assessments and estimates relating to maintenance, repairs, task items, and/or work order projects. Additionally, these features of system 4210 enable grouping of cost information by room or area or building for invoicing purposes.

Additionally, a surface area value for surface finish types may be stored (by room, area, building, etc.) which enables a quantification of the amount of finishes (i.e., paint, tile, carpet, etc.) within a building. This is particularly useful to the user when, for example, carpet needs to be replaced for the building, an area, or a room and the user needs to know how much carpet to purchase.

As described, system 4210 enables a work order including a task item list to be sent to a worker's mobile communications device. As described in U.S. patent application Ser. No. 14/186,578, filed Feb. 21, 2014 and entitled System and Method for Assessing and Managing a Facility incorporated herein by reference, a variety of information may be downloaded to the mobile communications device of the user for use when the user's mobile device is offline. Actions taken while offline can then be synched back to system 4210 when the mobile communications device comes back online.

In embodiments of the invention, only selected data is downloaded to the user's mobile device for offline operation. For example, the user may select the data to download from system 4210 to the user's mobile device. Additionally, and/or alternatively, data to be downloaded can be automatically selected by system 4210 based on the location of the user's mobile device or an asset in proximity to the user's mobile device (i.e., only information pertaining to that room location or a particular asset is downloaded, thereby limiting the amount of data to be downloaded). Available memory in the user's mobile device can be taken into consideration by system 4210 and prompts can be given to the user to select information for download (i.e., asset information; room information; area information, etc.). Additionally, information to be downloaded can be prioritized and/or limited by system 4210 based on the information that is needed (and not needed) for a known task item. For example, examples of information that may be provided in order to complete the known workflow are user identifications for a ticket assignment, description of pull-down values, ticket lists, room schedule, and room graphics. Additional supplemental information such as task item lists, cut-sheets, OEM data, construction documents, photos, linked files/videos, etc. can be selected to allow for functionality while preserving data storage on the user's mobile device. Actions taken by the user while offline (such as marking a task list item “pass”, with the date and time captured by the mobile device) are synched back with accompanying information (date/time/location) when the mobile device reconnects to the network (i.e., is back online).

Additionally, the information monitoring and management system 4210 enables capital forecasting and planning. In particular, information indicative of an asset's known or anticipated replacement cost and its life expectancy are stored in memory in association with the asset. In addition to known information about the asset (such as date of manufacture, date installed, date use began, known life of use expectancy for the particular asset or asset type), data retrieved from sensors associated with the asset may be used and compared with other information to enable algorithmic or human predictions about actual life expectancy for the asset (e.g., known life expectancy under ideal conditions may be 7 years; predicted actual life expectancy based on rate of use may be 5 years). With this information, capital planning may be done by taking into account the asset's anticipated replacement cost in conjunction with its projected actual life expectancy.

System 4210 generates an Asset Health identifier (such as a percentage or numerical value or ratio) to make adjustments to the life expectancy of the asset based on sensed and known real world conditions. As an example, an Asset Health value may be calculated by assessing the number of preventative maintenance task items that have been performed on an asset verses the number of task items that were scheduled to be performed against that asset. This information may be combined with the energy consumption per asset by asset type. If the energy consumption for a particular asset is an outlier from other assets of the same type, this reduces the Asset Health value of that asset. Ranges for energy consumption may be established and the amount that the Asset Health value is adjusted may correspond to the degree its energy consumption differs from that of other assets of the same type or from information indicative of the expected norm. This information is then factored to determine a mod factor that is applied to the life expectancy of the asset in question. Other factors of Asset Health may be the timeliness and completeness of maintenance. Asset health value can also be stored and displayed comparatively (across assets of a same type).

Additionally, system 4210 compares actual performance with optimally designed performance for an asset and uses that information in assessing Asset Health. For example, considerations may include a comparison of the design of a system or the designed use of an asset. In that regard, system 4210 can store trend data indicative of how closely an asset is preforming compared with its basis of design. In particular, the basis of design includes a safety factor and a piece of equipment will be over-designed for what its actual intended use. As will be understood, safety factors for one type of building (i.e., a safety factor on an air handler in an office building) will differ from safety factors for another type of building (ie., a safety factor on an air handler in a laboratory or hospital). Asset Health may be represented with icons or graphics (such as smiley face or frownie face, etc).

Accordingly, for illustrative purposes, a few specific examples that system 4210 could take into account when considering Asset Health could include (i) comparison of actual performance to the basis of design for a piece of equipment (ii) comparison of actual performance of an asset to known information about optimal design for the asset; (iii) a unit's oil pressure is running 1 point too high over eight months and that is known to shorten asset life by a year; (iii) extra voltage is being sent to a pump and that is known to decrease the life expectancy by a certain amount because too much voltage is bad on the circuit boards, etc.

Additionally, information from sources that are external to system 4210 may be input and used in capital planning. For example, in addition to sensed environmental conditions (i.e., temperature, humidity, etc.), weather information associated with location information can be applied to the analysis to enable location or regional-based decision making. For example, a particular type of asset may have operational performance characteristics and/or statistics in Phoenix, Ariz. that differ from the operational performance characteristics and/or statistics of that same asset type in New York, N.Y. Such information can be useful in making purchasing decisions for a purchase in a particular geographical location (e.g., chiller XYZ performs better in warm, arid climates; chiller ABC performs better in colder conditions, etc.)

The information stored in and generated by system 4210 is useful for capital planning for repairs, solutions, and purchases. For example, a recommendation could be made to place a resistor in front of the pump (in the example given above) and that it is expected that such a resistor will cost $X but will likely increase the life of the pump's circuit board by Y years; or, a recommendation could be given that, if the pump is turned off periodically it is going to save an anticipated amount of money because turning the pump off is better for the equipment because it has a chance to reset and that ramping up does not take as much energy as thought based on actual data, etc. Additionally, resulting actions could include changes in a preventative maintenance schedule (e.g., data indicates that a machine does not use as much oil as indicated and the number of actions needed to be taken to maintain the machine are reduced, thereby saving money). Energy consumption could be adjusted based on data, thereby saving money. Accordingly, system 4210 enables the user to use all of the captured sensor data to make real decisions about asset health and smart building and energy monitoring and optimization and correspondingly resulting capital planning.

Additionally, monitoring and management system 4210 enables assets to be organized together through an organizational feature called Asset Groups. The Asset Groups feature allows assets from different types to be grouped together. This allows a user to group together assets, including assets that might not otherwise be considered as being together. For example, a user may group all the assets involved in the AHU-1 loop (VAVs, fans, VFDs, etc.) or all of the energy-saving vs non-energy saving light fixtures. System 4210 enables users to assign, at the asset group level, custom properties and therefore associate and store in association with an asset group additional pieces of information that are relevant to that group. Additionally, trendlines of historically sensed data received from a BAS or other sensors may be created for one or more assets in a group to allow users to troubleshoot one asset against another or an entire system. The Asset Groups feature also enables a display of all of the work orders for the assets in a selected group so a user can view everything that needs to be or has been done on those particular assets.

As described above (see discussion pertaining to the FCS), the information monitoring and management system 4210 enables placement of hyperlinks (hotspots) on room images that can be utilized to link to assets as well as adjacent rooms. Hyperlinks are added by selecting the edit map tool from a room page, Additionally, hyperlink maps are stored at an independent data layer allowing for the underlying image to be substituted or updated without losing the map information. When viewing a particular image, such as a Floorplan image, a list is displayed that displays a list of rooms in that area. This can be changed by the user, but the default is a filtered list. When viewing a discipline view (such as a view pertaining to electrical, plumbing, etc.), the assets assigned to the room appear in a list. The user sets the default size of the hotspot then drags the item from the list to the location on the room image. The size and shape of the hyperlink can be adjusted based on the geometry of the asset shown. As assets are placed on the image they are removed from the list to ensure duplicate links are not added in a single room. This tracks quantity of assets as well (i.e., there are four light fixtures in the room and 15 light fixtures left in inventory).

Additionally, system 4210 enables the user to tag an asset that has been assigned to one room to also tag that asset with an additional room. For example, a Variable Air Volume (VAY) controller in an HVAC system in a hospital may be located in the hallway but is used to control temperature in a patient room on the other side of the wall on which the controller is located. In such a case, the VAY controller itself would be assigned to the hallway in system 4210 (because when it needs to be maintained, the maintenance professional needs to know its location and related information—e.g., lift the ceiling tiles in the hallway, don't go into the patient room, stay in the hallway, etc.). However, from a data management and usefulness perspective, it is helpful to know that the VAY controller in the hallway is the one serving a particular hospital room. Accordingly, system 4210 meets this need by enabling the asset (VAY controller), that is assigned to one location (the hallway), to be tagged in the corresponding room it serves (patient room in hospital). Additionally, for example, in some commercial environments, a VAY controller may control multiple rooms, in which case each of those rooms may be tagged with the asset.

Information monitoring and management system 4210 enables the user to generate numerous reports and types of reports. Information may be output in a spreadsheet data file. Reports based on prepared templates (such as historical data for an asset for 30 days, 60 days, and/or 90 days) may be generated.

Additionally, graphical representations of historical data may be generated and displayed, printed, and/or electronically communicated. For example, trendline information of sensor data over time, alone or in combination with other data (such as weather, information from related assets, etc.) may be generated and stored, displayed, and/or communicated. Graphical depictions may include representations of gauges, bar graphs, pie graphs, and other depictions to indicate information over time and/or in comparison with other information.

Additionally, system 4210 enables custom reports to be generated. Using user-entry fields or drop-down lists or menus or tabs or icons, a user may select items and time-frames of interest and have a report pertaining to the selections generated. Period, electronic distribution of period reports to selected users may be scheduled.

Compliance reports using entered lists may be generated. For example, information in the task item list library 4418 can be used to generate reports. Additionally, and/or alternatively, regulatory standards may be entered and information from those standards may be selected for generating a report. For example, an ASHE standards list may be entered and system 4210 can, upon user request, generate a report of all of the maintenance items required by the ASHE list and compliance (or lack thereof) of those maintenance items.

System 4210 enables productivity reporting, such as information indicating the data in system 4210 on how well staff is responding to work as submitted (e.g., timeliness of responses to task items or alarms; comparative information detailing the time it takes to complete task items by category (indicative of why certain things take longer than certain other things)).

Detailed reports by type of Internet of Things (IoT) sensor may be generated.

Energy usage reports may be generated. Additionally, analytical information pertaining to energy usage and predictions may be generated. Such reports may include predictive information, based on comparison of data with other known information. Such reports may also include opinion-related information or commentary, using historical and/or known information and results/outcomes in comparison with captured data. Such reports may include, based on sensed information in comparison with stored and known and/or predicted information/outcomes/results/pricing/costs, predictions and recommendations directed to anticipated capital expenditures and/or recommendations for saving money on energy expenditures or extending the life of equipment, enabling business decisions and building management decisions for facility managers.

Additionally, monitoring and management system 4210 enables images taken by contractors or service providers of interior portions of walls (i.e., photos taken during the construction phase of a building) that show what is behind drywall. System 4210 employs a data structure that has placeholders for images indicating the location of electrical conduit, plumbing, and/or medical gas or other lines, etc., are running behind the drywall so workers can avoid punching holes in walls to see what is behind the wall and where those items are located. This can be done by loading the image to system 4210 and/or interfacing, such as by an application program interface, with existing services/sources that provide such images. These images can be linked to work orders and sent to workers' mobile devices to enable more efficient and safer maintenance with less tear-out and potential for damage.

System 4210 employs useful data visualization and data import features. For example, system 4210 is developed so that the visual model of a building looks a desired way for visual purposes. For floorplans, system 4210 renders the walls in a dark color or shade and floors in a lighter color or shade. The room label is drawn in a dark color or shade, so it can be read easily. Extraneous text and/or symbols, that clutter the imagery and that might be confusing, are removed. Color coding is used. Fire-rated walls are displayed in red. Roofs and ceilings are hidden so the entirety of the room can be seen in the visual display of the floorplan. For discipline views (mechanical, electrical, plumbing, etc.), graphical information indicative of insulation for pipes is removed, supply and return conduit objects are displayed in different colors, and each discipline uses its own color or colors. Code clearance (especially important for electrical) can be highlighted or removed depending on client preference. The viewpoint for the display is set at a specific level for each discipline view so the discipline views all are viewed from the same perspective. Assets corresponding to the particular discipline are turned “on” for visualization while assets not corresponding to the selected discipline are turned “off” and therefore hidden. Additionally, for discipline views, room labels and walls are modified to appear in a lighter grayscale, so the assets are more prominent.

Regarding aggregation of building and building system data into system 4210, one approach is to manually/visually link the design documents with the PDF OEM manuals, etc. In embodiments of the invention, an automated data aggregation process is used that involves scanning and searching documents for keywords for asset names, assignments and/or groupings and automatically breaking down large documents to their individual components.

In embodiments, a software application is used to scan and identify all items in an image based on what is in the name of the item. So, for example, anything that could be described as generic object, such as a chair or a table or a desk or cabinet the application finds and identifies those items by information in the name of those items and places them in a list and everything in that list gets assigned a certain color. The same process is carried out for all groups, such as for example walls, or ceilings, or a list of electrical equipment, or even the text that comprises the room tags, etc.

In embodiments, a process is deployed using a software algorithm to cycle through images from digital building models in search of multi-line text (M-text) items on the image. An example of an M-text item is a room tag (room names and numbers). A saved viewpoint is created over each M-Text item (such as a room tag) based on the size of the text so that the size of the viewpoint corresponds to the size of the room. All of the saved viewpoints are scaled to the size of the room based on the text. The room names and numbers are exported a CSV file that can be imported into system 4210.

For example, old paper drawings (such as those used in the construction of older buildings) are scanned and converted into a particular format (such .DWG files for use by programs such as AutoCAD) and layered into a working software environment (such as Navisworks). This allows the image-creation and visualization process of system 4210, described above, to be utilized for older buildings.

More particularly, the searching process may look for asset labels that are traditionally present on construction and building planning documents, such as VAY, HVAC, etc. As noted above, there is also M-text that will be present on such documentation that can be searched on the scanned drawing.

Further, a system and method for identifying room locations (i.e., the location of the walls of a room) on drawings for which information has been scanned from paper and converted to a .dwg file identifies the center of a room using a room tag and employs geometric techniques to calculate anticipate locations of walls.

As is known, a key plan is a floor plan showing primary architectural elements, such as by floor level of a commercial building, and is important for giving a user an understanding of where a specific room is in relation to an area or floor of a building. In embodiments of the invention, a key plan is manually created for each room, where each room is defined by manually drawing a box around each individual room. In embodiments of the invention, key plans are generated using geolocation techniques, such as by tracing a mobile device that transmits coordinate information around the interior of each wall. Additionally, and/or alternatively, data from sensors that are located in or on the various walls of the floor or area and that have known locations can be used as position guides for drawing vectors to simulate walls. Additionally, and/or alternatively, coordinate information for a room coupled with mathematical techniques for approximating wall locations can be used to identify room boundaries and then a colored box may be drawn and saved over each room and then output as a viewpoint over the entire digital model of the space.

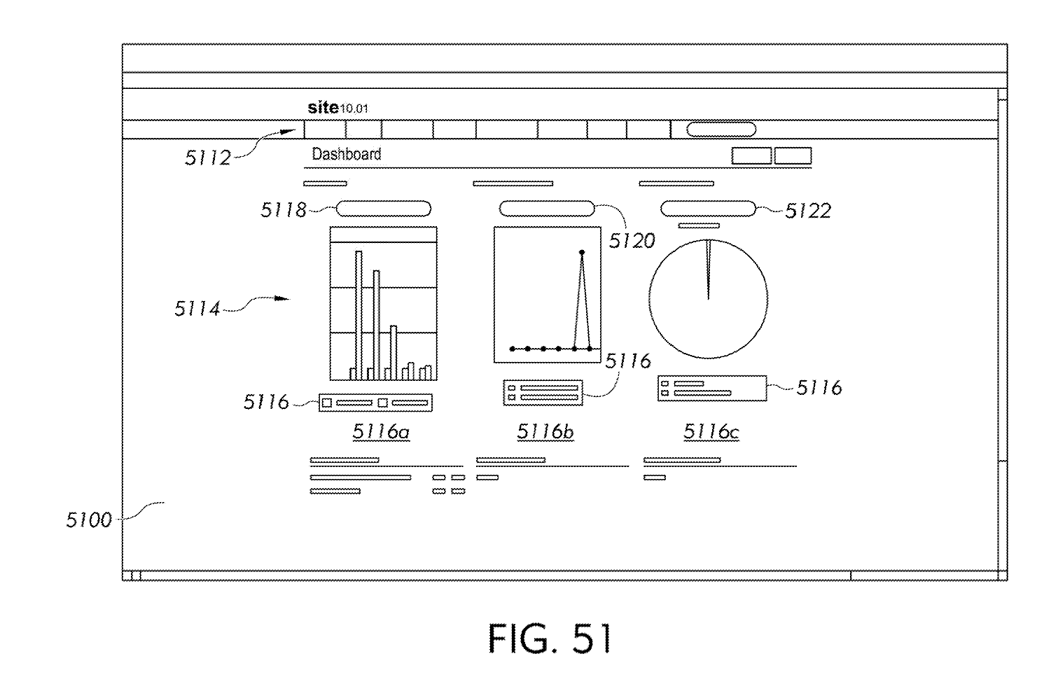

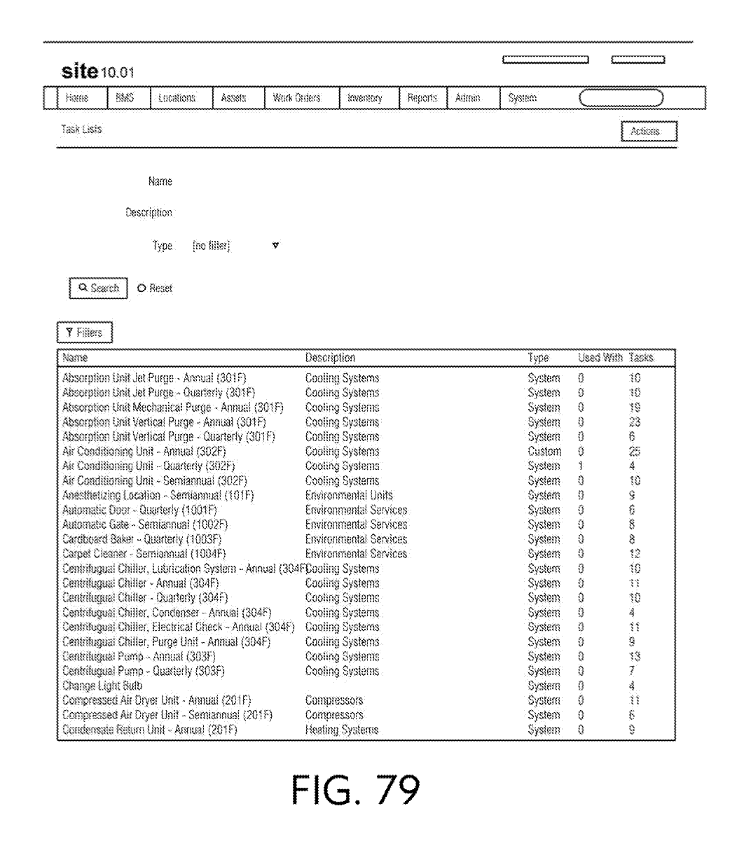

With reference now to FIGS. 51-92, screen displays generated by monitoring information management system 2510 are illustrated and described.

FIG. 51 illustrates a home screen, depicted generally by reference numeral 5100. Home screen 5100 includes a menu 5112 and graphically displays a dashboard 5114 including gauges 5116 that graphically display reports of information pertaining to operational aspects of assets being monitored and/or accumulated information relating to sensed data or assets being monitored. For example, gauge 5116a displays an aging report that tells the user how long a work order has been sitting undone. For example, aging reports can be generated for entered or selected timeframes such as 7 days, 30 days, 60 days, 90 days, etc. The aging report includes a bar 5118 indicating the total number (149) of open work orders at the present time. Gauge 5116b indicates average response time from the creation of a work order to its completion looking at a selected time frame (such as, for example, the past 30 days). Gauge 5116b includes a bar 5120 indicating the total number of work orders included in that calculation average response time. Gauge 5116c illustrates assigned work orders, which includes work orders that have been assigned within a select timeframe (such as +/−30 days). Accordingly, gauge 5116c is capturing some of the aging (i.e., unfinished work orders as well as information regarding future work orders (such as preventative maintenance work orders. Additionally, the information indicates the number of those work orders that have been assigned and those that have not been assigned, as indicated at bar 5122.

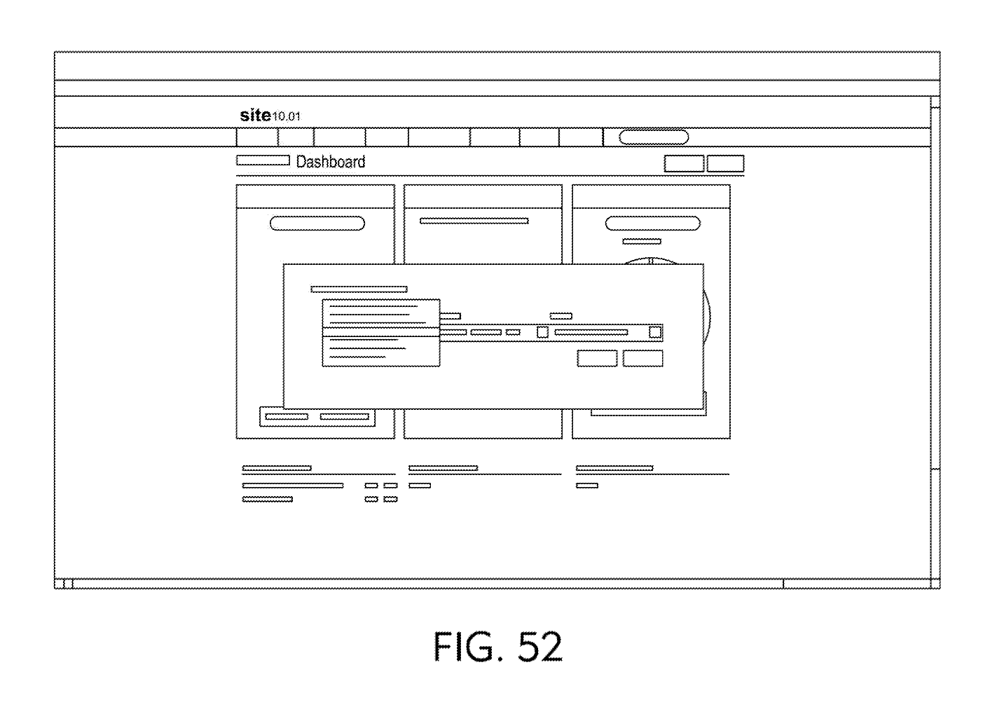

FIG. 52 illustrates a pop-up window that enables the user to change the display to indicate other reports (i.e., gauges). For example, average completed per FTE can show how many work orders (on average) are being completed by each technician (user) in the system over the last 30 days. This can be an indicator of how productive each employee is being or how productive the system as a whole is in allowing work orders to be completed. The gauge includes a bar across the top stating the actual average and two bars to indicate completed CMs (corrective or on-demand work orders) and completed PMs (preventative or schedule maintenance items). Another example is completed within 14 days. This shows the number of work orders in the last 3 months that were completed within 14 days of their scheduled date in a bar across the top. The graph shows a percentage of the completed work orders that match this criteria for both CM (corrective or on-demand) and PM (preventative or scheduled). This percentage can be viewed as a compliance percentage for how quickly work orders are being addressed. This is particularly useful in an environment where compliance is based on the speed at which issues are addressed, such as patient comfort issues in a hospital setting. Another example is average labor cost per ticket. This gauge gives a dollar amount across the top that shows the average cost of the labor for tickets by month over the last 6 months. This allows the user to see how much labor has been expended on tickets each month compared to other months. Labor cost can be calculated as effort hours times user hourly labor rate for the user assigned to the ticket or effort record. It is possible to assign a different hourly labor rate to each user. Another example is the work order status gauge. This gauge shows a percentage for each status of ticket (completed, active, canceled, on hold, created, etc). It can include all tickets with scheduled dates within the last 30 days. It can display the total number of tickets with scheduled dates within the last 30 days across the top.

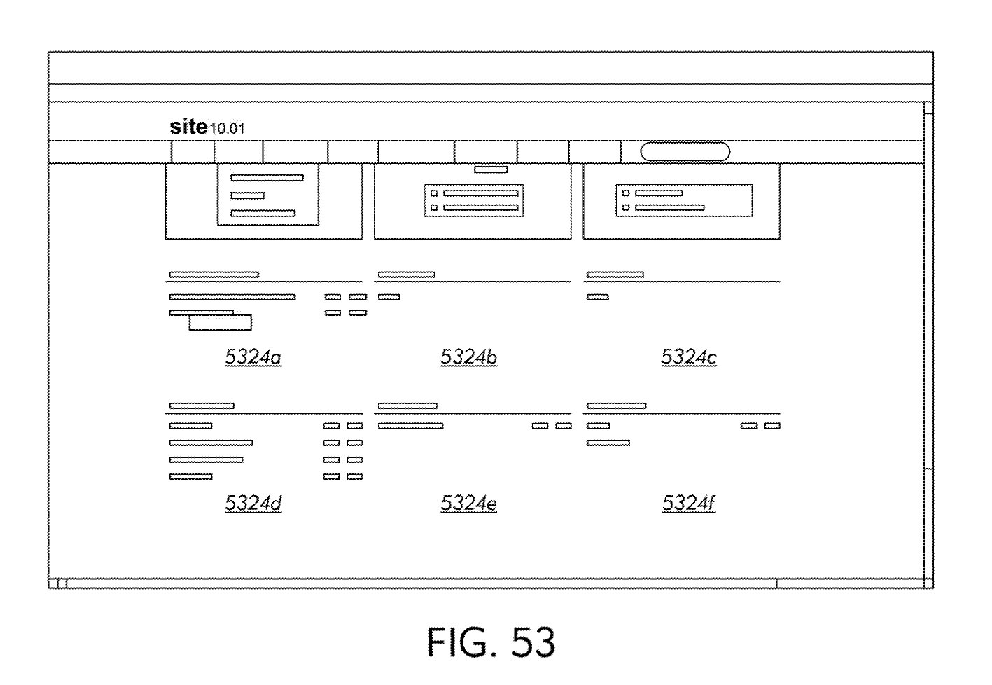

FIG. 53 illustrates the bottom of the home page. Six boxes 5324a-f are illustrated that refer to the most-recent and/or upcoming activities worked on by the individual user who is using the system 4210. This provides the user with an interface to link back directly into something that he or she was doing recently so the user does not have to navigate back to that point in another manner. Additionally, FIG. 53 illustrates the open BMS (Building Management System) navigation tab that is illustrating the menu three menu sub-items under the BMS tab.

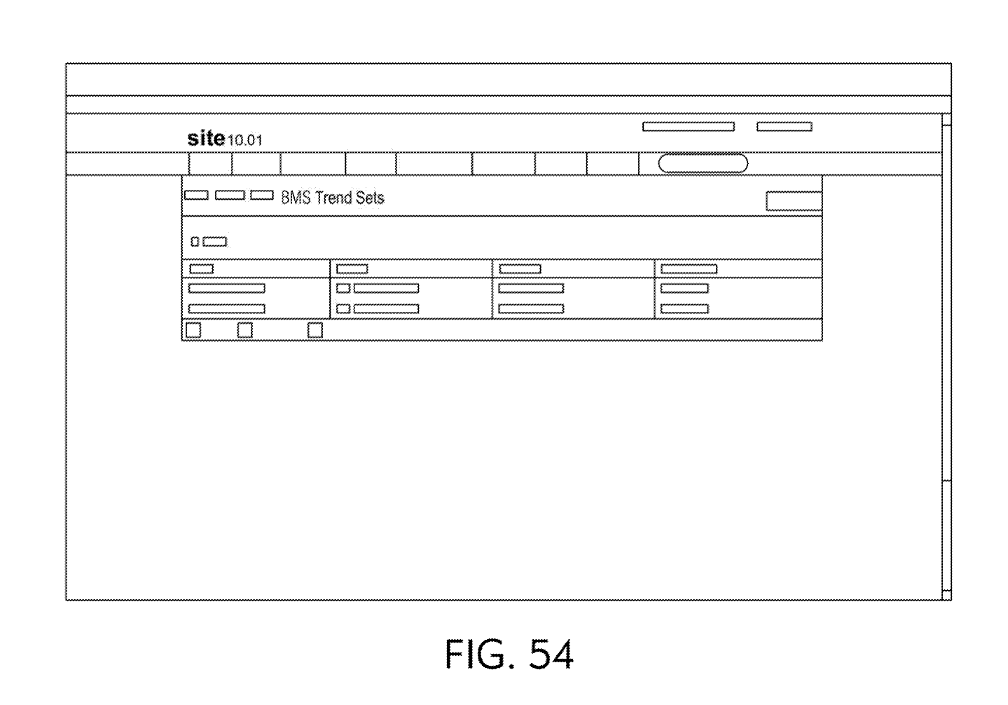

FIG. 54 illustrates trend set, a page to which the user is navigated when selecting that option under the BMS drop down menu of FIG. 53.

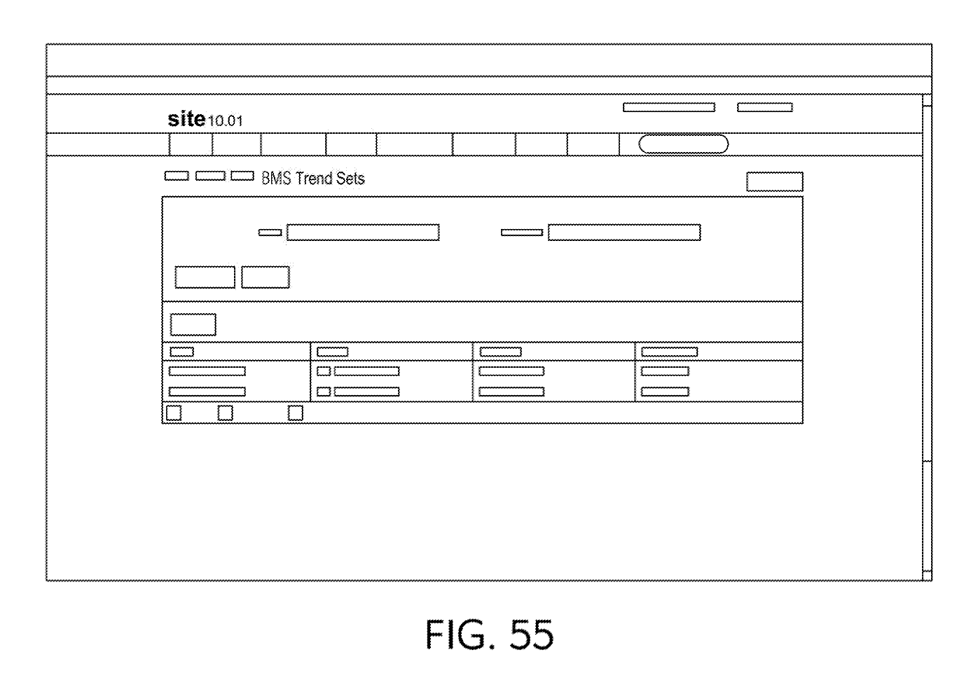

FIG. 55 illustrates the same page as FIG. 54 with the filters set open.

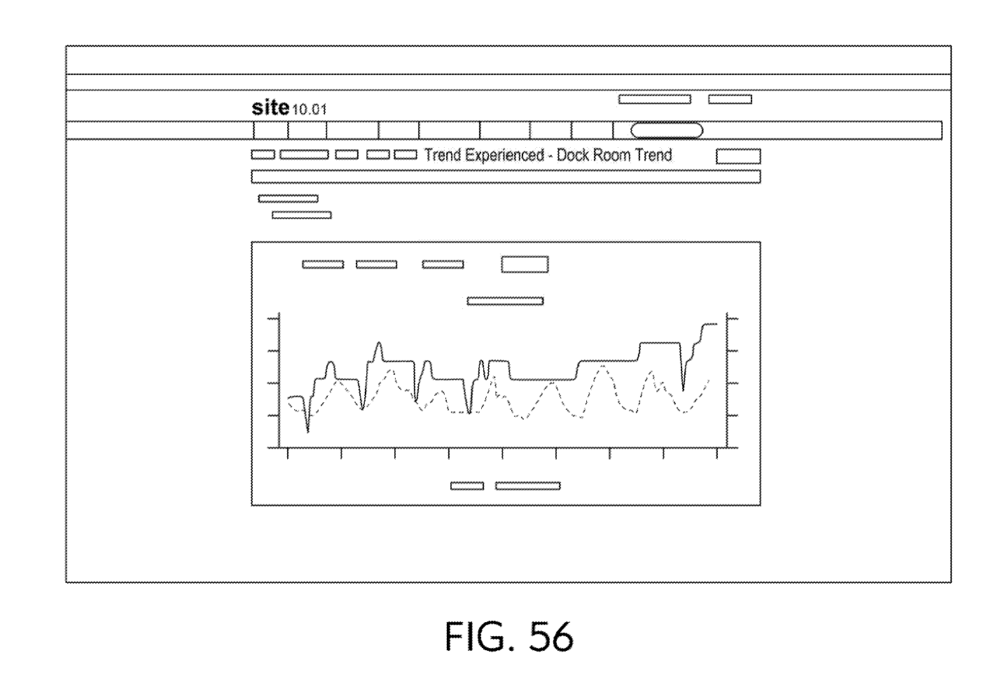

FIG. 56 illustrates a trend page based on selecting a trend set. FIG. 56 shows that system 4210 provides the user with trend lines that are associated with that trend set. For this illustration in particular, displayed is the weather line which occurs on every trend set across the whole system 4210 based on the zip code of the building that the user is viewing. Also shown is a line indicative of room temperature data for the selected room (Dock Room Trend).

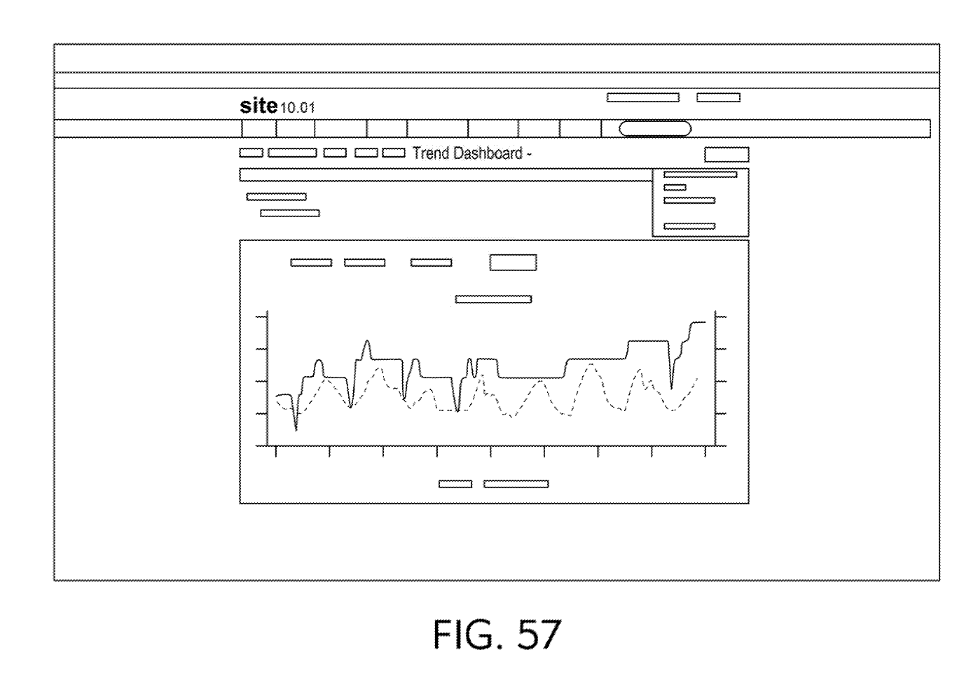

FIG. 57 illustrates the same view as FIG. 56 but with the actions button open. The actions button gives the user some additional selectable options. Instead of navigating back to the dashboard, the user can create a new trend set from the Actions menu. As illustrated, the user can delete this current trend set or can edit it from this page.

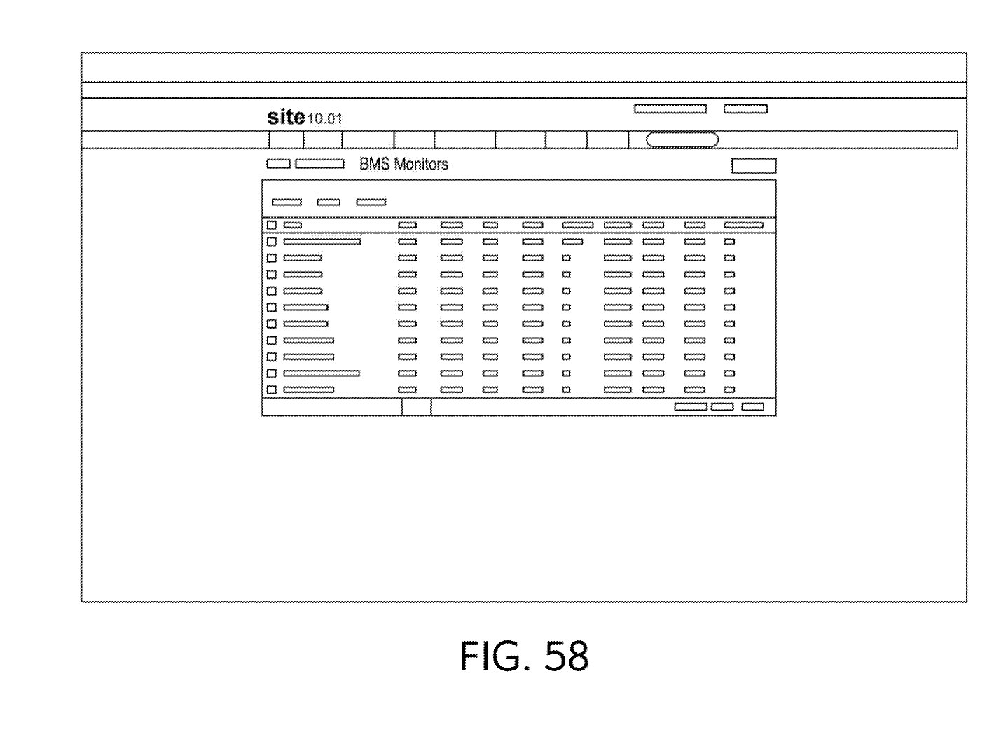

FIG. 58 is the BMS monitor's dashboard which the user navigates to by selecting the BMS tab and then selecting “monitors”. This screen shows the user all of the monitors (as defined above; i.e., a combination of an asset and a sensor) in the system 4210.

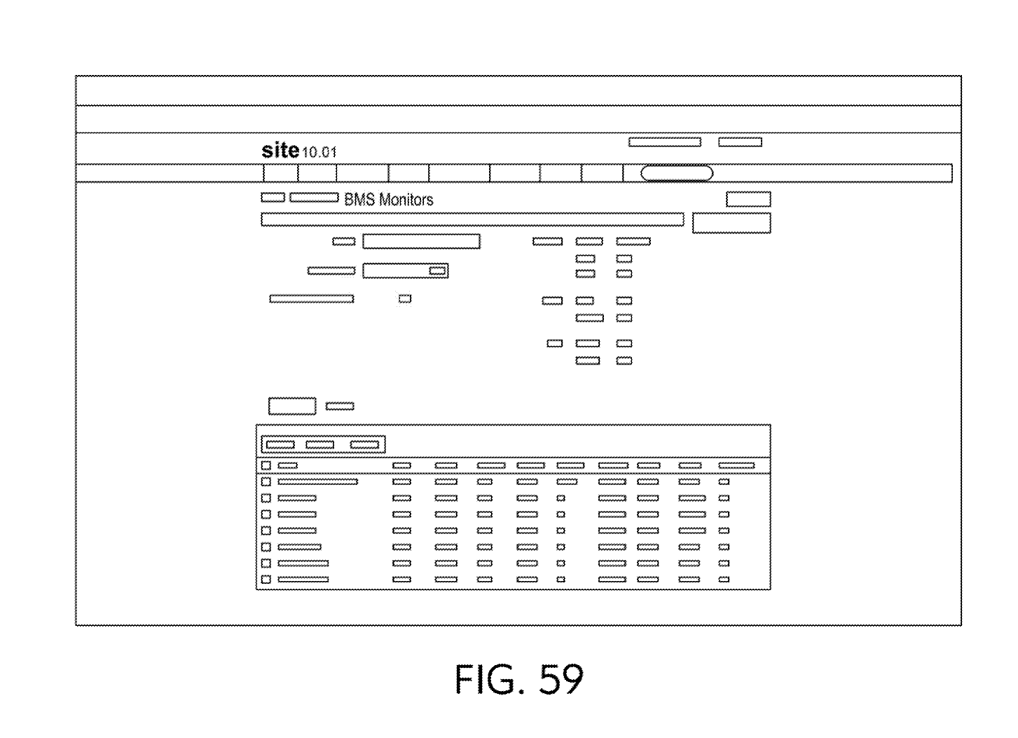

FIG. 59 is the same screen as illustrated in FIG. 58 with the filters tab open.

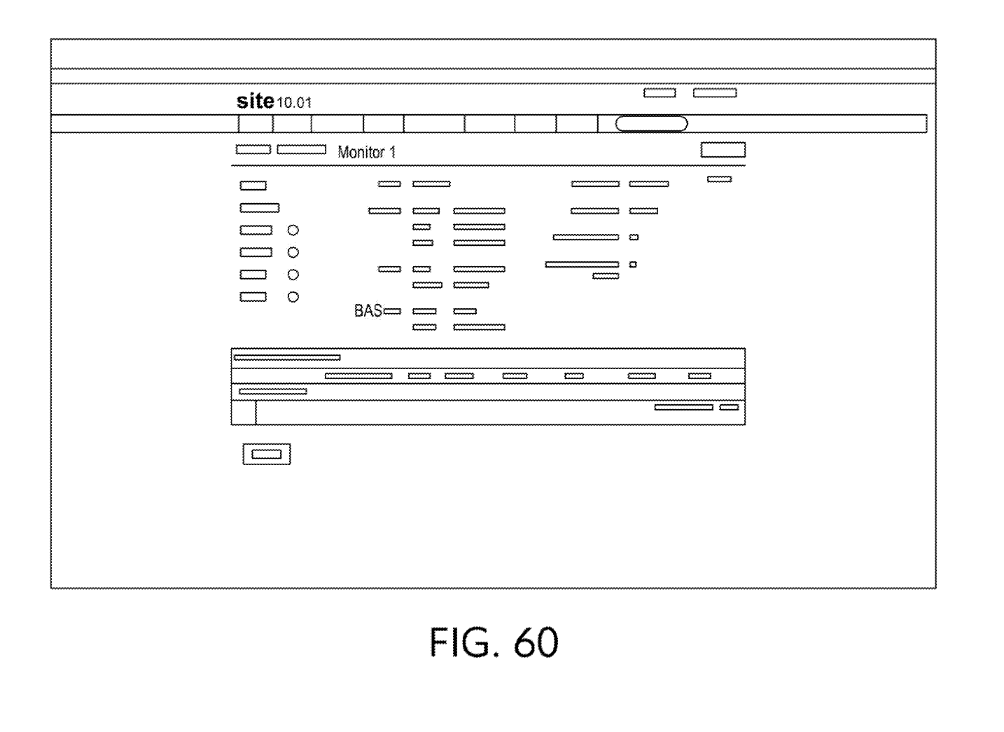

FIG. 60 is navigated to by selecting the monitor which takes the user to this view of information inside of the monitor. As shown in the second column of information each monitor has a name (a user entered free form name). Each monitor has either an asset, which has a location, or just a location. Accordingly, at the bottom of the middle column, where it is labeled BAS, information indicates the sensor and device association with the asset or room that is being discussed in this particular monitor. On the far right in the third column are options for the kind of monitor that is being considered and also the ability for the user to indicate that he or she wishes to create a work order for the monitor. Examples of monitor type include an alarm, a trend line, a threshold alarm, and a current value. System 4210 may further enable the user with the option to create a work order based on a particular monitor type. On the far left of the screen, in the first column, because that create work order check box is checked, system 4210 gives the user the option begins filling out all of the details of the work order (i.e., give the work order a name, assign it to a particular person, enter information for the work order, etc.).

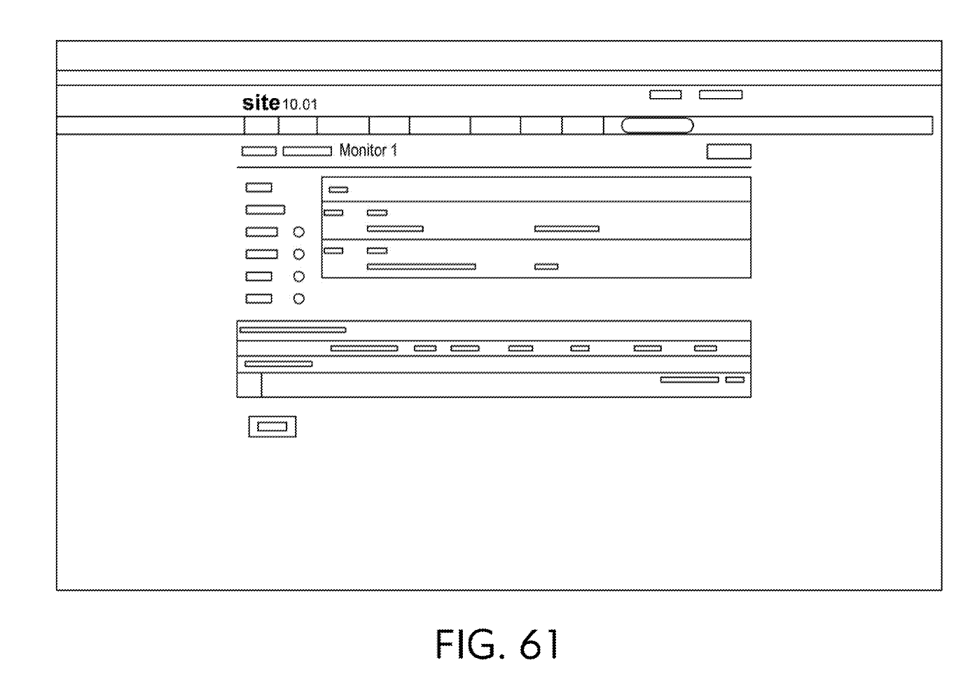

FIG. 61 is the same screen as illustrated in FIG. 60, but now, starting at the far-left column, the user clicked the task tab which is at the very bottom. As a result, the screen presents information indicative of the way the user can add these task items to a work order that is based on an alarm.

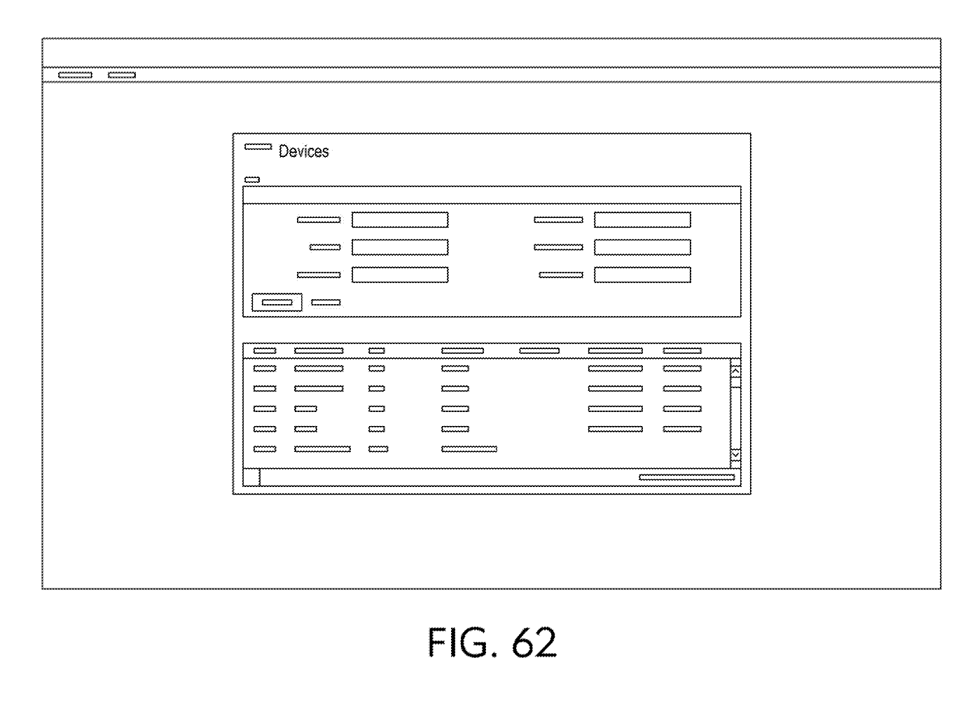

FIG. 62 illustrates a selection screen for devices, as defined herein.

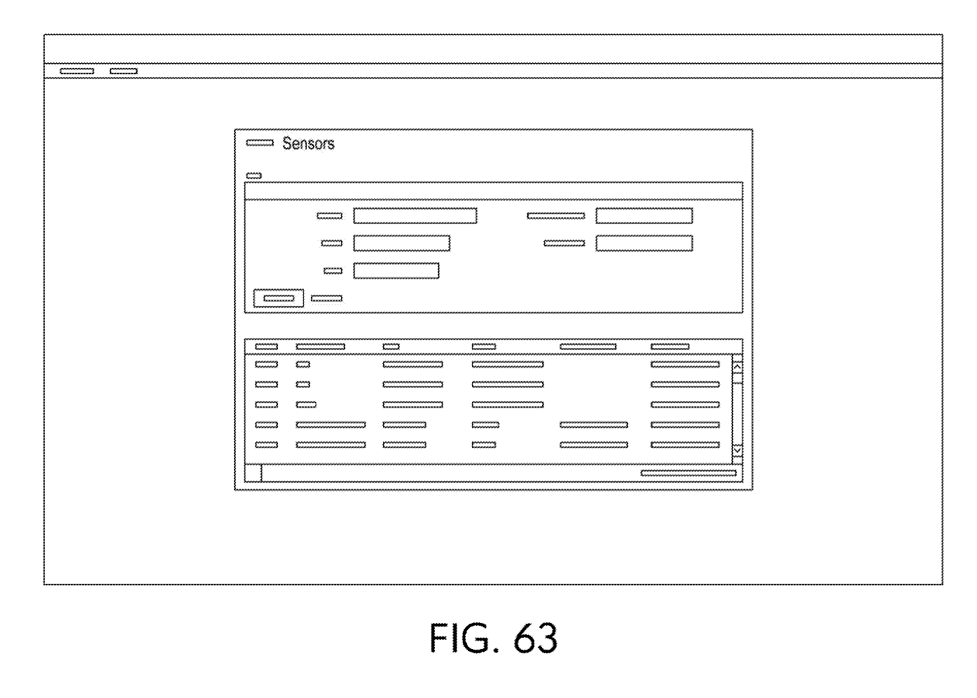

FIG. 63 illustrates a selection screen for sensors, as defined herein. The list of sensors is imported from the BAS server described herein. In other words, this list represents the data points discussed above in conjunction with FIG. 43 and this list represents the information that is transferred via line 4326 in FIG. 43 and the information is coming from a database outside of system 4210.

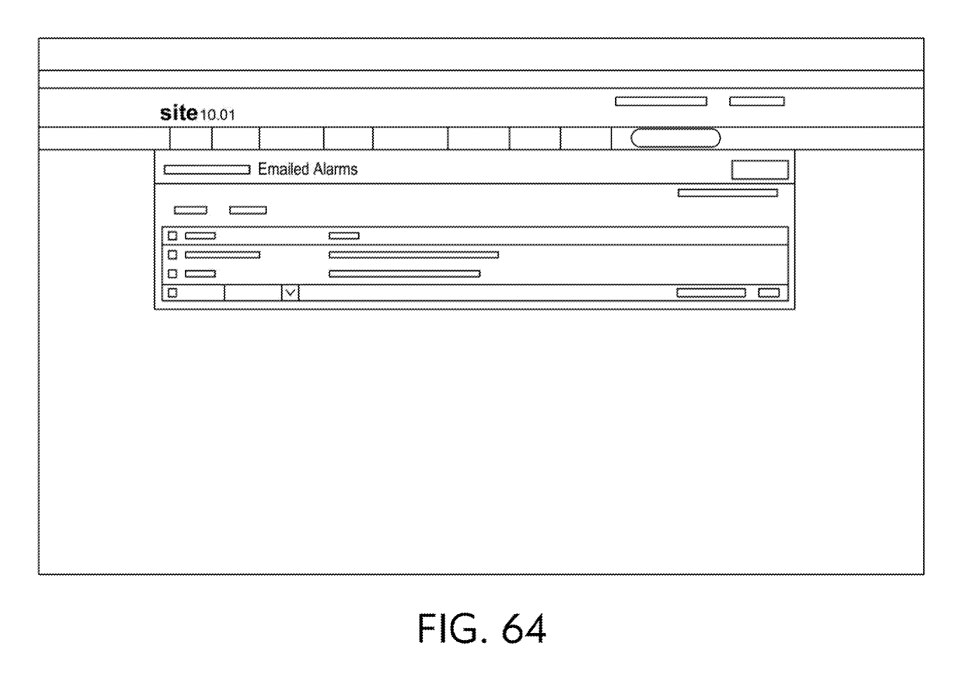

FIG. 64 illustrates a display screen representing emailed alarms. This screen is navigated to by selecting “emailed alarms” under the BMS menu tab.

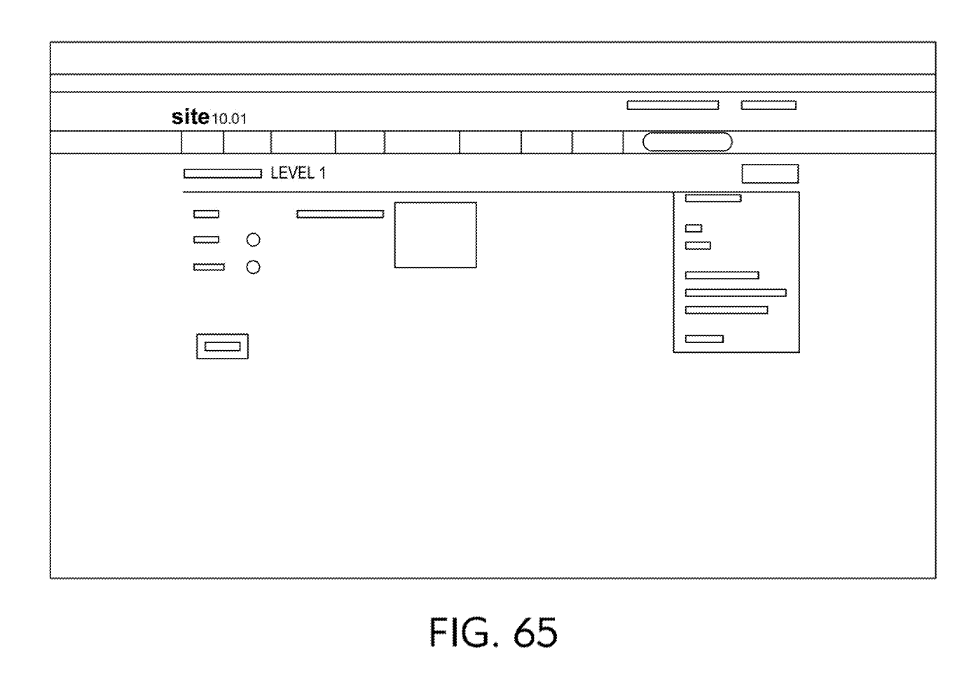

FIG. 65 illustrates a screen to which the user navigated by selecting the “locations” menu tab and the selecting “areas”. In particular, FIG. 65 illustrates the “actions” button being opened. Under the actions button, there is an item labeled “Add New Work Order”. When the user selects “Add New Work Order”, the system navigates the user to the new work order screen and auto populates into the work order information based on the screen that the user is navigating from. So, in the screen illustrated-level I—when the user adds a new work order, the system prepopulates the building that the user is in as well as the area that the user was viewing. This functionality is available for any object in system 4210, including but not limited to rooms, assets, areas, monitors, devices, buildings, etc.

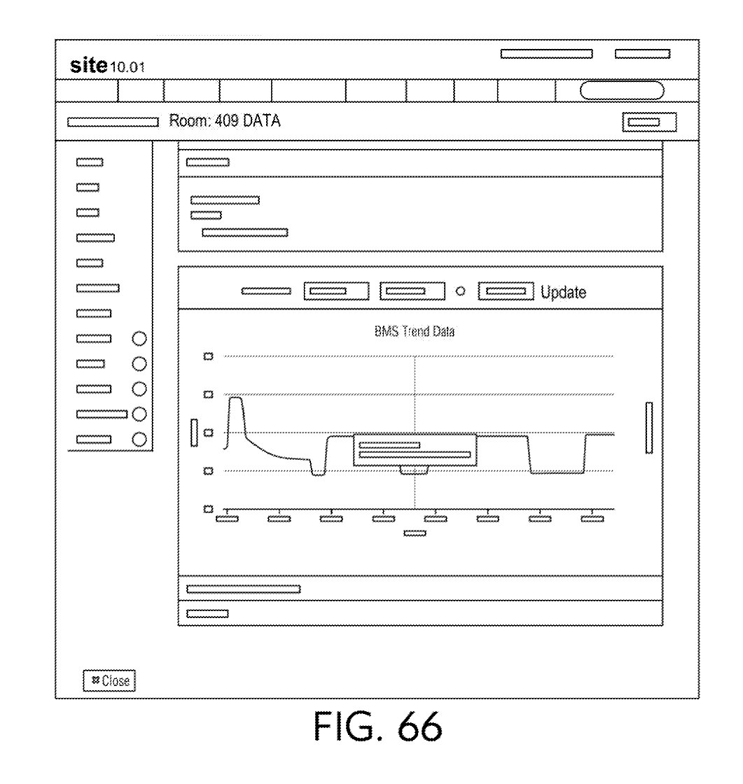

FIG. 66 illustrates a trend line monitor for a room view. In the case illustrated, there is no asset involved in this monitor. In that regard, monitor that associates an asset and a sensor can be viewed by navigating to the asset (from its location, the user may link to the asset and, from there, view the monitor trend line). It will be understood and appreciated that system 4210 may be implemented such that navigation to monitors may occur in other desired ways. As is also illustrated, a weather trend line (which is turned off in this view) may be selected (turned on) to simultaneously display a weather trend line. Additionally, system 4210 provides the ability to hide the displayed trend line (which is useful if the display is displaying numerous trend lines and the user wants to hide one of them or several of them). Additionally, system 4210 provides the ability for the user to change (by clicking on the text labeled “Data Rm 409 Temp”) the color or scale of the trend line. Additionally, as illustrated, system 4210 enables the user to change the date range of information viewed.

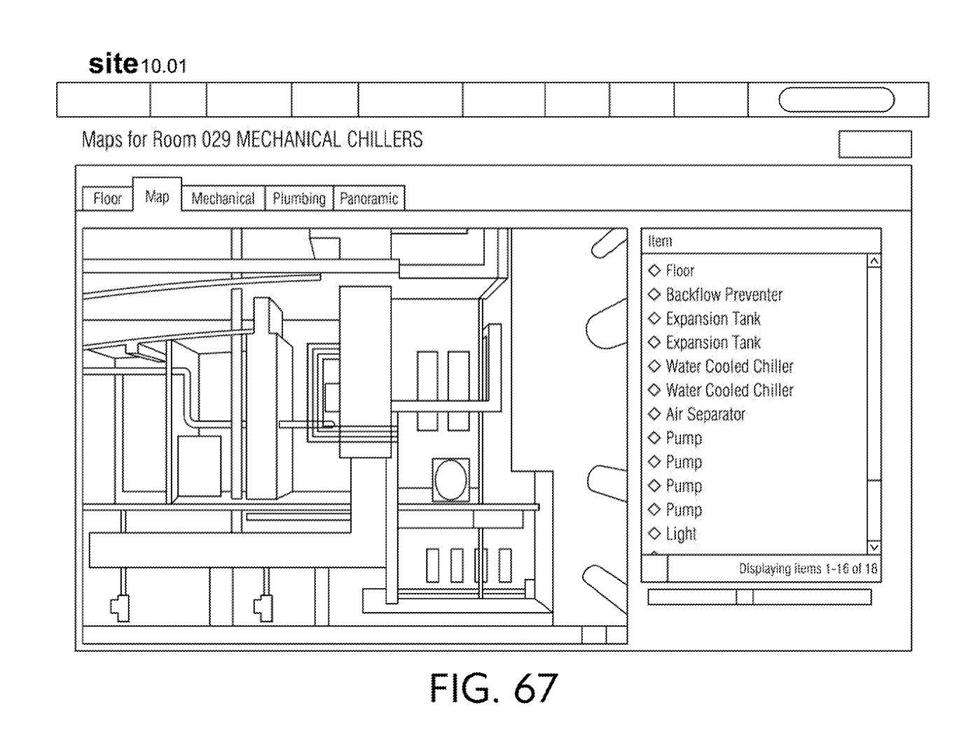

FIG. 67 illustrates the edit maps view which is navigated to by selected “actions” and then “edit maps” from a room view. This view illustrates all of the MEP (Mechanical, Electrical, and Plumbing systems). In particular, this screen illustrates how to make hotspot associations on the images. As described, the image is one layer of data and the hotspot is a completely separate data layer, so the user can substitute the images and the hotspots will remain in the same location. To make an association of a hotspot on the image, the user clicks on the crosshairs in the box at the right and drags the item to the image. From there, the user can reshape the circle to fit and move it to fit exactly over the asset that the user is identifying. Also, there is a quantity value associated with every asset that is listed in the “Item” box. Accordingly, if there are nine light fixtures in this room, once the user drags nine of that exact same light into the picture, that line is deleted from the list because it is no longer available (the user used all nine of the items). This Item list is already sorted to only the assets in this room. In accordance with embodiments of the invention, hotspots may populate themselves on the image based on coordinates that are associated with the items. Additionally, features of system 4210 enable the user to change which room he or she is viewing because the user wants to use an asset that is in a different room (perhaps because that asset serves that room and the user wants to include that link here).

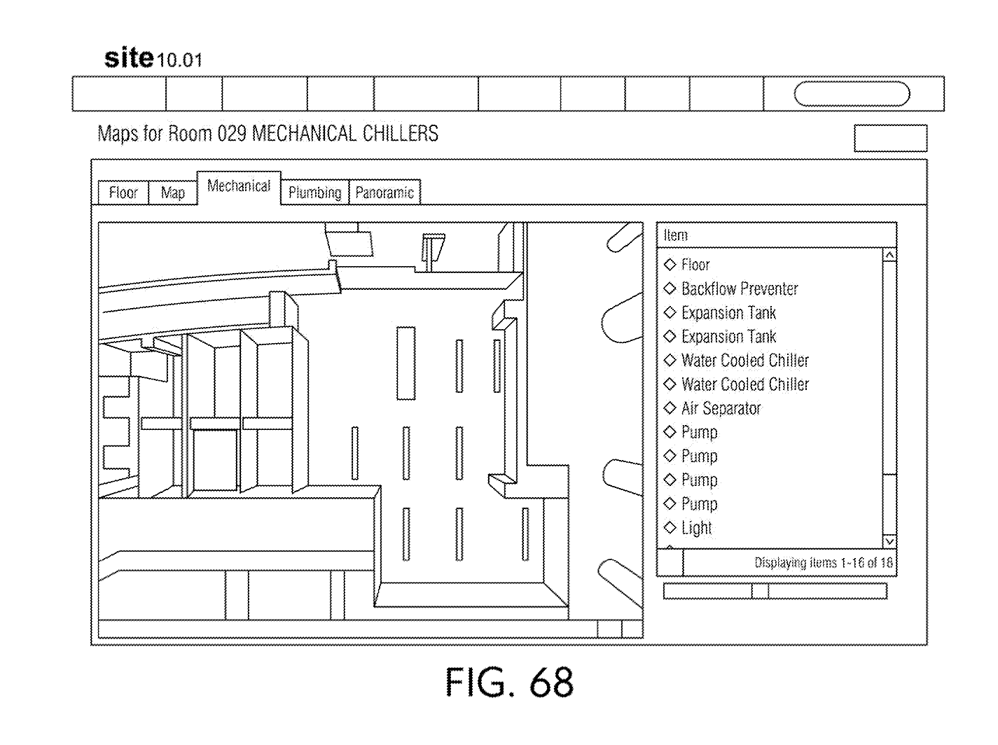

FIG. 68 illustrates a view of just the electrical system.

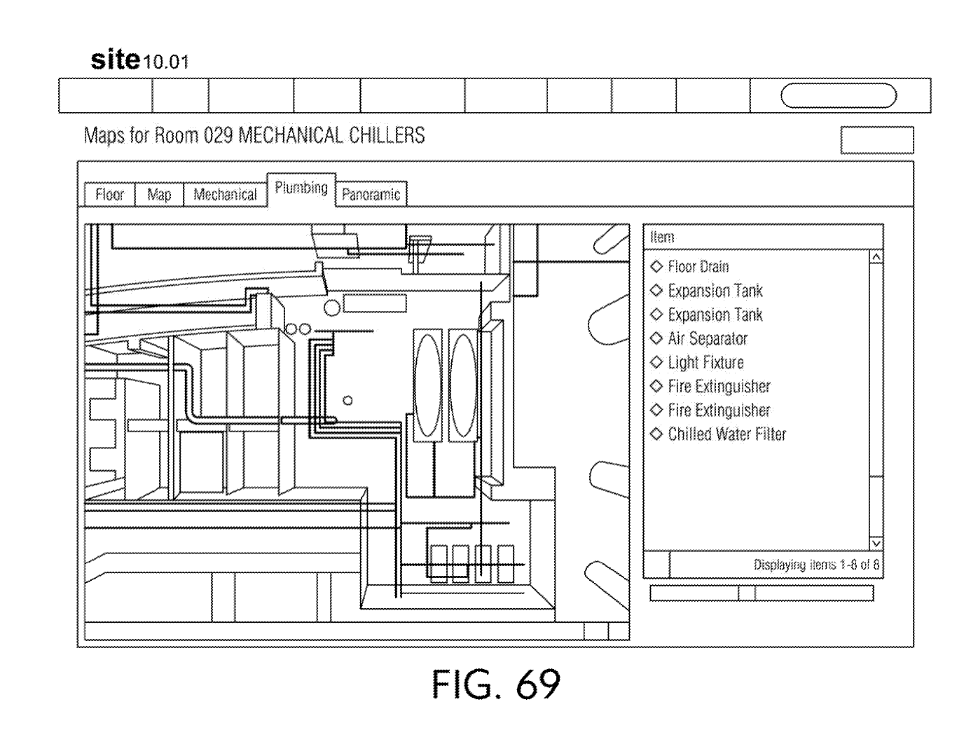

FIG. 69 illustrates a view of just the piping. Color coding is used to distinguish different types or use cases for piping (i.e., blue may be potable water, green may be an exhaust pipe for ventilation, yellow runs from chillers and condenser pump which will carry HVAC processed water and therefore may have chemicals such as glycol in the water, brown is for sewer lines, etc.).

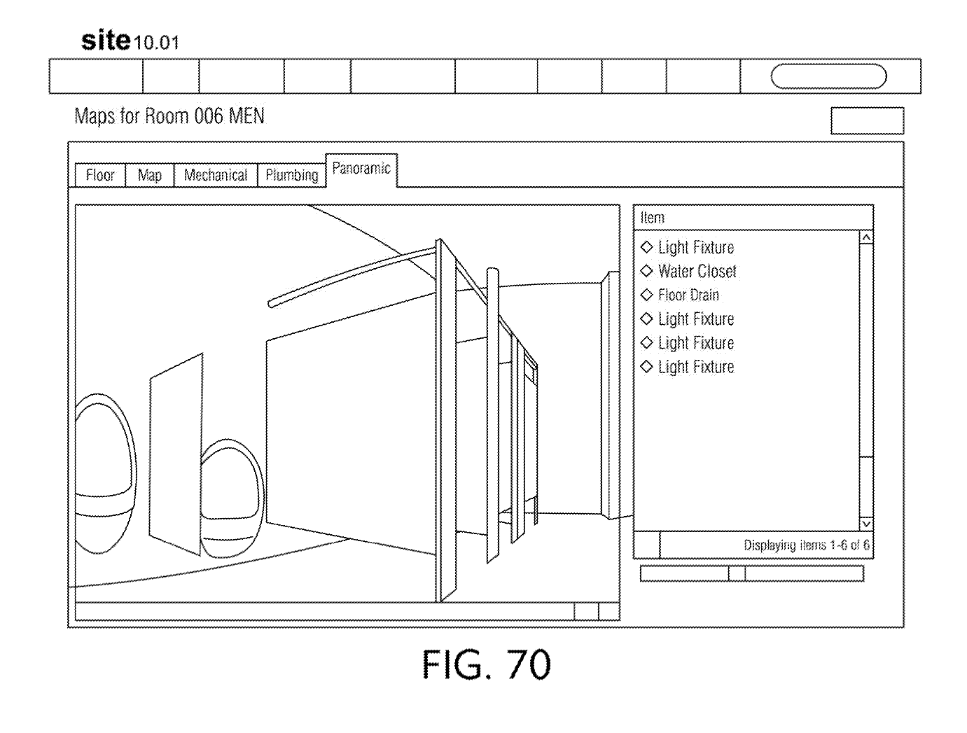

FIG. 70 illustrates the panoramic view which illustrates an actual picture of the space to provide a true representation of the space (which sometimes differs from digital building models).

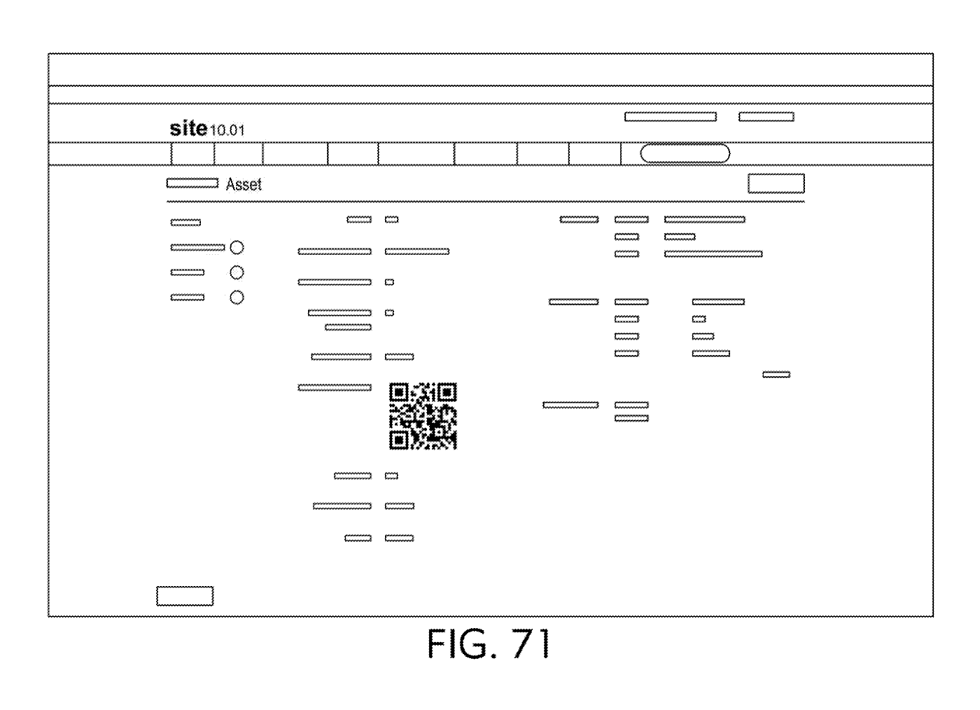

FIG. 71 illustrates an asset page which the user navigates to clicking “assets” in the menu navigation bar and then selecting “assets” in a drop-down submenu, which navigates the user to an asset dashboard enabling the user to select an asset, as illustrated in FIG. 71. In particular, the asset illustrates an asset group with which this asset is associated and includes a link enabling user navigation to information regarding the asset group.

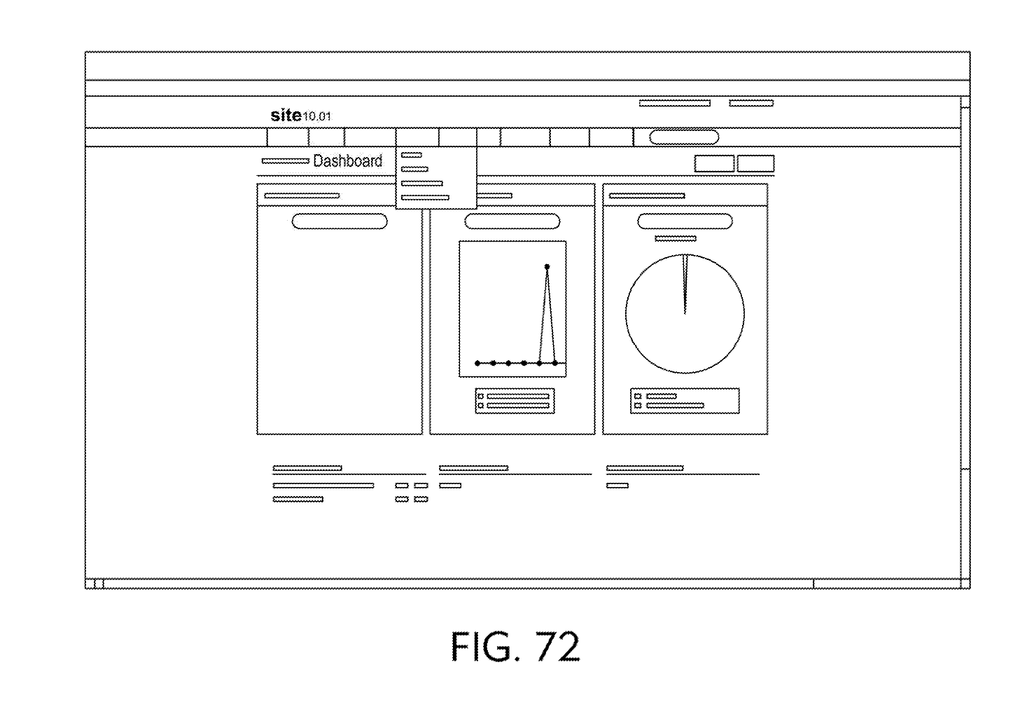

FIG. 72 illustrates the home page and shows the drop-down navigation under “assets” in the menu navigation bar.

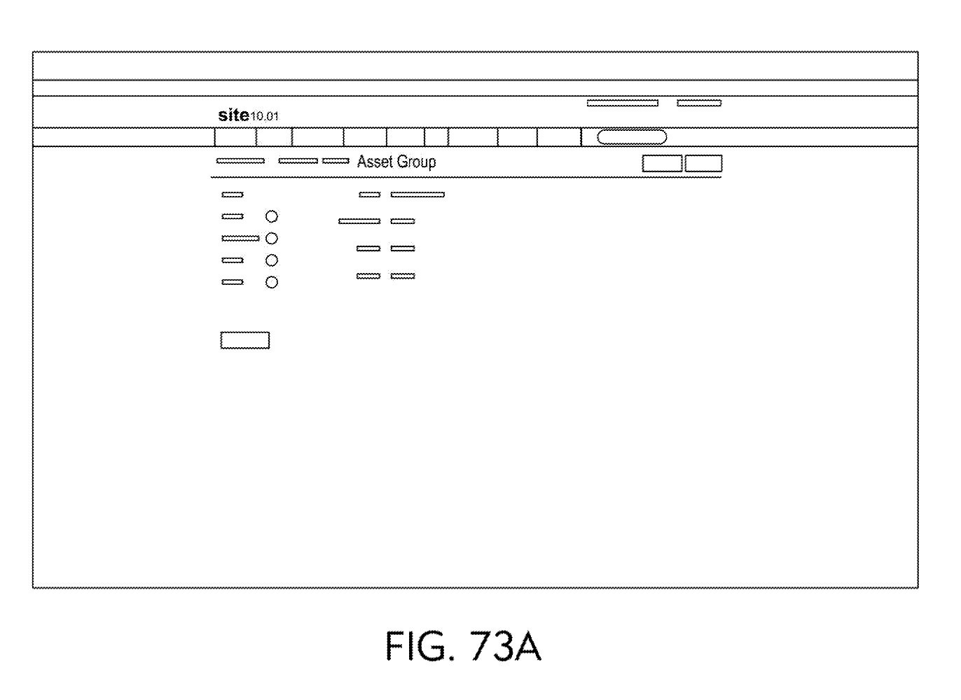

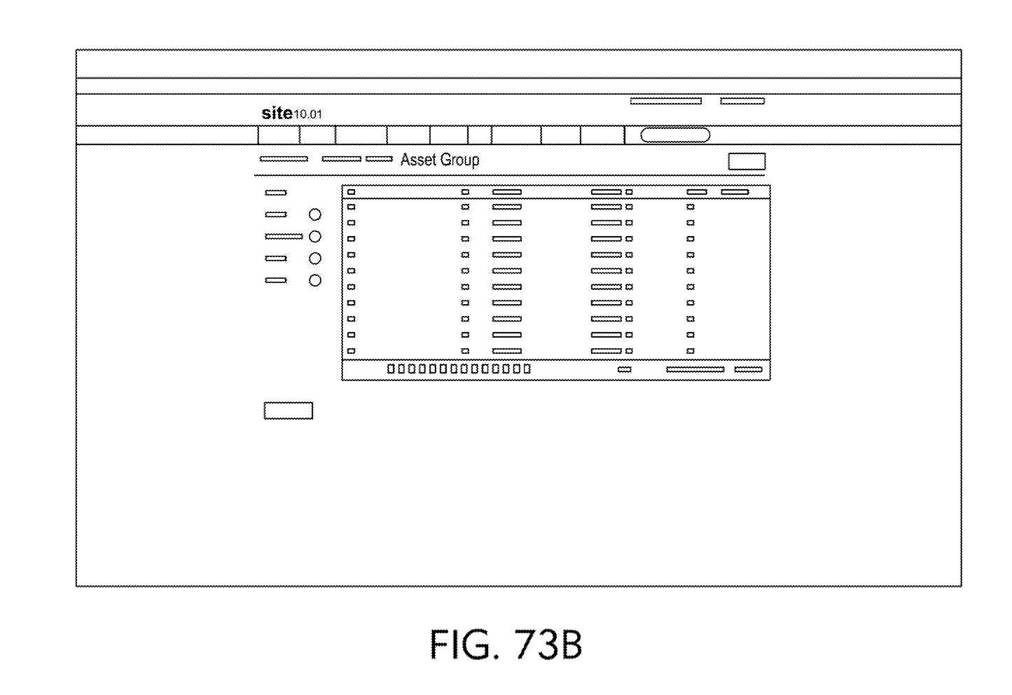

FIG. 73a and FIG. 73b illustrate the screens displayed when the user selects “asset group” under the “asset” menu. As illustrated, the page at FIG. 73a shows the details of the Asset Group and FIG. 73b shows all of the assets associated with a selected asset group. It also lists any work orders (Work Orders tab) that are assigned to an asset or an asset type that are associated with that group. The user has the opportunity to add custom properties and/or put system drawings or one-line drawings or other information under that particular asset group.

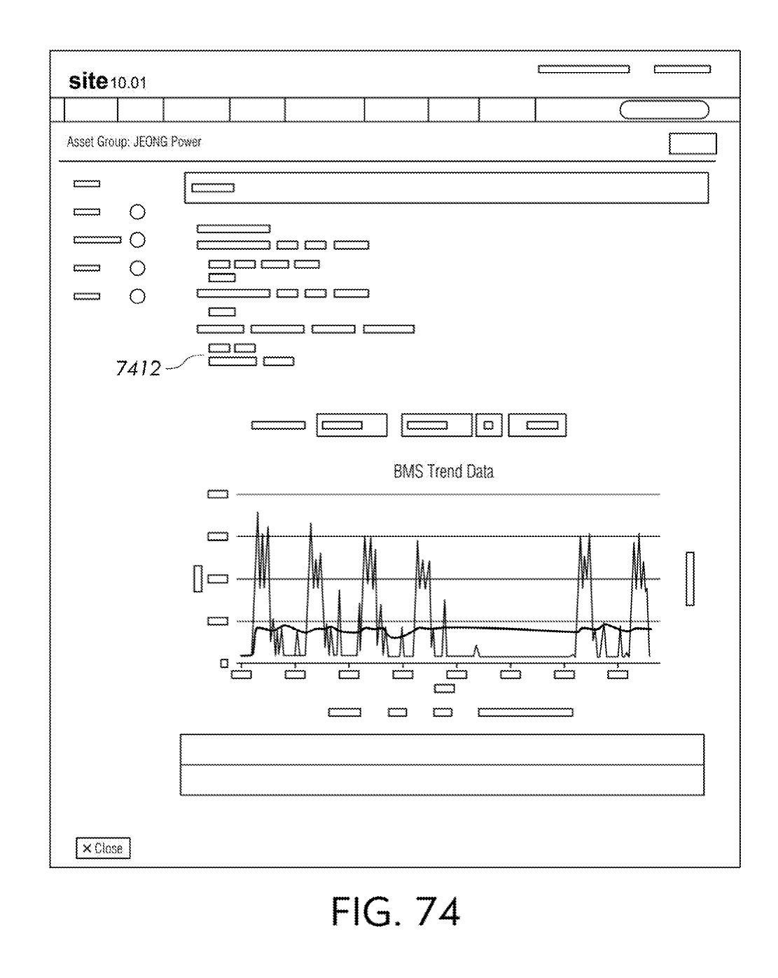

FIG. 74 illustrates monitors that are associated with an asset that is itself associated with the asset group viewed in FIGS. 73a and 73b. Any monitors that are associated with an asset that is associated with this group will show up on the monitors tab under the asset group. As illustrated in the box 7412, the monitors are broken out by asset type. Because an asset group brings assets and asset types of all different kinds into one spot, system 4210 divide them out. Illustrated is a P-P3 in the top line-a type of electrical panel and there are two monitors indicating two different electrical panels that are being monitored—and then the next item is P-P1 and there is another electrical panel (a third electrical panel) under that item. Accordingly, illustrated are three different assets and two different asset types that are all in the same asset group. The color of the icon next to the monitor identifiers indicates that the monitor is visible in the shown trend line. The trend line for a monitor can be hidden, in which case the color of the icon changes or turns gray.

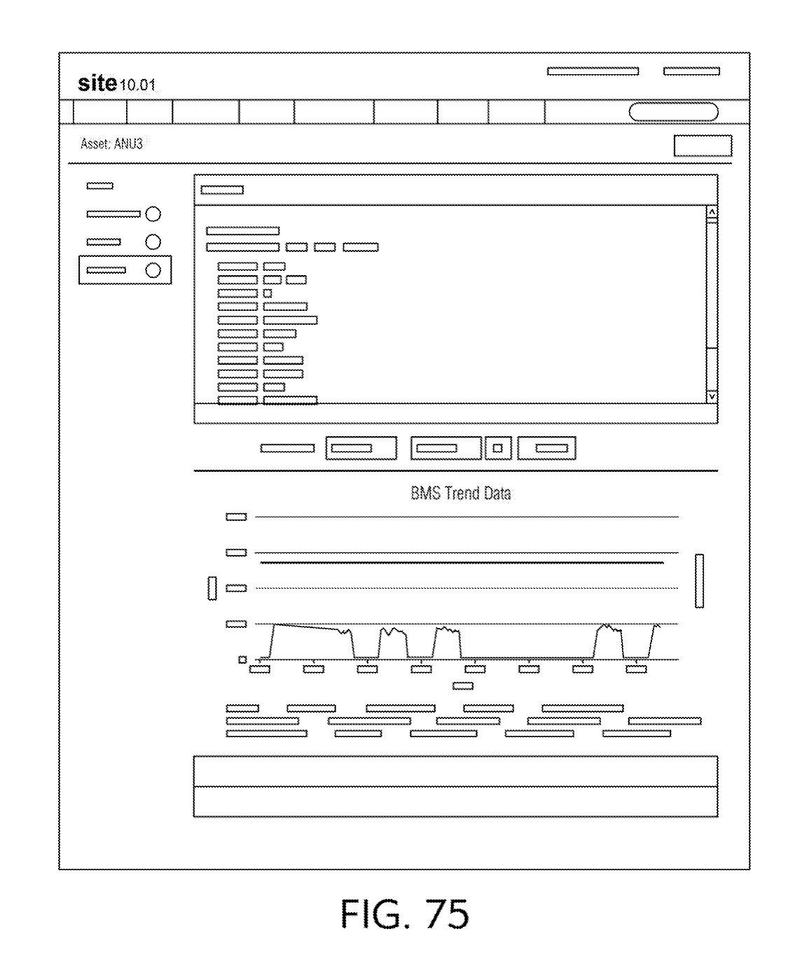

FIG. 75 illustrates all of the monitors that are associated with a particular asset. As illustrated, there are often many sensors associated with one asset. Accordingly, there are numerous monitors associated with this particular asset, each monitoring something different.

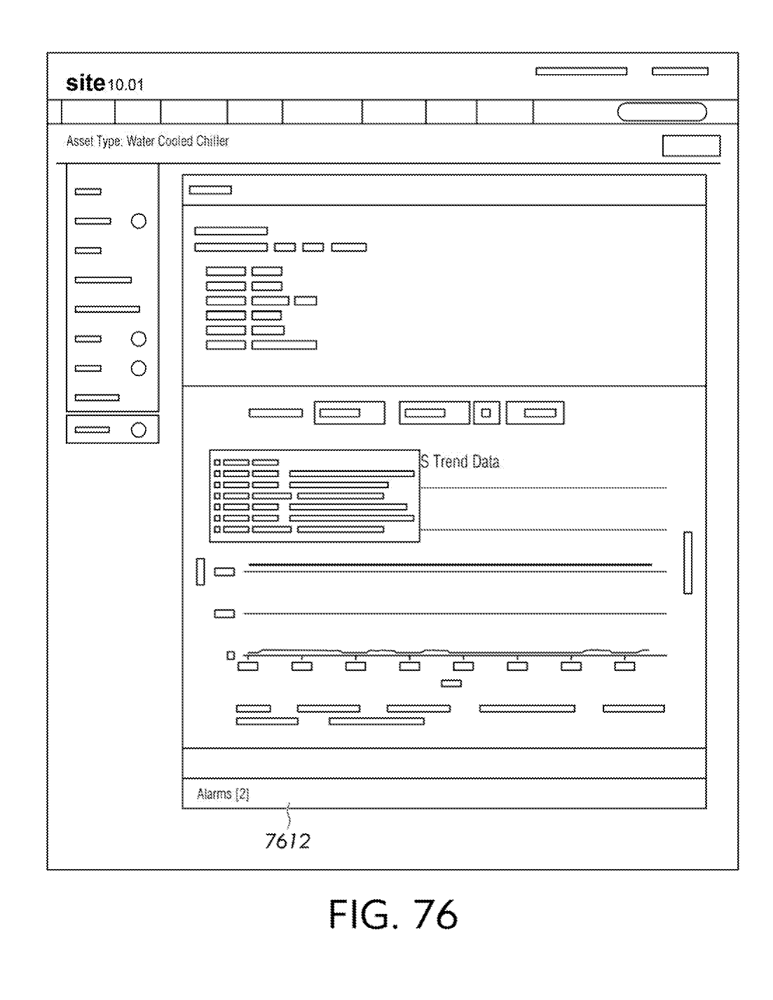

FIG. 76 illustrates an asset type. As illustrated, there are sensors that are associated with Chiller 1 and there are sensors that are associated with Chiller 2. This page enables the user to easily compare how well the two items are working.

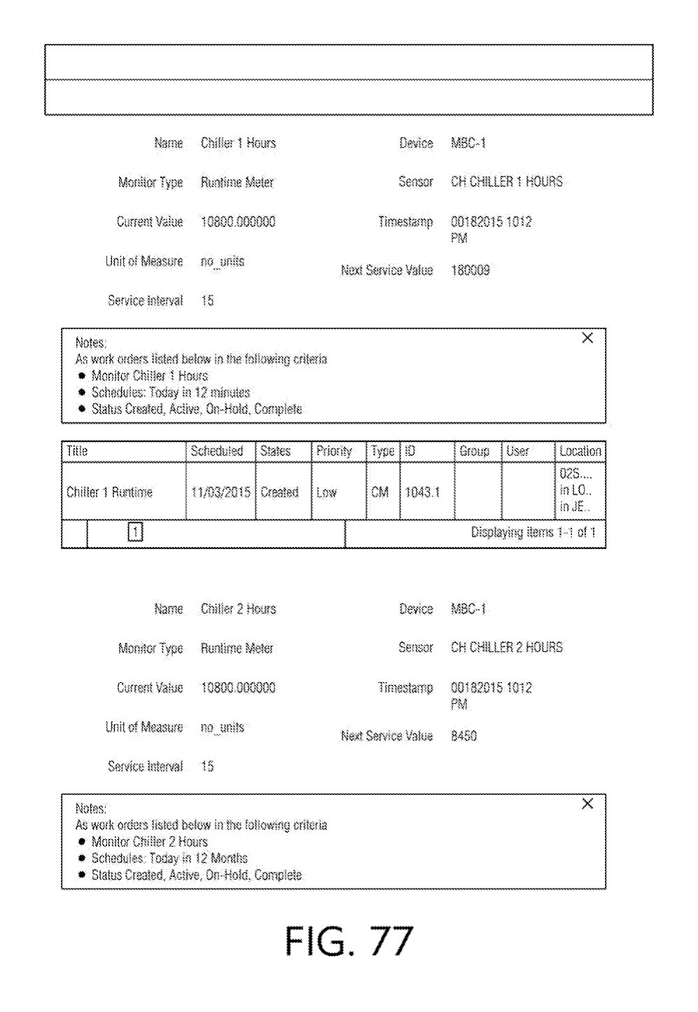

FIG. 77 illustrates a continuation (by scrolling down) of the previous screen illustrated in FIG. 76. At the bottom of FIG. 76 there is a bar 7612 that reads “alarms (2)”. FIG. 77 is the screen to which the system 4510 navigations when the user clicks on the bar 7612. This page shows how many work orders have been created from that alarm for this particular asset type. System 4210 enables alarms to be applied in any instance in which a trend set is captured (i.e., assets, asset groups, asset types and rooms can all have alarms associated with them and from this page you can see how many work orders have been created from that alarm).

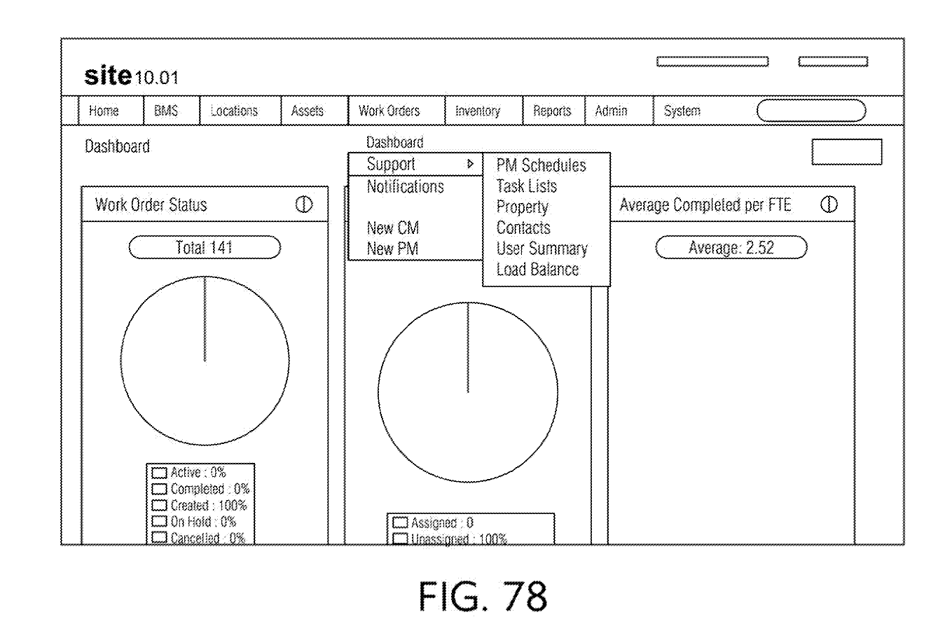

FIG. 78 illustrates the home page and, in particular, the “Work Orders” drop down menu with hovering over “Support”.

Page 79 illustrates the screen to which system 4210 navigates when the user clicks on “Task Lists” from the noted “Support” tab. In particular, illustrated is the task item lists library 4418 described herein.

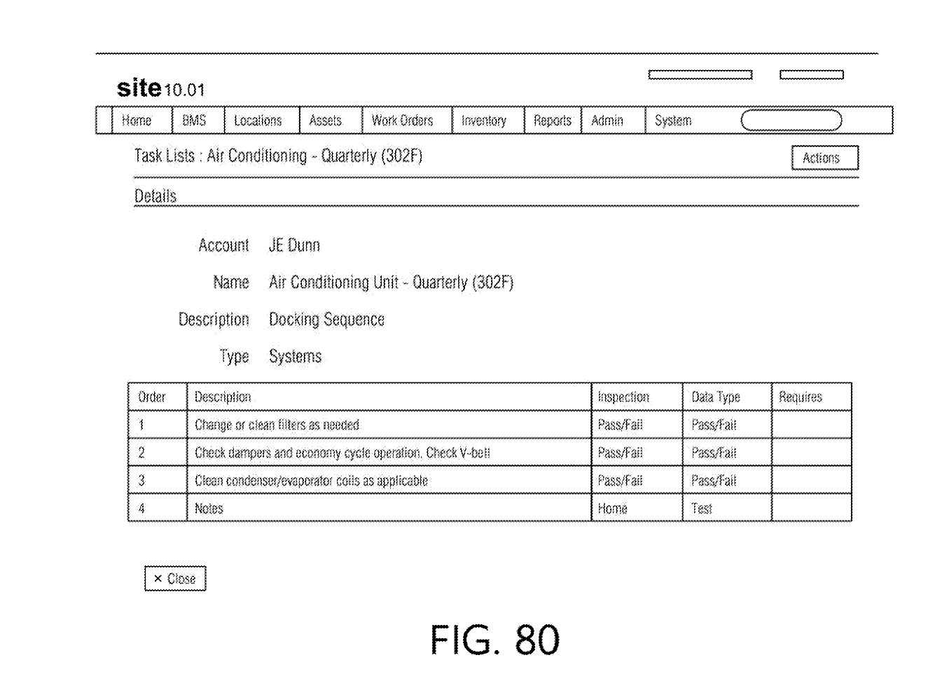

FIG. 80 illustrates the view based on selection of a particular task item list.

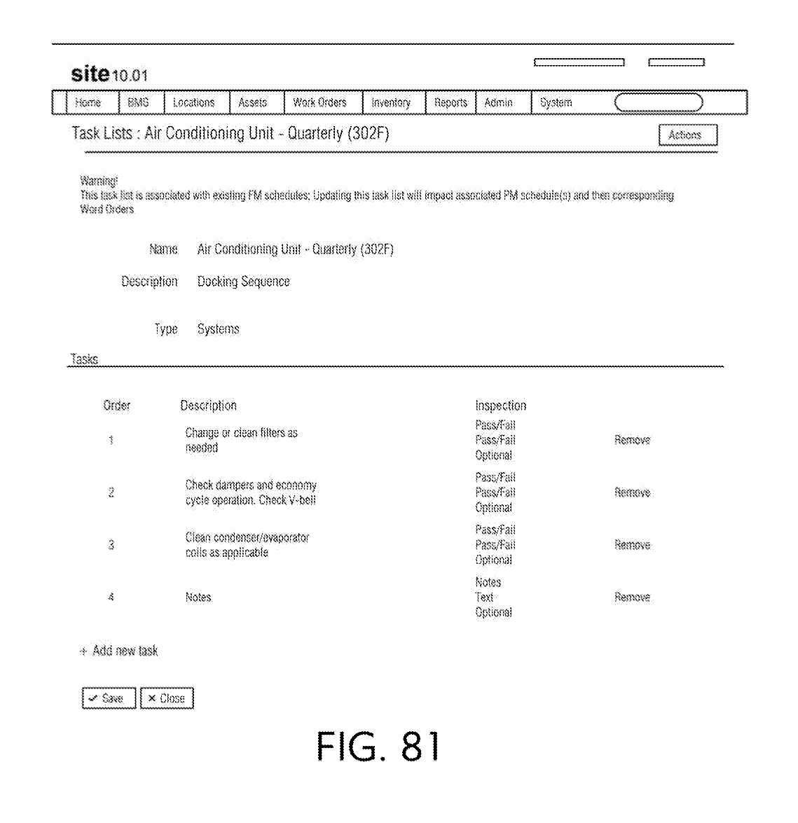

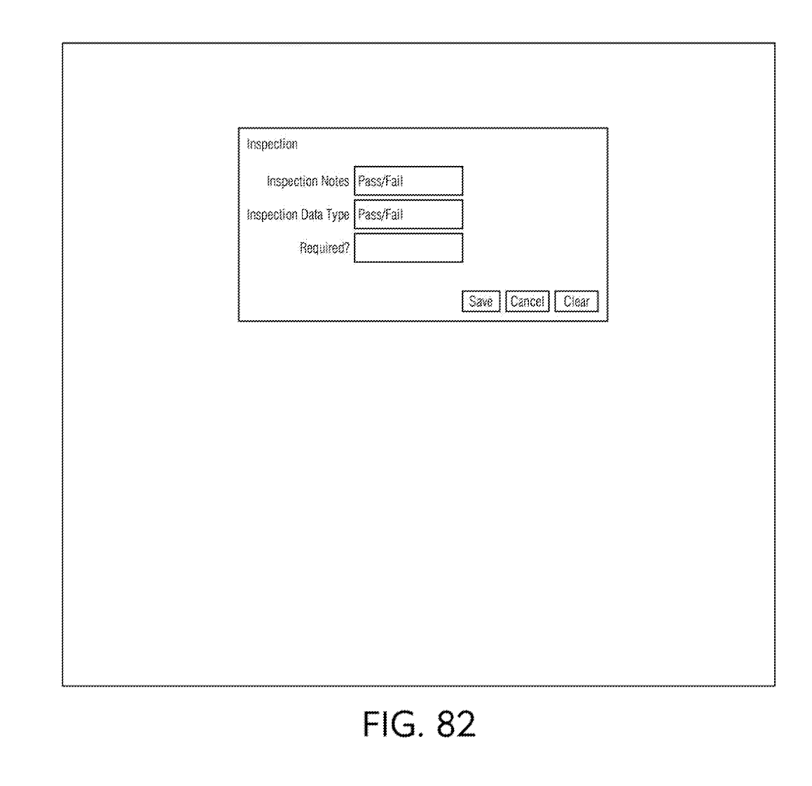

FIG. 81 illustrates the edit screen for the task item list just viewed in FIG. 80. As illustrated, this screen gives the user a warning that anytime the user updates or makes a change to this task item list, system 4210 is going to update every future or unedited preventative maintenance schedule or corrective maintenance ticket (does not update completed tickets) that has this list associated with it. Additionally, the user has opportunities to edit information, such as reordering the items, making changes to the descriptions, change the names or numbers, adding task items, etc. When the user clicks on a pass/fail indicator “Inspection”, a pop-up is provide as illustrated in FIG. 82.

FIG. 82 illustrates a pop-up box that gives the user the opportunity to name the inspection value and select if the user desires to type this value as a pass/fail or as a note entry. The user can select whether the inspection is required or not.

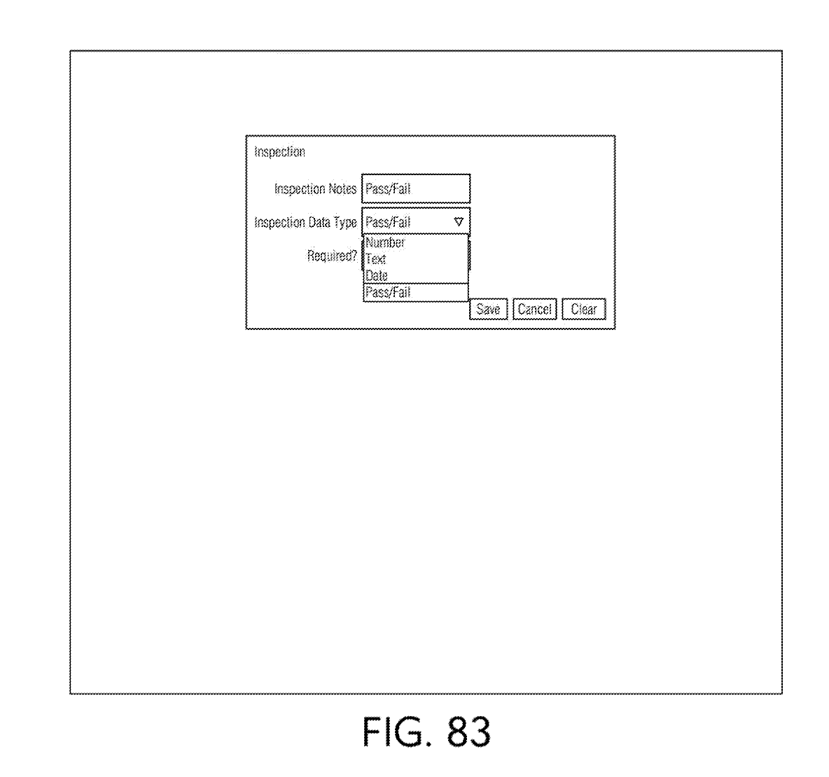

FIG. 83 illustrates the same pop-up as illustrated in FIG. 82 but showing the drop down under inspection to give the user the option to select the type of inspection data.

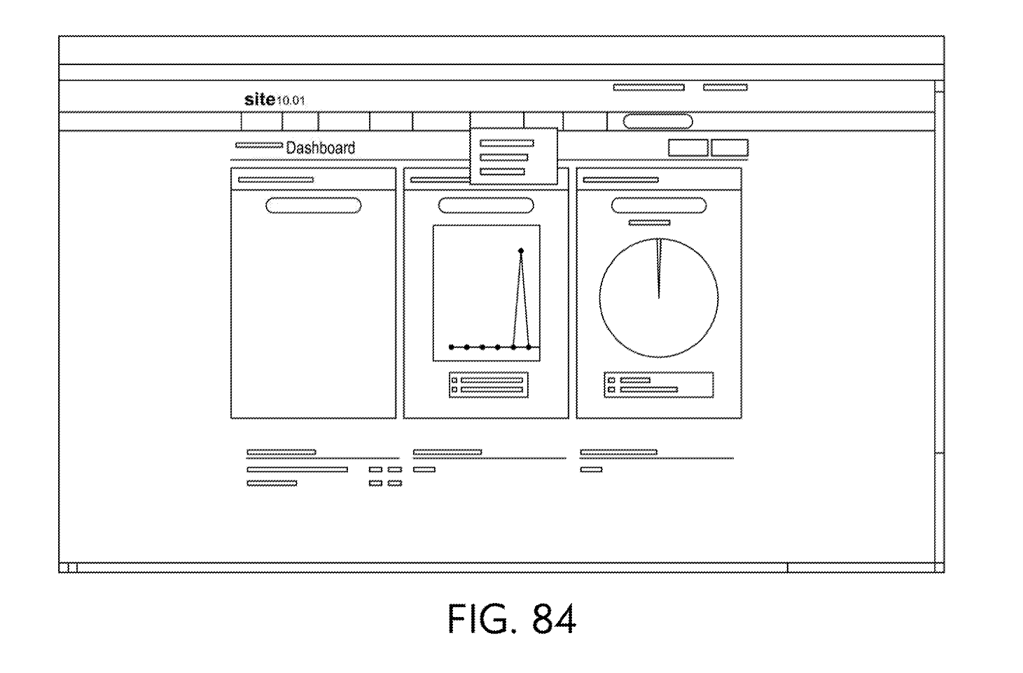

FIG. 84 illustrates the home screen and illustrated is a user-selection of “Inventory” on the navigation bar as well as the sub-menu for Inventory.

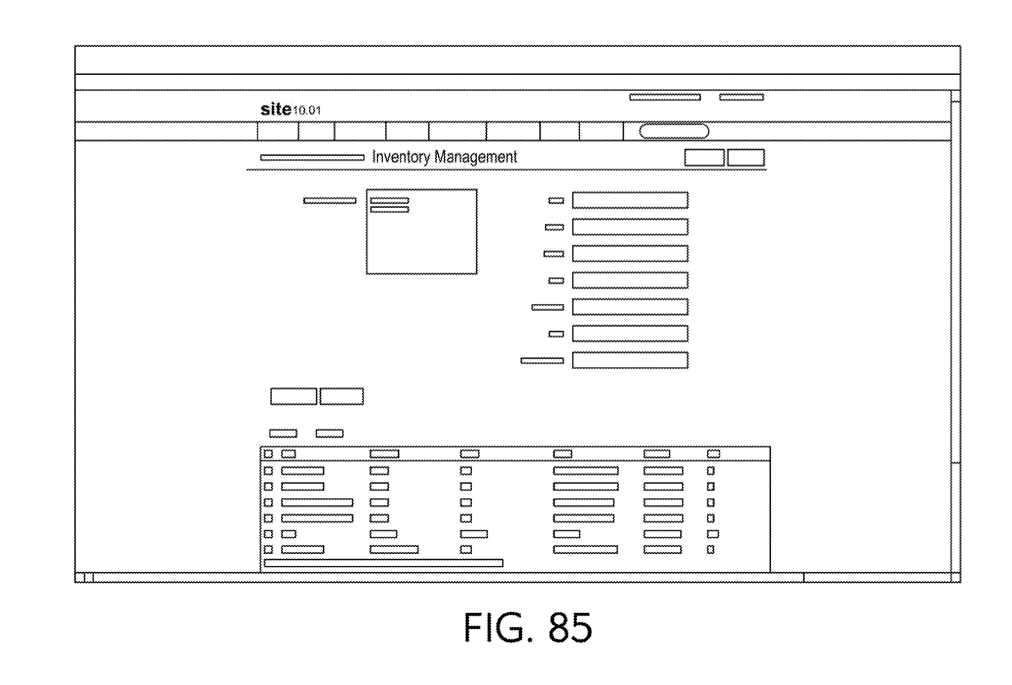

FIG. 85 illustrates the inventory management dashboard with the filters open.

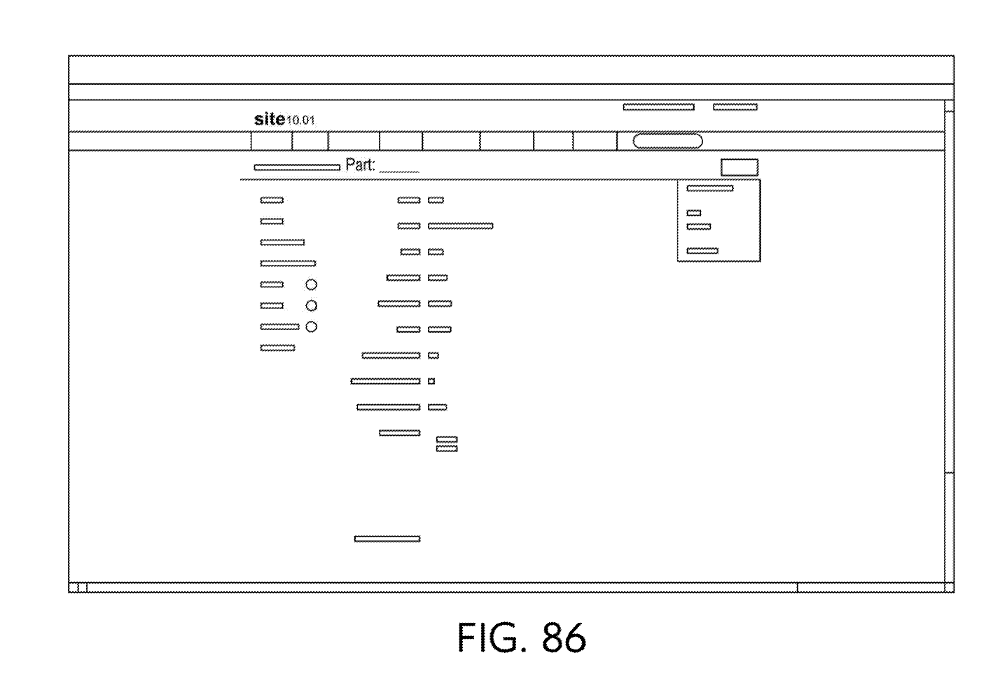

FIG. 86 illustrates navigation to a particular part from the inventory management page. Parts may be commodity items (like light bulbs) or finish items (like extra tile or paint). Information about the part is provided on the page.

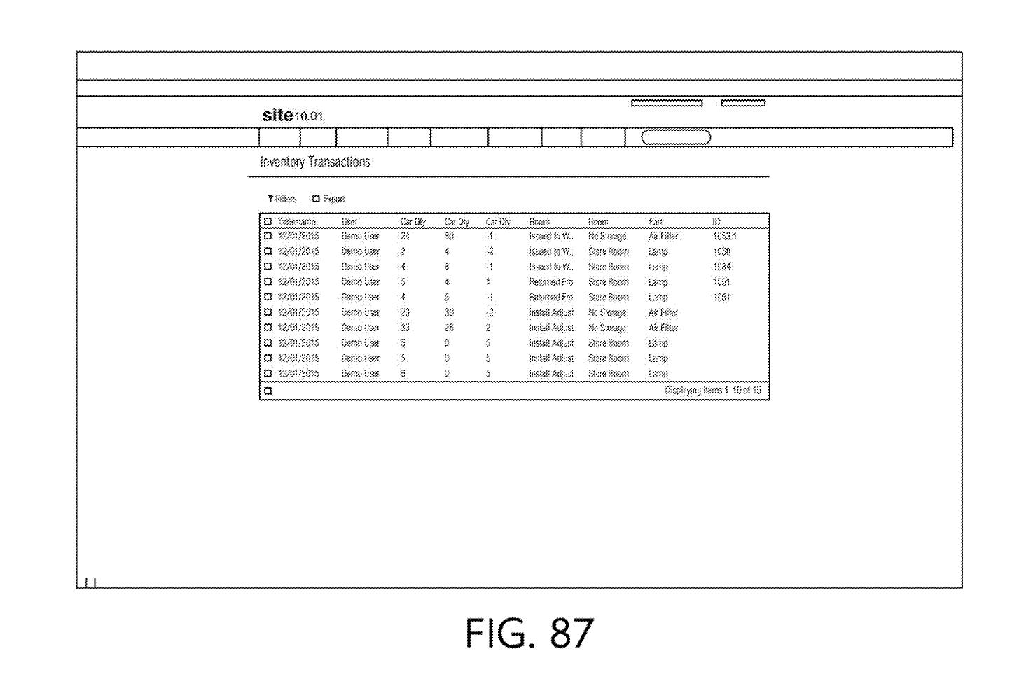

FIG. 87 illustrates the inventory transactions page. This page provides information regarding where inventory is going or where it is coming from. Each time a change is made to an inventory item, that change is identified in transactions. For example, it If you take an item and use it on a work order or through a work order (for example two light bulbs were used), then transactions will indicate that at a particular time a particular person took 2 lightbulbs away from a particular store room. Additions to stock are also recorded. Inventory thresholds may be established such, when the number of a particular item in stock drops below a threshold number, an order notification alert is generated and transmitted to assigned personnel.

Additionally, system 4210 enables inventory alerts. Such inventory alerts can be set-up by the user of system 4210 to enable just-in-time ordering/delivery of needed inventory. For example, schedule preventative maintenance information in system 4210 may indicate that a facility is in need of eight filters within the next two months and system 4210 alerts the user with a notification of that need at an appointed time prior to the scheduled maintenance along with an indication of the number of such filters already in inventory. Alerts can be set-up to alert a user when an item associated with an alert falls below a threshold value in inventory. For example, an alert could be set-up to notify that a particular type of light bulb has fallen below a set threshold number of five such light bulbs in inventory. Such alerts may be associated by system 4210 with costing information as well as with ordering information.

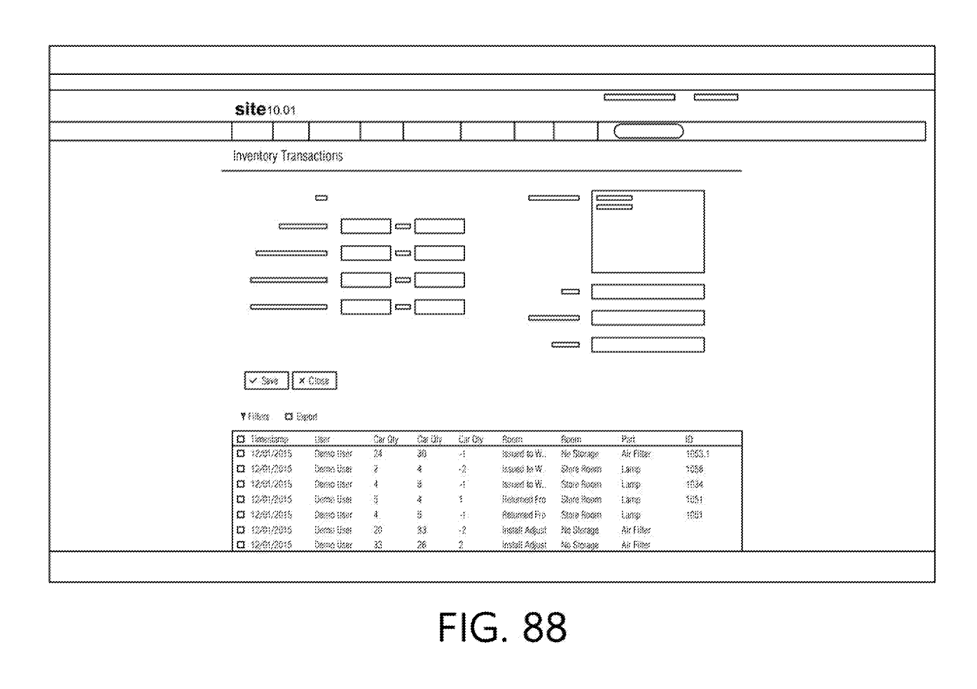

FIG. 88 illustrates the same page as illustrated in FIG. 87 but with the filters open.

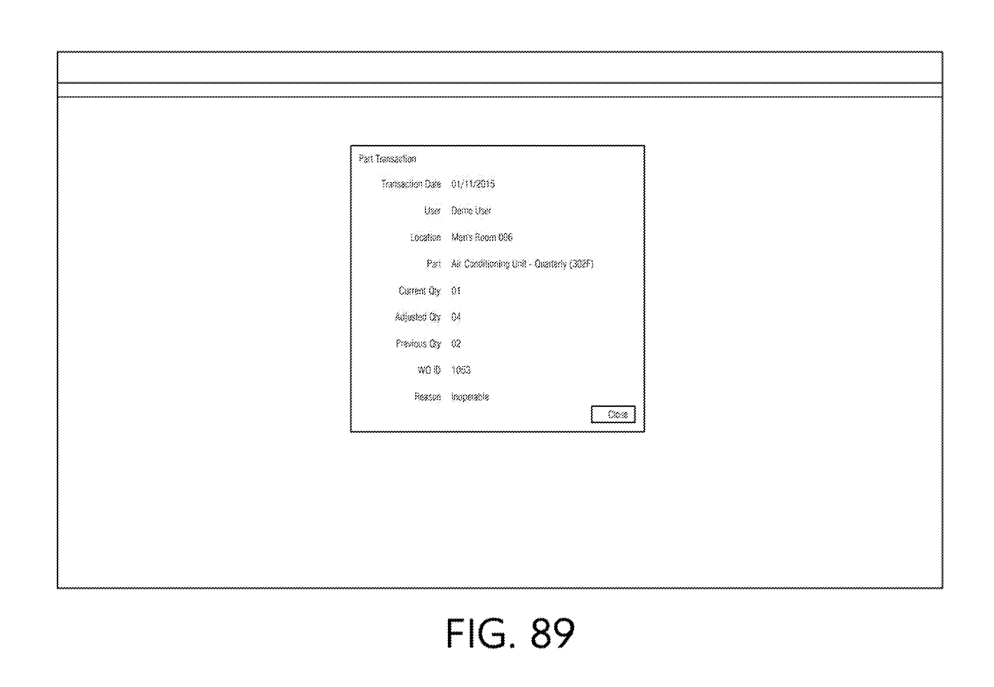

FIG. 89 illustrates a pop-up that is displayed showing the user all of the detail of an inventory transaction that was selected (clicked-on) by the user.

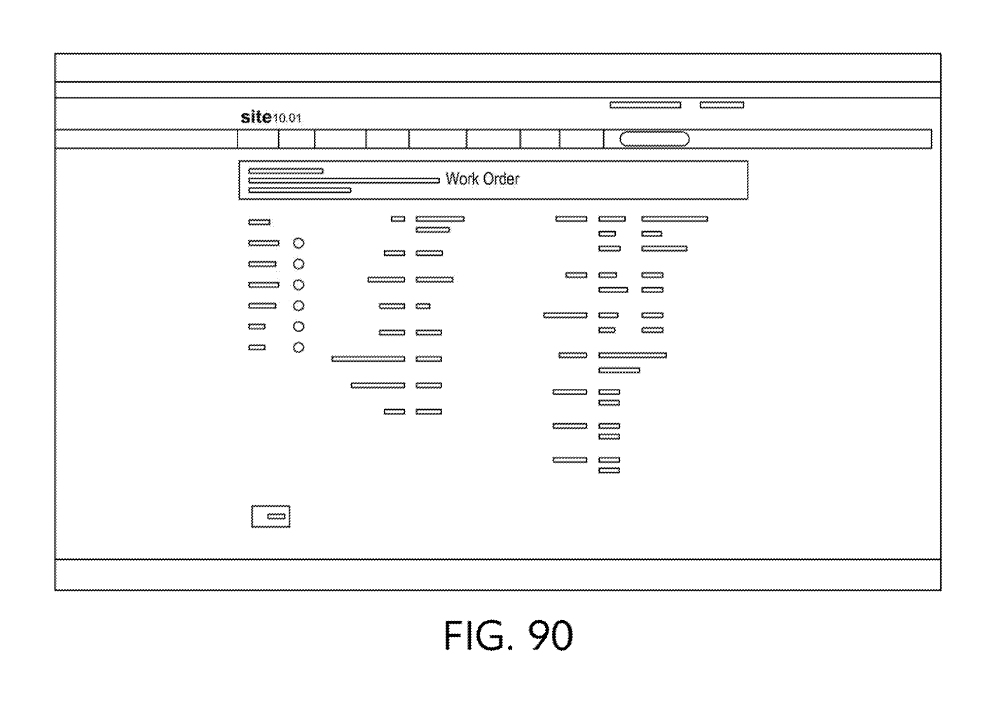

FIG. 90 illustrates a work order instance that is associated with a preventative maintenance schedule.

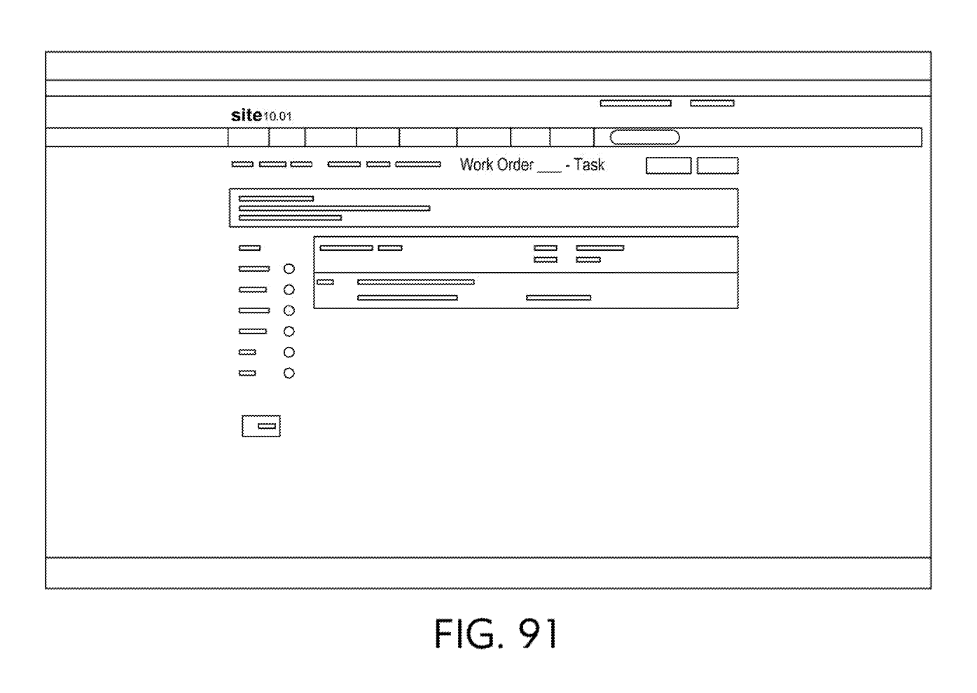

FIG. 91 illustrates the display when the user selects the “Tasks” tab on that particular work order instance viewed in FIG. 90. There is a check box in the far left that, when checked, will indicate who checked the box and will indicate the time/date that the person checked the box. On the right side of the screen there is the pass/fail or non-applicable. As described herein, if the user fails the item, the user can create a follow-up corrective maintenance ticket. Additionally, this screen indicates what is needed to get the maintenance done.

FIG. 92 illustrates information indicative of how much work is going into each work order ticket. This screen may illustrate information indicative of time tracked from start to completion of a project. Information can be manually entered by the user.

As will be apparent in view of the foregoing description, the present inventions are systems and methods that in embodiments may employ computer software, algorithms, and computing equipment. Some portions of the foregoing detailed description may be presented in terms of algorithms and symbolic representations of operations on data bits within a computer memory. These algorithmic descriptions and representations are ways used by those skilled in the data processing arts to effectively convey the substance of their work to others skilled in the art. An algorithm is here, and generally, considered to be a self consistent sequence of steps leading to a desired result. The steps used in an algorithm are those requiring physical manipulation of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the description herein, terms such as “processing” or “computing” or “calculating” or “determining” or “displaying” or the like refer to the action and processes of a computer system, or similar computing device, that manipulates and transforms data represented as physical (e.g., electronic) quantities within the computer system's registers and memories into other data similarly represented as physical quantities within the computer system's registers or memories or other such information storage, transmission or display devices.

As will also be appreciated, certain aspects of the present invention can be implemented in hardware, software, firmware, or a combination thereof.

In this description, any references to “one embodiment”, “an embodiment”, or “embodiments” mean that the feature or features being referred to are included in at least one embodiment of the technology, hardware, software, firmware, and/or components of the invention. Separate references to “one embodiment”, “an embodiment”, or “embodiments” in this description do not necessarily refer to the same embodiment and are also not mutually exclusive unless so stated and/or except as will be readily apparent from the description to those skilled in the art. For example, a feature, structure, act, etc. described in one embodiment may also be included in other embodiments but is not necessarily included. Thus, the present technology, systems, and methods can include a variety of combinations and/or integrations of the embodiments described therein.

Algorithms of the present invention as described herein may be implemented in computer programs stored in or on computer-readable medium residing on or accessible by computing equipment, including but not limited to electronic servers, personal computers, laptop and tablet computers, and mobile communications devices and that may employ communications equipment to communicate with each other. The computer programs preferably comprise ordered listings of executable instructions for implementing logical functions. The computer programs can be embodied in any computer or microprocessor-readable medium for use by or in connection with an instruction execution system, apparatus, or device, such that the instructions can be fetched from or identified in the instruction execution system and executed. The computer-readable medium can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, or device. More specific, although not necessarily inclusive, examples of the computer-readable medium would include the following: an electronical connection having one or more wired connections, a portable computer diskette, a random-access memory (RAM), a read-only memory (ROM), an erasable, programmable, read-only memory (EPROM or Flash memory), an optical fiber, and a portable compact disk read-only memory (CD-ROM).

As explained above, aspects of the invention may be implemented with a computer program or programs, also referred to herein as “software”, that operate computer equipment. Software generally refers to a set of statements or instructions to be used directly or indirectly in one or more computers in order to bring about a certain result. For the benefit of convenience, references made herein to software or programs “performing” certain functions shall be with the understanding that the function is performed by execution of the software using hardware, such as a microprocessor. It should also be understood that one or more of the following may apply to the present invention, namely, that (i) the system software of the present invention for performing certain functions may utilize and employ an operating system, drivers, web services, and/or communications instructions sets, (ii) the executable software is stored in memory or in an additional memory in machine codes that correspond to a native machine language instruction set comprised of a plurality of native instructions used by an electronic processor, (iii) each native instruction comprises a code that is readable by a processing architecture of the electronic processor and that can be used to specify particular electronic components for select functions, identifying particular memory locations, and controlling processes in the electronic processor, and/or (iv) executable software may comprise a set of machine codes selected from the native machine language instruction set corresponding to the electronic processor.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including”, and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A system comprising:
a database that stores information indicative of a plurality of assets that are used in a building or system;
a user interface that enables:
identifying a group of assets from said plurality of assets; and
associating a portion of said plurality of assets with said identified group of assets.

2. The system of claim 1, wherein said system further enables assigning a custom property to said identified group of assets.

3. The system of claim 1, wherein said system enables associating additional information with said identified group of assets.

4. The system of claim 1, wherein said system further maintains a plurality of work orders, wherein said system associates with said identified group of assets any work orders of said plurality of work orders that relate to any asset in said identified group of assets.

5. The system of claim 4, wherein said any work orders of said plurality of work orders that relate to any asset in said identified group of assets are displayed in conjunction with information indicative of said identified group of assets.

6. The system of claim 1, wherein said system generates a trendline for at least one asset in said identified group of assets, wherein said generated trendline is indicative of a performance of said at least one asset.

7. The system of claim 1, wherein said system generates a trendline that is representative of an operational characteristic of a plurality of assets in said identified group.

8. The system of claim 1, wherein said identifying a group of assets of said plurality of assets comprises identifying all assets in at least one of an air handling loop, a plumbing system, a sewage system, a piping system, an HVAC system, a fire suppression system, a fire alarm system, a security system, an IT system, a wireless network, a wired network, a plurality of door hardware assets, a plurality of door security assets, a plurality of card reader assets, a plurality of closed-circuit television (CCTV) assets, a video system, and a monitoring network.

9. The system of claim 1, wherein said portion of said plurality of assets that are associated with said identified group of assets are collectively located in a plurality of different rooms of a building in which said assets are located.

10. The system of claim 1, wherein said portion of said plurality of assets that are associated with said identified group of assets are collectively located on a plurality of different floors of a building in which said assets are located.

11. A method comprising:
storing in a database information that is indicative of a plurality of assets that are used in a building or system; using a graphical user interface, identifying a group of assets from said plurality of assets that are used in a building or system; and
associating a portion of said plurality of assets with said identified group of assets.

12. The method of claim 11, wherein said method further comprises assigning a custom property to said identified group of assets.

13. The method of claim 11, wherein said method further comprises associating additional information with said identified group of assets.

14. The method of claim 11, wherein said method further comprises maintaining a plurality of work orders and associating with said identified group of assets any work orders of said plurality of work orders that relate to any asset in said identified group of assets.

15. The method of claim 14, wherein said method further comprises displaying, in conjunction with information indicative of said identified group of assets, any work orders of said plurality of work orders that relate to any asset in said identified group of assets.

16. The method of claim 11, wherein said method comprises generating a trendline for at least one asset in said identified group of assets, wherein said generated trendline is indicative of a performance of said at least one asset.

17. The method of claim 11, wherein said method comprises generating a trendline that is representative of an operational characteristic of a plurality of assets in said identified group.

18. The method of claim 11, wherein said identifying a group of assets of said plurality of assets comprises identifying all assets in an air handling loop, a plumbing system, a sewage system, a piping system, an HVAC system, a fire suppression system, a fire alarm system, a security system, an IT system, a wireless network, a wired network, a plurality of door hardware assets, a plurality of door security assets, a plurality of card reader assets, a plurality of closed-circuit television (CCTV) assets, a video system, and a monitoring network.

19. The method of claim 11, wherein said portion of said plurality of assets that are associated with said identified group of assets are collectively located in at least one of (i) a plurality of different rooms of a building in which said assets are located and (ii) a plurality of different floors of a building in which said assets are located.

20. A non-transient computer readable medium containing program instructions, wherein execution of the program instructions by one or more processors of a computer system causes the one or more processors to carry out the steps of:
storing in a database information that is indicative of a plurality of assets that are used in a building or system;
using a graphical user interface, identifying a group of assets from said plurality of assets that are used in a building or system; and
associating a portion of said plurality of assets with said identified group of assets.
